(19) United States
(12) Patent Application Publication
(10) Pub. No.: US 2008/0114689 A1
(43) Pub. Date: May 15, 2008

(54) Patient information management method

(76) Inventors: Kevin Psynik, Murrysville, PA (US); Kevin Bowen, Pittsburgh, PA (US); Bob Barker, Chambersburg, PA (US); Steve Tracey, Pittsburgh, PA (US); Scott Ball, Greensburg, PA (US); Zachary D. Paul, Pittsburgh, PA (US)

Correspondence Address: MICHAEL W. HAAS;RESPIRONICS, INC., 1010 MURRY RIDGE LANE, MURRYSVILLE, PA, 15668, US

(21) Appl. No.: 11/932,009

(22) Filed: Oct. 31, 2007

Related U.S. Application Data
(60) Provisional application No. 60/856,405, filed on Nov. 3, 2006.

(51) Int. Cl. H04L 9/08; G06Q 50/00

(52) U.S. Cl. 705/51; 705/3

(57) ABSTRACT

A computer-implemented system for patient information management, including at least one database having a plurality of data fields populated with patient data, clinician data, physician data, healthcare provider data, device data, medical data, health data, presentation data, identification data, administrator data, or any combination thereof. The system provides a patient information interface in communication with the at least one database for selectively and dynamically presenting data fields to the users that are configured for access to the interface. A set of program instructions is configured to facilitate communication of data between at least one patient device and the system. A communication for patient information management and a method of facilitating the secure transmission of data of a patient device over a network to a patient management system are also disclosed.

### CROSS-REFERENCE TO RELATED APPLICATIONS

This application claims priority under 35 U.S.C. § 119(e) from provisional U.S. patent application No. 60/856,405 filed Nov. 3, 2006 the contents of which are incorporated herein by reference.

### BACKGROUND OF THE INVENTION

1. Field of the Invention

The present invention relates generally to methods, apparatus, and systems for: (1) monitoring patients and the various devices associated with these patients, such as therapeutic devices and the like; (2) managing data collection, distribution, and communication over a network; and (3) providing an interface for use by clinicians, physicians, home care providers, medial device manufactures, administrators and the like in the area of patient information management. In addition, the present invention relates generally to a networked system, communications platform, and architecture for facilitating communication and data transmission in a networked environment in the area of patient information management.

2. Description of Related Art

It is well known to treat a medical disorder or to diagnose, treat or monitor the condition of a patient using medical equipment. For example, a patient may be monitored and treated for various sleep disorders in a lab or in some other setting. An example of a type of sleep disorder is sleep apnea, which includes obstructive sleep apnea and central sleep apnea. Obstructive sleep apnea is characterized by a collapse of the upper airways during sleep, while central sleep apnea is characterized by the suspension of all respiratory movement. Obstructive sleep apnea and central sleep apnea may be combined in a condition referred to as mixed apnea.

In order to diagnose and/or treat such medical disorders, various equipment and devices are required for successful diagnosis and a resulting prescribed treatment. For example, patients suffering from a pulmonary or respiratory disorder, such as obstructive sleep apnea, are often treated with a pressure support device, such as a continuous positive airway pressure (CPAP) device. A CPAP device delivers a flow of fluid to the airway of the patient throughout the patient's breathing cycle in order to “splint” the airway, thereby preventing its collapse during sleep. Examples of such CPAP devices are the REMstar® and Solo® family of CPAP devices manufactured by Respironics, Inc. of Pittsburgh, Pa.

In another type of treatment, a bi-level positive pressure therapy is provided to the patient, in which the pressure of air delivered to the patient's airway varies or is synchronized with the patient's breathing cycle to maximize therapeutic effect and comfort to the patient. An example of a pressure support device that provides “bi-level” pressure support, in which a lower pressure is delivered to a patient during the patient's expiratory phase then during the inspiratory phase, is the BiPAP® family of devices manufactured and distributed by Respironics, Inc. of Pittsburgh, Pa. Such a bi-level mode of pressure support is taught, for example, in U.S. Pat. Nos. 5,148,802; 5,313,937; 5,433,193; 5,632,269; 5,803,065; 6,029,664; 6,305,374; 6,539,940; 6,948,497; and 7,100,607, the contents of each of which are incorporated by reference in the present invention. Another example of a pressure support device that provides variable level of pressure support, in which the pressure is lowed during the patient's expiratory phase, is the Bi-Flex® and C-Flex™ family of devices manufactured and distributed by Respironics, Inc. of Pittsburgh, Pa. These types of pressure support are taught, for example, in U.S. Pat. Nos. 5,535,738; 5,794,615, 6,105,575; 6,609,517; and 6,932,084 the contents of each of which are incorporated by reference in the present invention.

It is also known to provide an auto-titration positive pressure therapy in which the pressure provided to the patient changes based upon the detected conditions of the patient, such as whether the patient is snoring or experiencing an apnea, hypopnea, or upper airway resistance. An example of the device that adjusts the pressure delivered to the patient, based on whether or not the patient is snoring, is the Virtuoso® CPAP family of devices manufactured and distributed by Respironics, Inc. An example of auto-titration pressure support mode that controls pressure based on snore is taught, for example, in U.S. Pat. Nos. 5,203,343; 5,458,137; and 6,085,747, the contents of which are incorporated herein by reference.

A further example of an auto-titration pressure support device that actively tests the patient's airway to determine whether obstruction, complete or partial, could occur and adjust the pressure output to avoid this result is the Tranquility® AutoCPAP device, also manufactured by Respironics, Inc. This auto-titration pressure support device is taught in U.S. Pat. Nos. 5,645,053; 6,286,508; 6,550,478; and 6,920,877, the content of which is also incorporated herein by reference.

In treating a patient using any of the above-described pressure support systems, each of which represent a mode of providing pressure support, it is often desirable to monitor various parameters associated with the use of such systems. In addition, it is necessary to collect the data locally in the device or other locally available storage medium, and it is this data that is used by clinicians and physicians to: ensure compliance with a prescription or therapy; ensure that the device is operating appropriately; monitor a patient's progress by collecting and analyzing the data at the device level, etc. Therefore, it is important to establish an appropriate communications protocol to provide the collected data to a central database or repository for use by the clinicians, physicians and administrators.

According to the prior art, the data that is collected at the device level, e.g., usage data, patient data, device data, etc., may be stored on a removable medium, such as a Smartcard. An example of this type of data collection technique is taught, for example, in PCT patent application publication no. WO 01/32069. In one embodiment, the data on the Smartcard may be transmitted to the central system by: sending the Smartcard through the mail to the administrative entity; sending the Smartcard to a clinician for transfer of data into the system, etc. Once the data is received, the receiving system must process, distribute and analyze the data, and direct the appropriate data streams and information to the users, e.g., the clinician, the health care provider, the physician, the administrator, a customer service representative, a technical person, etc.

One drawback of the prior art is the limited interface provided to the clinician and the physician for use in monitoring the patient's interactions, device operation, compliance statistics, etc. Typically, such prior art systems include an internal communications architecture that directs data to the appropriate individuals for use in carrying out their daily duties and responsibilities. If, however, a clinician of a specific facility would like to talk to a clinician at a different facility, or a physician associated with the patient, normal routes of communications must be used, e.g., telephone, facsimile, e-mail, etc. This distributed data collection, processing and communications is inefficient and prone to inconsistent data problems, communications failures and other issues related to the separation of the users.

Still further, these prior art systems do not maximize the functionality and communications features for use in managing patient data, device data, etc. In particular, such systems do not provide an easy-to-understand and powerful interface to receive, analyze, process, and transmit data between a large number of users of varying access and responsibility levels. It is this lack of data unification that leads to a variety of compliance issues, response time delays, inefficient or improper communication, etc.

Therefore, there is a need in the art of a patient information management system that provides a unified and workable solution to the distribution of its users. There is also a need in the art for an effective data collection, processing and analytical system that utilizes uniform, discrete data streams and the relationships between data to achieve effective analytical results. In addition, there is a need in the art for a method and system for patient information management that allows for the communication between many different types of users according to a prescribed, yet modifiable, rule set. Further, there is a need in the art for a patient information management system that allows for the secure communication of patient data (and device data) over a network. Accordingly, the above-discussed prior art systems lack the ability to provide secure communications of data between patients, patient devices, clinicians, physicians and administrators and, therefore these prior art systems cannot provide a dynamic and responsive patient information management system for use in providing enhanced medical treatment, as well as a dynamic and secure communications infrastructure.

### SUMMARY OF THE INVENTION

Accordingly, it is an object of the present invention to provide a computer-implemented method and system of patient information management that overcomes the shortcomings of conventional patient information management systems. In particular, it is an object of the present invention to provide a computer-implemented patient information management system that offers a robust and secure communications platform and infrastructure to facilitate communications between patients, patient devices, clinicians, physicians, administrators, etc. It is another object of the present invention to provide a computer-implemented patient information management system that provides a simple, yet dynamic, interface to the clinician, physician and administrator for use in monitoring, analyzing and communicating with patients and/or patient devices. It is a further object of the present invention to provide a computer-implemented patient information management system that offers a relational data system for use in managing a patient's needs in a network setting. It is a still further object of the present invention to provide a computer-implemented patient information management system that provides increased compliance monitoring, reminder functions, notifications, patient data and information management and other functionality that enhances the user's experience at the interface, while, at the same time, improving user/patient responsiveness which results in a drastically enhanced health care system.

Accordingly, the present invention is directed to a computer-implemented system for patient information management. The system includes at least one database having a plurality of data fields populated with patient data, clinician data, physician data, healthcare provider data, device data, medical data, health data, presentation data, identification data, administrator data, or any combination thereof. The system also includes a patient information interface in communication with the at least one database for selectively and dynamically presenting data to the users that are configured for access to the interface. In addition, a set of program instructions is used to facilitate communication of data between at least one patient device and the system.

In a further embodiment, the present invention is directed to a communication system for patient information management. The system includes at least one central database having a plurality of data fields populated with patient data, clinician data, physician data, healthcare provider data, device data, medical data, health data, presentation data, identification data, administrator data, or any combination thereof. Further, a set of program instructions facilitates communication of data between at least one patient device and the system via a communications device in communication with the at least one patient device.

In yet another embodiment, the present invention is directed to a method of facilitating the secure transmission of data of a patient device over a network to a patient management system. The method includes the steps of: enabling communication between the patient device and a communications device; and transmitting, by the communications device, data to a patient management system server. The transmission occurs over a network, and the data is patient data, device data, medical data, health data, presentation data, identification data, or any combination thereof.

These and other objects, features and characteristics of the present invention, as well as the methods of operation and functions of the related elements of structure and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of a patient information management system according to the principles of the present invention;

FIGS. 2-82 are screenshots of various portions of a patient information interface displayed to a user of the patient information management system according to the principles of the present invention;

FIG. 83 is a schematic view of one preferred embodiment of the functional groupings of the patient information management system according to the principles of the present invention;

FIG. 84 is a schematic view of various functionalities and interconnections for a user-administrator of the patient information management system according to the principles of the present invention;

FIG. 85 is a schematic view of various functionalities and interconnections for a user-clinician of the patient information management system according to the principles of the present invention;

FIG. 86 is a schematic view of various functionalities and interconnections for a user-physician of the patient information management system according to the principles of the present invention;

FIG. 87 is a schematic view of the reporting functionalities of the patient information management system according to the principles of the present invention;

FIG. 88 is an example summary compliance report displayed to a user of the patient information management system according to the principles of the present invention;

FIG. 89 is a chart illustrating various communication device status information that can be provided to the user;

FIG. 90 is a schematic view of a communications system and platform for use in patient information management according to the principles of the present invention;

FIG. 91 is a schematic view of the functionalities and interconnections in the communications system and platform for use in patient information management according to the principles of the present invention

FIG. 92 is a diagram illustrating a process by which a modem accessory (communication device) is sold, shipped, serviced, and used to call the patient data management system according to the principles of the present invention.

### DESCRIPTION OF THE EXEMPLARY EMBODIMENTS

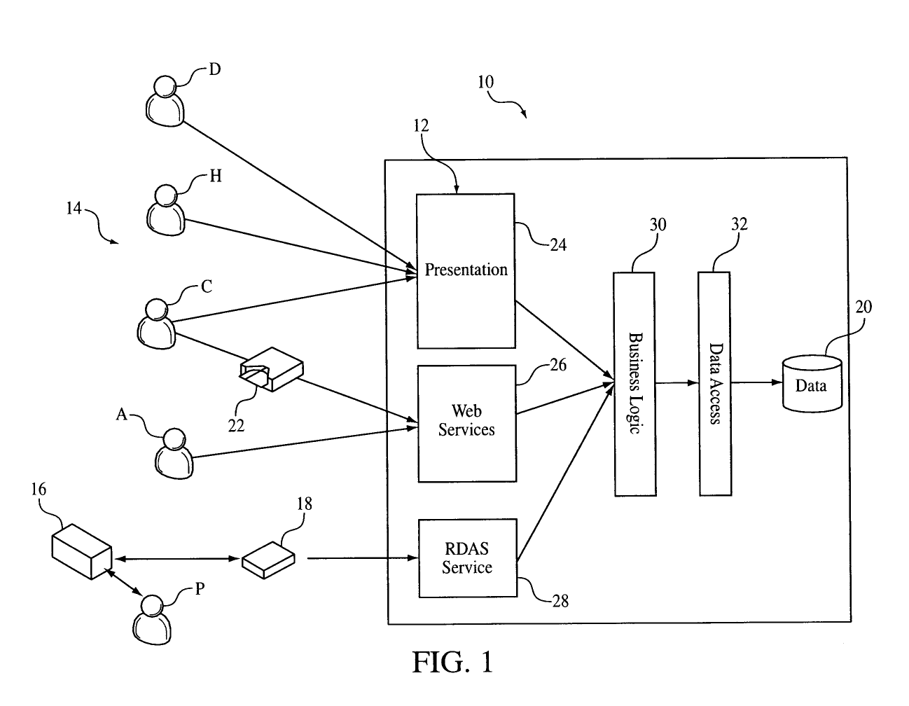

The present invention is directed to a patient information management system 10. A preferred and non-limiting embodiment of system 10 is illustrated in FIG. 1. System 10 includes a patient information interface 12, which permits access to and use of the functionality of system 10 by a variety of users 14. As seen in FIG. 1, users 14 may include a clinician C, a healthcare provider (HCP) and its employees (which typically include clinicians and administrators H, a physician or doctor D, a healthcare staff person, a family member, a compliance monitoring officer, a system administrator A, a medical device manufacturing company, etc. In addition, system 10 provides for communication with at least one, and typically multiple patient devices 16 associated with a respective patient P. As discussed in more detail hereinafter, communications from patient device 16 to other components of system 10 are achieved through some form of communications device 18. Accordingly, the present invention is directed to the patient information interface, communications architecture, and other various components and devices that compliment and create patient information management system 10.

In order to utilize patient information interface 12, system 10 includes at least one database 20, which includes data fields populated with patient data, clinician data, physician data, healthcare provider data, device data, medical data, health data, presentation data, identification data and/or administrator data. In addition, patient information interface 12 is tailored to and further configurable by user 14, whether a clinician C, a physician D, a heath care provider H, etc. Accordingly, patient information interface 12 is in communication with database 20 and programmed to selectively and dynamically present the data fields to a user 14 and is configured for access to patient information interface 12. In addition, system 10 includes a set of program instructions configured to facilitate communication of data between the patient devices 16 and system 10, such as database 20 of system 10.

Patient device 16 may be a variety of therapeutic, medical, and similar devices, e.g., pressure support devices and the like. An example of a patient device suitable for use with the present invention is the pressure support system disclosed in U.S. patent application publication no. 2007/0169776 to Kepler et al. (“the '776 publication”) the contents of which are incorporated herein by reference. In order to obtain the appropriate data from the sub-components of device 16, which are in communication with the patient P, patient device 16 includes some storage medium, e.g., a Smartcard 22, an internal hard drive, etc. Further, patient device 16 uses some method for communicating the stored data to system 10. For example, the data could be transferred from Smartcard 22 to database 20 of system 10, or in another preferred embodiment, the data could be transmitted to system 10 (or database 20) via a communications device 18, e.g., a modem, a wireless modem, a dial-up modem, etc.

In the pressure support system taught by the '776 publication, communications device 18 is a modem that is operatively coupled to the processor that control the pressure support system. More specifically, the pressure support system of the '776 publication includes a slot that receives a modem in a modular fashion. However, the present invention also contemplates the communications device 18 can be physically separated from patient device 16. In which case the communications device can communicate with the patient device via any conventional communication link, either wireless or hardwired.

As discussed in greater detail hereinafter, system 10 may include a variety of layers and accompanying program instructions for use in configuring patient information interface 12 for a specific type of user 14, driving the functions for system 10 interaction, managing the communications between devices, managing data transfer, etc. For example, as seen in FIG. 1, system 10 includes a presentation layer 24 for configuring and driving patient information interface 12 for users 14, and in this embodiment, physician D, HCP H, and clinician C. System 10 further includes a web services layer 26 for providing data transfer services, e.g., through a Smartcard 22, as well as for providing an interactive layer for use by a super-user or system administrator A. Finally, a communications services layer 28 is used to allow for the appropriate and effective communications between patient device 16 (and specifically the associated communications device 18) and system 10.

Layers 24, 26, 28 are in communication with and function through a business logic 30, which is in communication with a data access module 32. Accordingly, all incoming data is provided through the appropriate layer 24, 26, 28, through business logic 30 and data access module 32, and into database 20. Of course, the same business logic 30 and access module 32 allow for the data communication with layers 24, 26, 28 for use in selectively presenting the data to user 14.

### I. Patient Information Interface

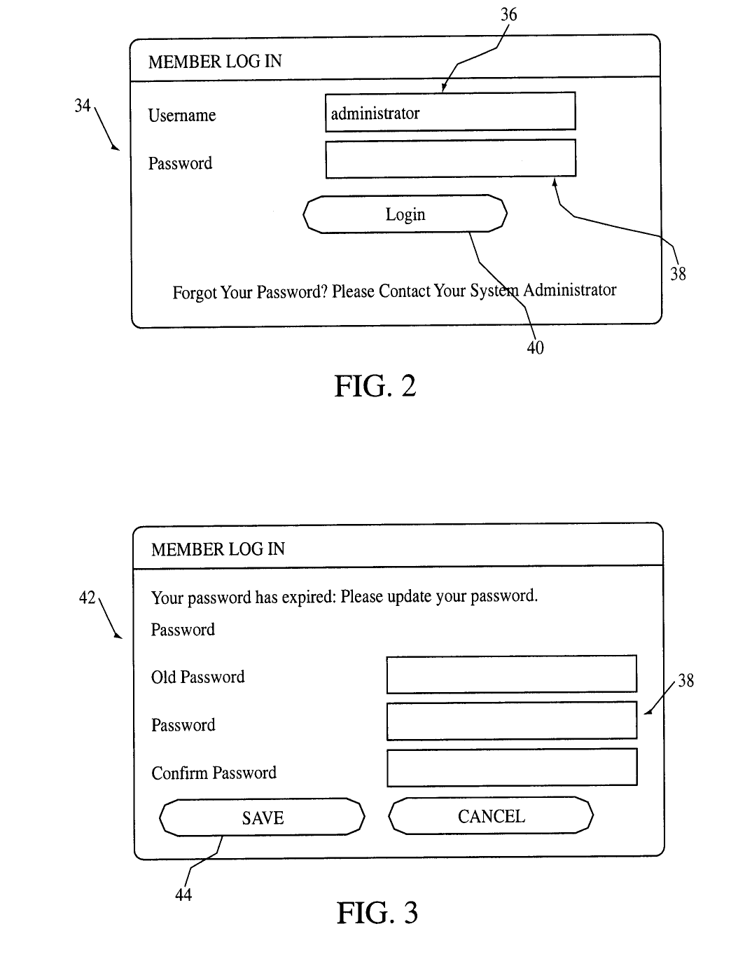

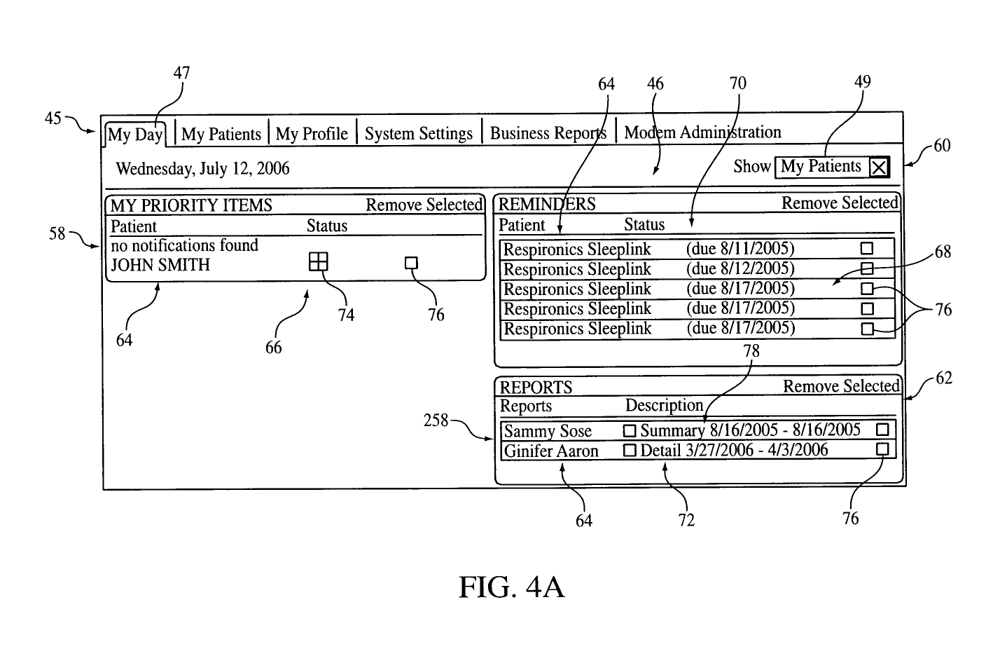

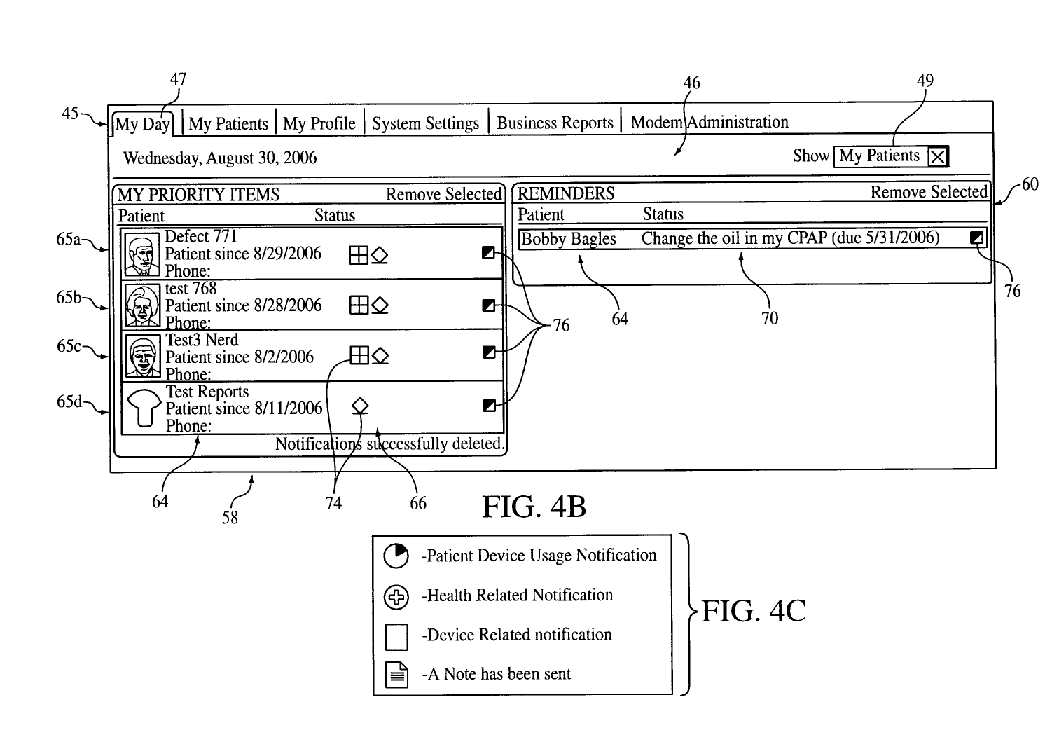

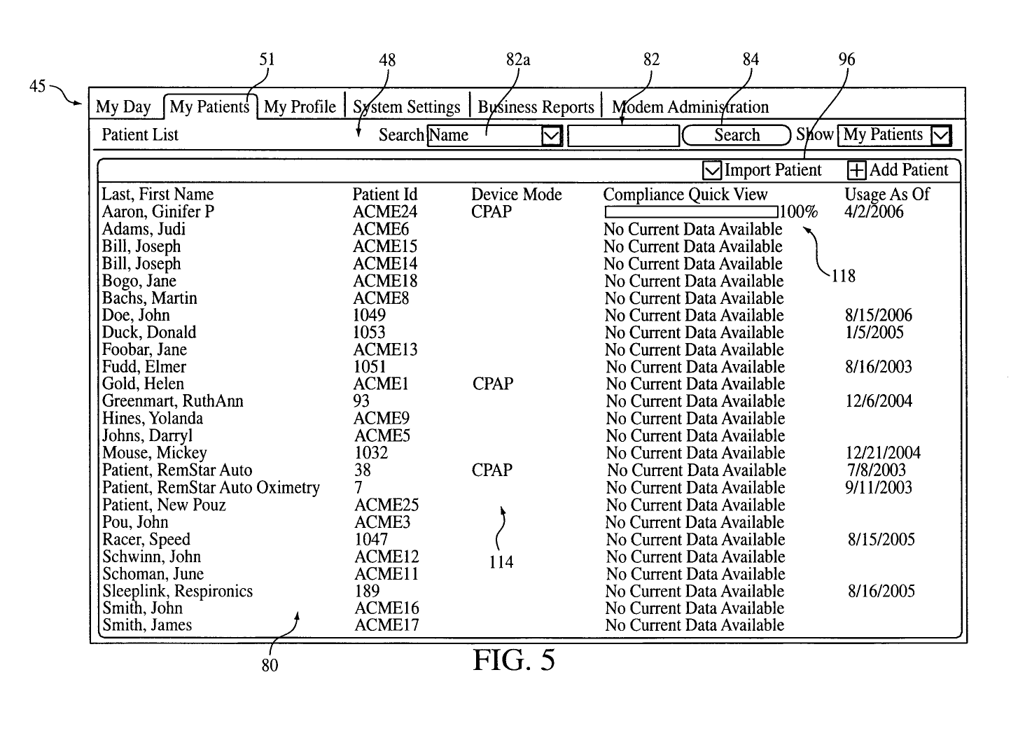

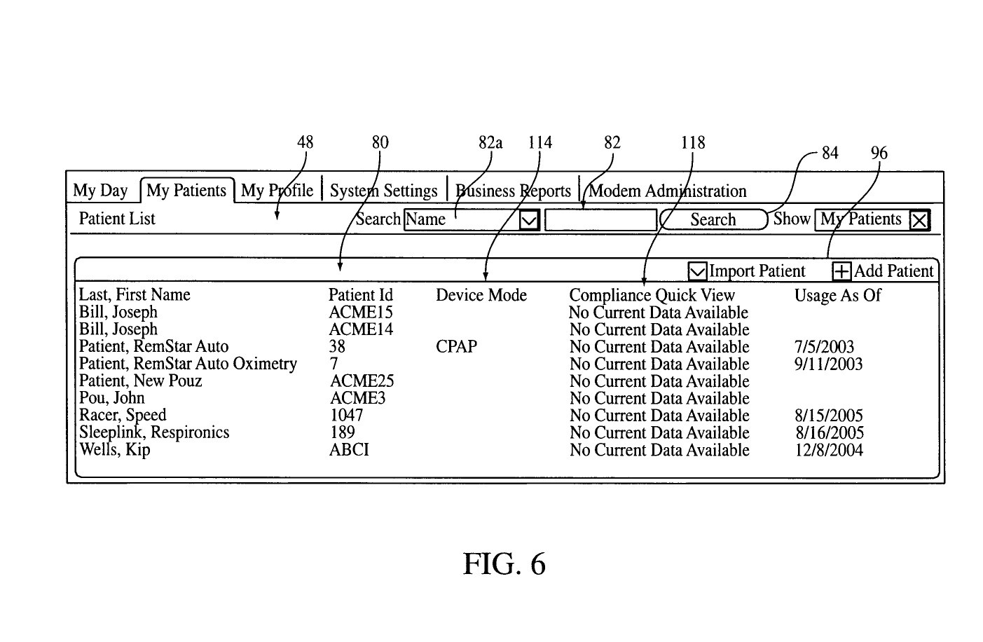

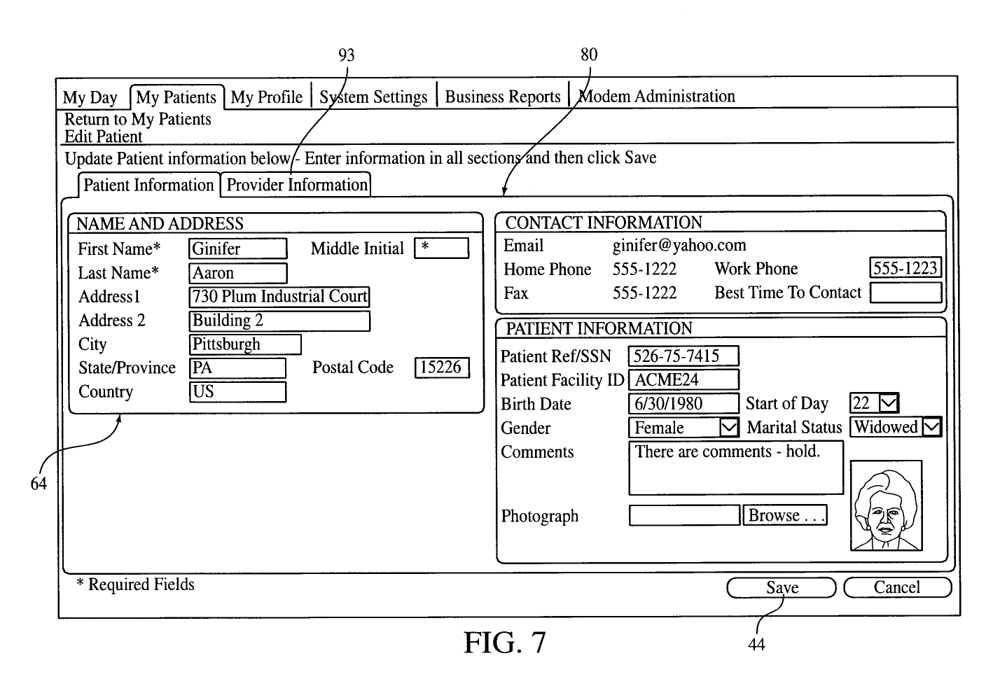

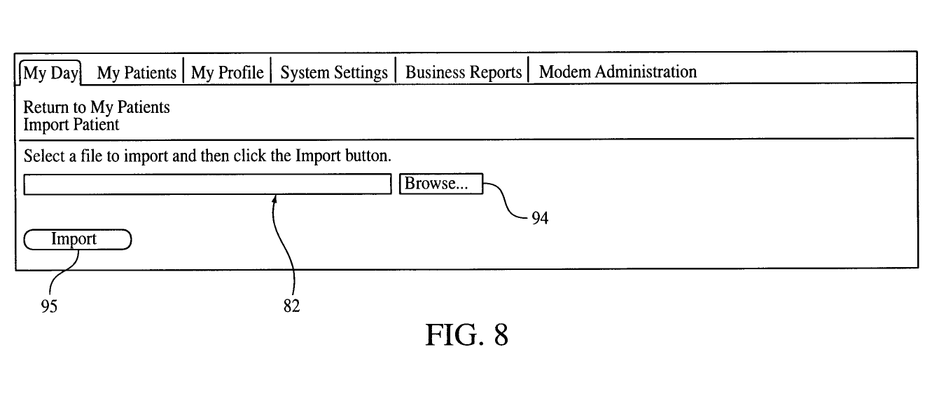

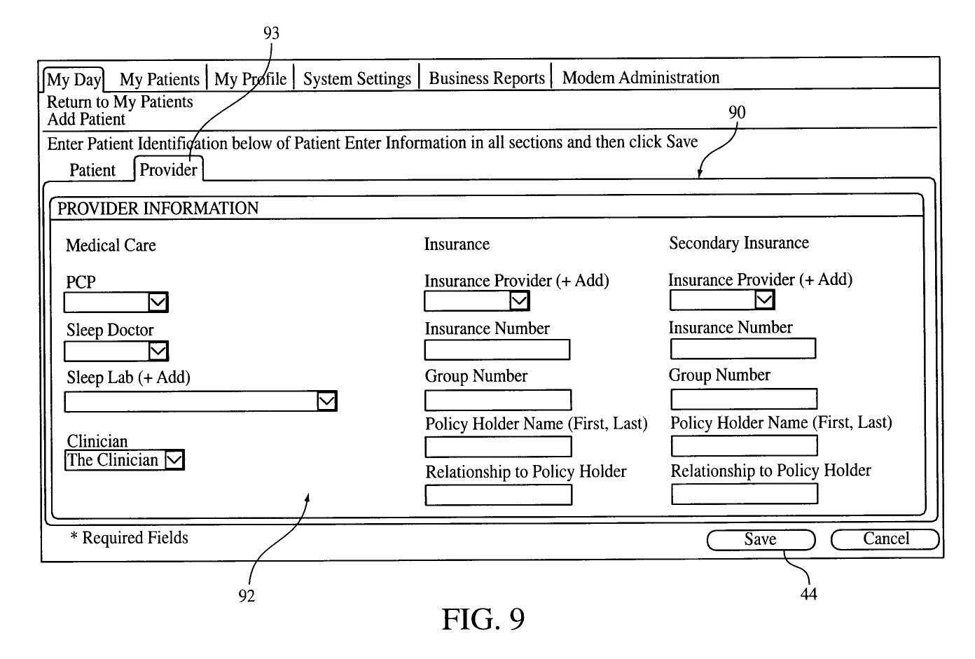

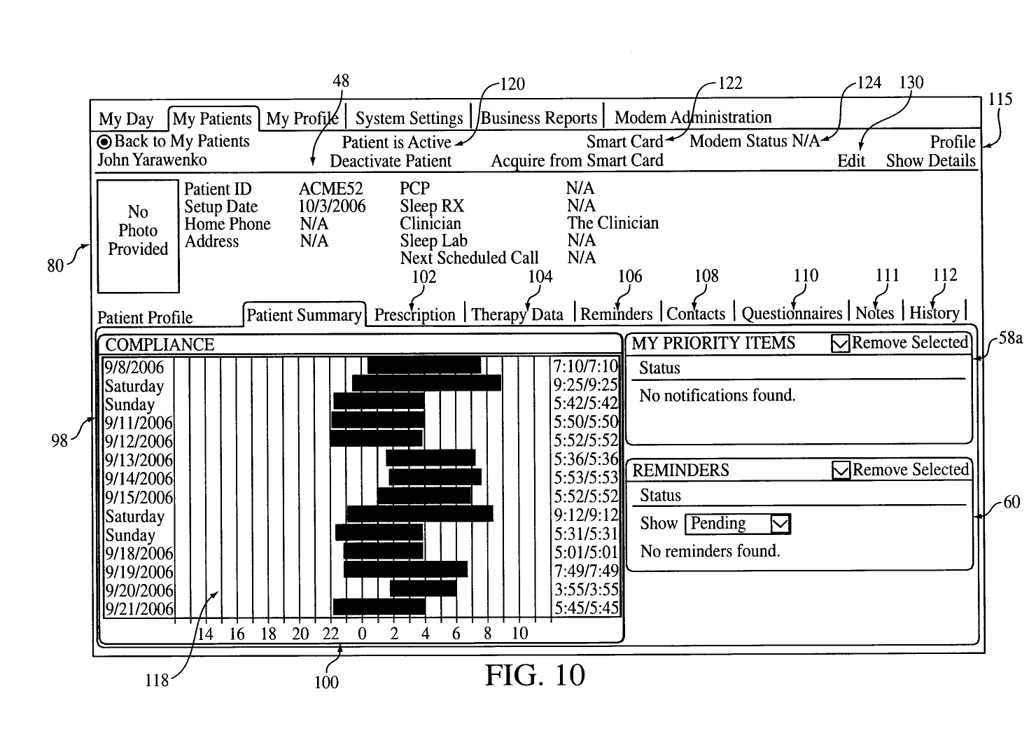

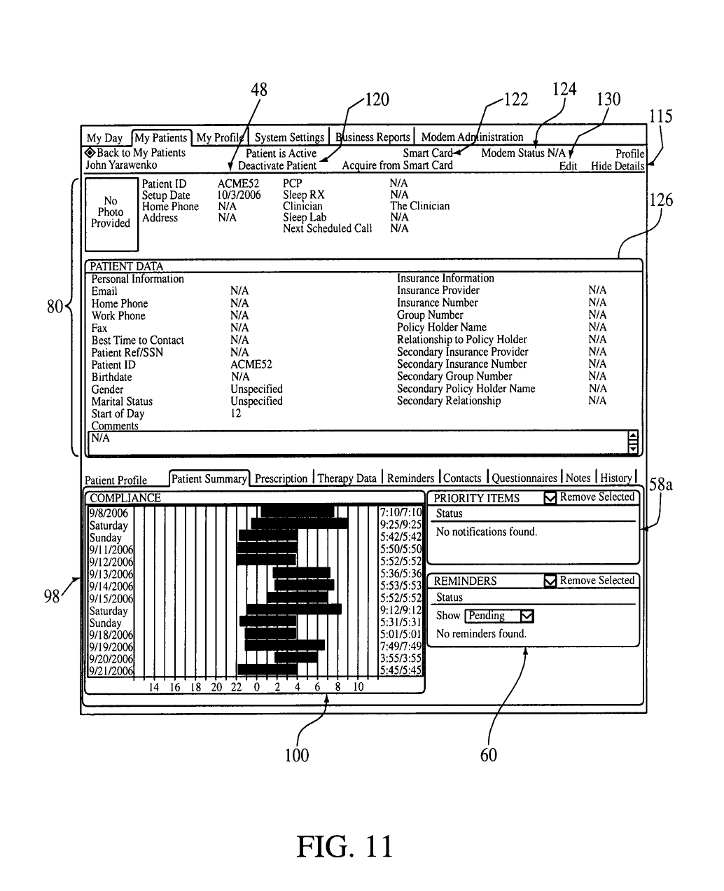

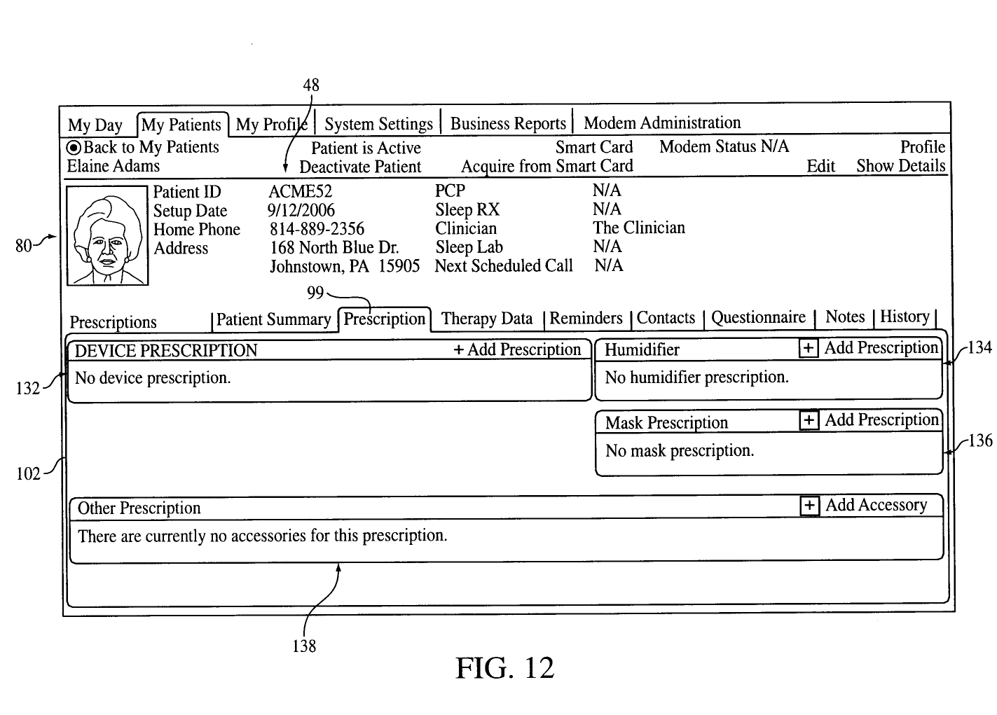

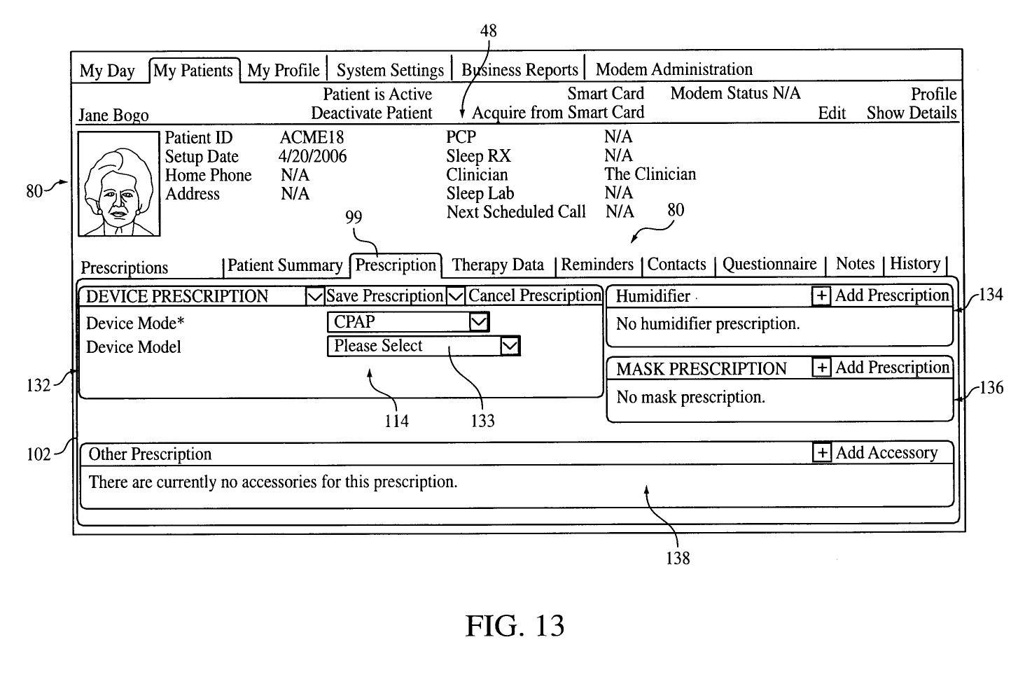

In order to gain access to system 10 and patient information interface 12, a login interface 34 is provided. As seen in FIG. 2, login interface 34 allows user 14 to input user name data 36 and password data 38. In one embodiment, the input field for the user name data 36 will accept up to 50 alphanumeric characters, and the input field for password data 38 will accept up to 16 alphanumeric characters. In addition, login interface 34 includes a login button 40, which, when selected, submits the values from the text boxes for validation and acceptance. If accepted, user 14 will be presented with patient information interface 12. A message may instruct users to contact their administrator A to change the password in the event they forgot it.

A password modification interface 42 will allow user 14 to modify and change password data 38. For example, password data 38 may be set to expire after a certain period of time, in which case password modification interface 42 will be displayed to user 14, requiring that password data 38 be updated or modified (See FIG. 3). Three input fields will be provided, including a field for the old password, the new password and a confirmation of the new password. If the new password and the confirmed password do not match, an error will be displayed to user 14. User 14 will not have the ability to enter the application without changing the password. A save button 44 will be displayed to user 14 for use in saving the new and confirmed password data 38.

Once user 14 gains access to system 10 further screens and functions of patient information interface 12 will be presented. In one embodiment, patient information interface 12 includes a series of screens or areas that can be selectively chosen by user 14. In one embodiment, the screens are changed and navigated through a tabbed orientation. To this end a series of tabs 45 are provided that, when selected, enable the associated screen or screens to be displayed. In FIG. 4A, a “My Day” tab 47 is selected, so that the screen or screens associated with this tab are displayed.

As seen in FIG. 4A, the use of a tabbed navigation bar 45 allows user 14 to choose between the various screens, including a daily data screen 46 (FIGS. 4A and 4B), a patient data screen 48 (FIGS. 5, 6, 11, 12, 14-20, 27-31, 33, 34, 39-43, and 45-48), a profile data screen 50 (FIGS. 35, 49, and 50), a system setting data screen 52 (FIG. 51-76), a business reports screen 54 (FIGS. 77 and 78), and a modem administration screen 56 (FIGS. 79-82) by selecting the appropriate tab. In a preferred embodiment, patient information interface 12 is configured to first display daily data screen 46 to user 14 as a default display. Of course, the system can be configured to display any screen upon start-up. Moreover, the user can select a start-up screen or use a customized screen.

Also, as seen in FIG. 4A among others, each screen 46, 48, 50, 52, 54, 56 is separated into various sections, each displaying appropriate data relevant to user 14 under the categorized section. In particular, on daily data screen 46 of this embodiment, three sections are selectively displayed, including a priority items section 58, a reminders section 60 and a reports section 62. Priority items section 58 is configured to display patient identification data 64 and associated notification data 66. Reminders section 60 is configured to display patient identification data 64, reminder data 68, and deadline data 70. Further, reports section 62 is configured to display patient identification data 64, as well as report description data 72. In this manner, the various data fields are selectively and dynamically displayed to user 14 on any particular section 58, 60, 62 of each screen 46, 48, 50, 52, 54, 56 of patient information interface 12. This data is provided from database 20, which acts as a data warehouse for all data streams and transmits the appropriate data for use in populating a field in any portion of patient information interface 12.

Further, the data and information presented to user 14 may also be selectively displayed based upon a category, which may be selected through a drop-down list 49 or similar function. In the present embodiment, the data may be presented to user 14 under the category “My Patients” and “My Work Team Patients” via drop down list 49. The “My Patients” selection shall be the default setting. When an option is selected from the drop-down list, one or more of the panels below it are refreshed with data relevant to the selection. The priority items section 58 will contain a list of patients P and patient identification data 64 based upon the selection made in the drop-down list. A page control shall be displayed as needed throughout patient information interface 12.

Patient identification data 64 can include a variety of data fields, including a photograph of the patient P, a patient name, a patient identification, patient relationship data, contact data, etc. For example, patient identification data 64 may include how long the patient P has been in system 10 or used a given medical device, e.g., device 16, 18, etc.

Referring again to FIG. 4A, the “My Day” or daily data screen 46 includes a priority items section 58 and/or reminders section 60. In each of these sections, the patient's P information (i.e., the patient identification data 64) is sorted or ordered by priority. For example, this priority listing may be in sequential order and determined by the nature of the associated notification data 66. The associated notification data 66 may be health-related data, device-related data, usage-related data, etc. In addition, a variety of icons 74 can be used to quickly present to user 14 the type of associated notification data 66 for each patient P. For example, icons 74 may represent whether the associated notification data 66 is health-related, device-related, usage-related, etc., and within each category, the associated notification data 66 can be sorted in reverse chronological order.

The meaning of each icon 74 may be found by user 14 by hovering the mouse over the icon 74. In one embodiment, the area where icons 74 are displayed may be capable of presenting multiple icons 74, each representing a type of associated notification data 66, as discussed above. Therefore, the associated notification data may be text, alphanumeric text, a symbol, an icon 74, a visual indicator, etc. This enables the user to see all of the notification data 66 associated with a given patient in a minimal amount of screen space. The records for each patient can then be opened up, for example, by selecting patient identification data 64. This causes detailed information about the patient to be displayed. See, e.g., FIG. 10. The details associated with the notification data is displayed in priority items section 58a. A listing of icons 74 suitable for display as notification data 66 and the meaning of each icon is shown in FIG. 4C.

In priority items section 58, a selectable box 76 may be included for selecting or removing patient identification data 64 and associated notification data 66 from this section. Further, in priority items section 58, patient identification data 64 and associated notification data 66 can be displayed for multiple patients P, and the data displayed in an order of priority based upon the patient identification data 64, the associated notification data 66, health-related data, device-related data, usage-related data, chronological data, etc. FIG. 4B illustrates an embodiment of daily data screen 46 that show how multiple patients are viewed. In this embodiment, four patients 65a, 65b, 65c, and 65d are listed in priority items section 58. The first three patients 65a, 65b, and 65c, each have two icons 74 as notification data associated with them.

The present invention contemplates that usage, health, or device related notifications are generated when patient data is received, typically from either a smartcard or modem. As the data is received, the system examines the data and determines if the data is an exception to a rule that was previously established in the system. Such rules can be set or established, for example, by an HCP H, a system Administrator A, or any other user of the system with authorization to set such rules. As an example, the system may examine the data associated with respiration to identify breathing patterns such the patient, and, in particular, abnormal breathing patterns such as Cheyne Stokes Respiration (CSR). The determination of whether data corresponds to a rule or threshold can be done using any conventional data monitoring routine.

The present invention contemplates that the rules used by the system are currently under set via the System Settings Section on toolbar 45. Examples of calculation rules are compliance related, AHI related, and large leak related. When the data meets the criteria for a rule, a patient note notifications is delivered to the clinician, the HCP, the physician, or any combination thereof.

Also as seen in FIGS. 4A and 4B, in reminders section 60, patient identification data 64, reminder data 68, and deadline data 70 is displayed for multiple patients P and, again, the data is displayed in an order of priority based upon patient identification data 64, reminder data 68, deadline data 70, etc. In reports section 62 (which is omitted from the embodiment of FIG. 4B), selectable box 76 is provided for selecting or removing various report types 78 from a list of multiple report types 78 provided in this section 62. In addition, in reports section 62, the report description data 72 or report type 78 includes a selectable report type 78, wherein, upon selection of report type 78, a report associated with report type 78 for an associated patient P is presented to user 14. In general, reports section 62 serves to provide user 14 with the ability to select and view report data 258 discussed below.

As noted above, another screen available in patient information interface 12 is patient data screen 48, see e.g., FIG. 5. Patient data screen 48 is selected, for example via “My Patients” tab 51 on toolbar 45. Patient data screen 48 selectively displays patient data 80 associated with a each patient P. In FIG. 5, a plurality of patients are shown, i.e., all of the patients associated with the user who logged into the system. Patient data 80 may include, for example, the following: last name, first name, patient identification data 64, company name, clinician name, facility name, provider name, physician name, device data 114, device mode data, compliance data, a graphical representation of compliance data, device usage data, etc.

The present invention contemplates that patient data 80 be displayed on a patient data screen 48 in response to a search query, a search parameter, a drop-down search term, a user input search term, etc. For example, patient data 80 may be selectively displayed based upon a selected category, associated patient data 80, work team patient data, inactive patient data, etc. As seen in FIG. 5, the listing of patient data 80 can be provided in a user-selectable manner. For example, patient data 80 may be sorted in ascending order, descending order, by any of the individual categories, etc.

In order to identify a specific patient P, various search boxes 82 are provided for searching on category types or specific terms or alphanumeric combinations. Once the appropriate category is chosen or term placed in search box 82, a search button 84 is selected to begin the searching process. As discussed above, all patient data 80 may be shown based upon super categories, as selected from a drop-down list, e.g., “My Patients”, “My Work Team Patients”, “Inactive Patients”, etc. As seen in FIG. 6, a patient list is presented to user 14 in response to a search based on either a choice made from a drop-down list or by a choice made from search box 82, possibly in combination with text entered in search box 82. Accordingly, patient data screen 48 will display a list of patients P matching specified search options. FIG. 6 illustrates a list of patients uncovered by searching for a particular set of patients using the search term “p” in search box 82 and “Name” in search field box 82a.

As seen in the example of FIG. 6, patient data 80 that is presented to user 14 in response to the search is the patient's name, identification, device mode, compliance quick view (or graphical representation of the patient's compliance) and usage data. In this embodiment, if compliance data is not available or is older than six months, the phrase “no current data available” will be displayed in the compliance quick view column. Further, these results may be sorted by clicking on any of the column headings, and patient data 80 will then be sorted alphabetically.

On patient data screen 48, user 14 is permitted to add patient data 80, modify patient data 80, import patient data 80, save patient data 80, etc. FIG. 7 illustrates an edit section 128 that is used to edit patient information, which is accessed, for example, by selecting a particular patient from the list of patients and selecting an “Edit” button 130 associated with that patient. See FIG. 10. The patient data that can be edited may include patient information, provider information, identification information, contact information, first name, last name, middle initial, address, city, state, country, zip code, e-mail address, home phone number, facsimile number, work phone number, best time to contact data, social security number, patient facility identification, birth date, gender, start of day data, marital status, comments, photograph, emergency contact data, actual contact data, etc. Of course, the present invention contemplates that any of the data throughout system 10 can be added, deleted, modified, edited, saved, etc. by any user 14 having the appropriate access and administrative authorities.

Once all of the appropriate information and data has been placed in the appropriate fields, a save button 44 may be selected to save patient data 80. Input fields that require mandatory input may be designated with an asterisk to the right of the field label, and this asterisk indicates that user 14 must enter patient data 80 into such fields. Any number of data points or patient data 80 may be input into the patient P record during the operation of adding or modifying a patient P in system 10. A blank patient data 80 is provided if a new patient is to be added. To add a new patient, the “Add Patient” item in FIG. 5, for example, is selected. The necessary information is filled into the blanks and save button is actuated to save the new patient.

Another function provided at patient information interface 12, and as illustrated in FIG. 8, is that patient data 80 may be imported into system 10 from a preexisting file or database. This is accomplished, for example, by actuating “Import Patient” button 96 in FIG. 5. As shown, user 14 may select a browse button 94 to locate the file, and once found, select the import button 95 to import the data into system 10. It is envisioned that patient data 80 may be provided in a variety of forms and formats, such that system 10 may parse the imported data stream and related file type in order to extract the necessary information to create a patient file and populate the appropriate fields in database 20. Accordingly, system 10 allows for user 14 to activate or deactivate a patient P, acquire data from an external source, input data, modify data, save data, delete data, receive external data, transmit data to an external device, etc.

A provider section 90 may also be displayed to user 14 at patient information interface 12. In the example illustrated in FIG. 9, provider data 92 is entered for the patient P in section 90. provider section 90 may be accessed, for example, by selecting “Provider Information” tab 93 in FIG. 7 when entering or editing patient data. This tab is referred to as “Provider” tab 93 in FIG. 9. Provider data 92 may include the primary care physician, the sleep doctor, the sleep laboratory, the clinician, insurance data, secondary insurance data, insurance provider data, insurance number data, group number data, policyholder name, relationship to policyholder, etc. Of course, any of this data may already be included in a drop-down selectable menu, or if required, directly entered into a text input field.

In order to better present patient data 80 to user 14, in patient data screen 48, a patient profile section 98 is provided. Patient profile section 98 is configured to present patient data 80, patient detail data, patient summary data 100—accessed via a “Patient Summary” tab, prescription data 102—accessed via a “Prescription” tab, therapy data 104—accessed via a “Therapy Data” tab, reminder data 106—accessed via a “Reminder” tab, contact data 108—accessed via a “Contacts” tab, questionnaire data 110—accessed via a “Questionnaires” tab, notes data 111—accessed via a “Notes” tab, and history data 112—accessed via a “History” tab. As discussed above, each set of such data may be presented on separate screens, different sections or in tabbed form, as illustrated in FIG. 11A. In one embodiment, patient summary data 100 includes compliance data 118, usage data, a graphical representation of usage data, a graphical representation of compliance data, dates of use, patient priority item data, status data, reminder data, selectable data, etc.

Compliance data 118 illustrates or other indicates the patient's use of patient device 16 and other data related to that use, as associated with the patient's compliance with a therapeutic regimen. Accordingly, user 14 can quickly visualize the state of the patient's compliance with his or her therapy. The priority data may be provided in patient profile section 98 in a similar manner as discussed hereinabove in connection with priority items section 58a. As noted above, priority items section 58a preferably shows details regarding notification data 66, e.g., the meaning behind icon 74.

Similarly, reminder data 62 may be presented to user 14 in patient profile section 98, as discussed above in connection with reminders section 60. It is this patient summary data 100 that would provide user 14 with an abbreviated, yet important snapshot of the important patient data 80 associated with any particular patient P.

User 14 may engage in a variety of other functions either at this patient profile section 98 or in other applicable areas of patient information interface 12. For example, user 14 may activate or deactivate a patient P by selecting an activity button 120. Deactivating a patient means that the data for that patient will not show up on any lists. This may occur when the home care provider no longer wishes to monitor the data for a particular patient, for example, if the patient the switches HCPs, discontinues therapy, passes away, etc. The present invention contemplates that the patient data is not deleted altogether, but is simply not displayed, i.e., by deactivating patient, when information related to such a patient is no longer of interest to the user.

In addition, user 14 may acquire data from Smartcard 22 in a process that is initiated by selecting an acquire button 122. This process will be described in greater detail hereinafter. In addition, a modem settings button 124 is provided to user 14, and when selected, links to a modem management screen, which is discussed in further detail hereinafter. It is also envisioned that modem status data and scheduled call data may also be displayed on patient profile section 98 or elsewhere in patient information interface 12.

As discussed above, compliance data 118 may be shown to user 14 in a graphical form. For example, for each date and hour intersection, a block may be displayed. The block would indicate the hours of usage of patient device 16. If the number of hours is a minimum of four, the bar and corresponding date and time may be in neutral color as determined by the visual scheme. If the number of hours is more than zero but less than four, the bar may be a shade of red. Finally, if the number of hours is zero, no bar would be displayed. In this manner, user 14 may quickly view a patient's usage of patient device 16. In addition, user 14 may select how much compliance data 118 is provided and presented.

With respect to reminder data 106 as discussed above, many of the records and data fields in patient information interface 12 include selectable box 76. Selectable box 76 can be used to remove items that are selected in a specified list, and the list would then refresh with the remaining items. In addition, a message may be displayed stating that the listing has been successfully updated.

As discussed above, reminder data 106 may be provided to user 14. The user 14 may select what type and category of reminder data 106 he or she wishes to review by using a drop-down list, text search, etc. Reminder data 106 is ordered by due date in chronological order, where the oldest are listed first. Some categories that are available include the ability for user 14 to show all reminder data 106, completed reminder data 106, pending reminder data 106, etc. Changing a selection in the drop-down list will retrieve the selected list of reminder data 106, and any checkboxes that have been selected would be cleared.

As shown in FIG. 11, a patient detail section 126 can be displayed to user 14 as part of patient data 80, as opposed to merely patient summary data 100. Patient detail section 126 may display patient data 80 in a detailed form, as opposed to a summarized form. In addition, comments may be added and saved as part of patient data 80 and associated with a particular patient P. Whether a detailed view of the patient data (FIG. 11) or a summary view (FIG. 10) is shown is determined by selecting “Show Details” tab 113 in FIG. 10 or “Hide Details” tab 115 in FIG. 11. The present invention contemplates that the show and hide details buttons can be provided on other screens to allow the user quick access to details about a patient as desired.

As noted above, prescription data 102 is also presented to user 14 in patient profile section 98, preferably in a different section or tabbed area. For example, the present invention contemplates that the prescription data is displayed upon selecting “Prescription” tab 99. As shown in FIG. 12, prescription data 102 may include patient identification data 64, setup date, home phone number, address, primary care physician D, sleep prescription, clinician C, sleep laboratory, call data, device mode, device model, device data 114, humidifier data, mask data, prescription data, selectable data, comment data, issuance data, etc. As seen in FIG. 12, prescription data 102 may be broken down into different areas and categories, including a device prescription section 132, a humidifier section 134, a mask prescription section 136, and an other prescription section 138. Each section 132, 134, 136, 138 will include a variety of prescription data 102 related to the appropriate section 132, 134, 136, 138, and prescription data 102 may be selectable, modifiable, categorized or configured by user 14, using a variety of techniques, including drop-down lists, selection boxes, searching functions and the like.

In device prescription section 132, the device mode and the device model can be selected from a drop-down list 133. See FIG. 13. In addition, depending upon the device mode and model selected, the serial number, issue date, pressure setting, device settings, alert settings, and other selectable features of the device can be selected from either drop-down lists 135 or other data selection screens. See FIG. 14. A calendar can be accessed via a calendar button 137 to set the issue date. Additionally, it should be noted that all of the data provided in these sections are dynamically displayed and appropriate to the device mode and model selected.

FIG. 15 illustrates one feature of system 10 where the prescription data 102, and in this case the prescription data associated with patient device 16, can be sent to patient device 16. In particular, once the appropriate settings are selected, prescription data 102 can be sent to a Smartcard 22 or directly to patient device 16 by selecting send button 140. Once selected, the appropriate prescription data 102 is used to program, reprogram or otherwise communicate with patient device 16. In other prescription section 138, prescription data 102 associated with accessories and other devices can be selected and chosen. For example, prescription data 102 may include an item description, serial number, issue date, replacement reminder, etc. As illustrated in FIG. 16, prescription data 102 associated with a humidifier and a mask is selectable and modifiable in the humidifier section 134 and mask prescription section 136.

FIG. 16 further illustrates the use of multiple edit buttons 130 for editing and/or modifying prescription data 102 in a respective section 132, 134, 136, 138. For example, prescription data 102 in the device prescription section 132 is modifiable (FIG. 17), and prescription data 102 in the other prescription section 138 is modifiable (FIG. 18). However, it is envisioned that any of the data in any of the sections is modifiable depending upon the access level and authorities given to user 14. In these embodiments, drop-down lists are provided for editing the data. Of course, any conventional technique can be used for this purpose.

FIGS. 19A-19E illustrate further embodiments for setting device prescription section 132a, humidifier section 134a, mask prescription section 136a, and other prescription section 138a. Device prescription section 132a shows the selection of an AutoCPAP as the device mode. Such a device can vary the pressure delivered to the patient over a range of pressures. A typical autoCPAP device limits the range of pressure that the device can deliver to the patient. Thus, the maximum and minimum pressure are shown in boxes 139a and 139b.

FIG. 19E illustrates device prescription section 132b that is displayed if a user selects “Yes” for a “use modem” box 129 in FIG. 19A. In this embodiment, the user is prompted to input a validation number in box 131. This is a required field that must be completed. Once all required data is entered the user actuates save button 131a.

The present invention contemplates providing a technique for self-validating a serial number entered into the system—for example, a serial number entered into a serial number field 141. To accomplish this, the system provides a validation number to insure that the serial number is typed correctly. The validation number is a convention that allows patient data management system 10 to assign a number to a device, based on a serial number of the device, which can insure that when typed by a user, it is entered correctly. In this case the device is a modem, which is a specific type of communication device 18.

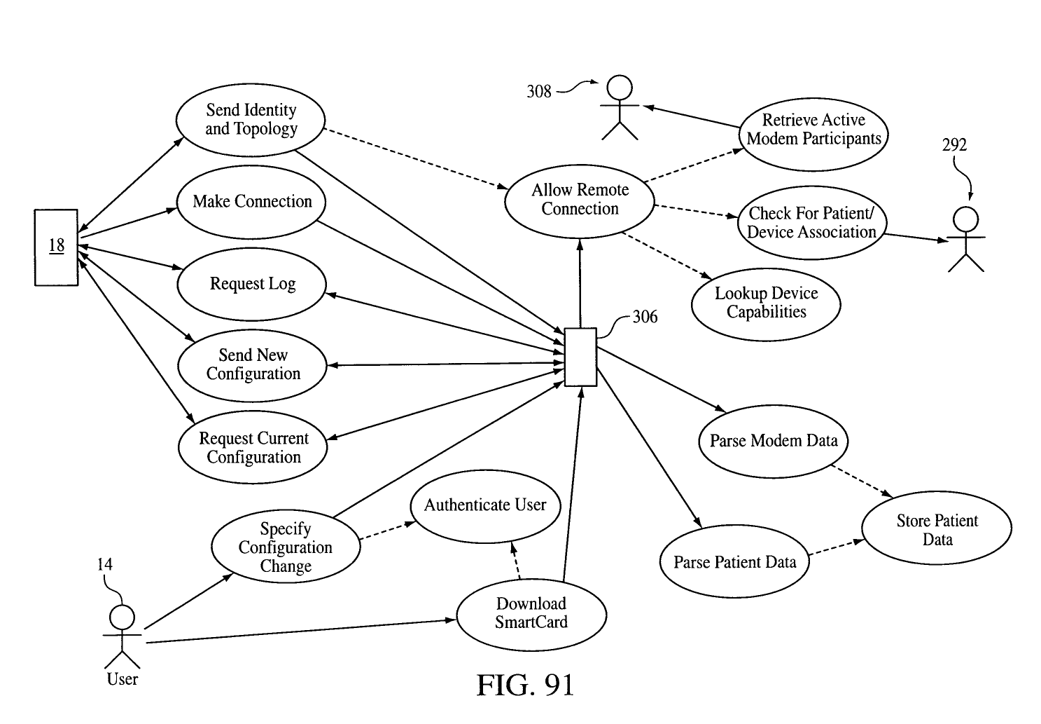

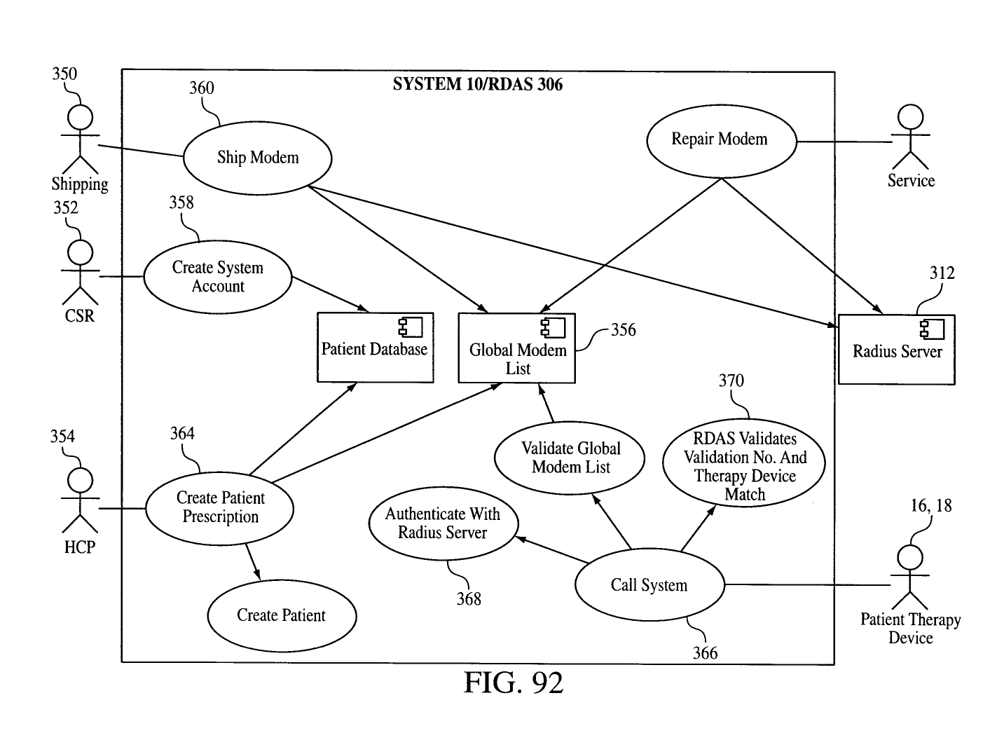

In an exemplary embodiment, the validation number is be comprised of two parts; (a) a modified serial number, and (b) a validation code. The validation code is added to the end of the modified serial number and is generated using a well known technique to insure its correctness. For example, if the serial number is 12345, a formula to sum the characters to generate a two digit validation code can be provided. Such a formula would produce the following validation code: 1+2+3+4+5=15. The validation number for serial number 12345 would then be 1234515. The validation number is discussed in greater detail below with respect to FIG. 92.

The modified serial number, which is a modified version of the serial number typically used by the product tracking database, such as SAP, used by a device manufacturer; and a validation code. The modified serial number is based on the serial number but includes less characters, while still being unique or nearly unique to the serial number. In an exemplary embodiment, the modified serial number is generated by combining the actual serial number into a six digit number, which is followed by a 4 digit validation code.

### EXAMPLE

serial number: WM123456789

validation number: (modified serial number/validation code)=49P302/3718.

The modified serial number is a base 31 representation of the actual serial number digits. This provides a range of over 887 million possible serial numbers represented in 6 digits (31 [symbol] 6). The numeric set consists of:

0123456789BCDFGHJKLMNPQRSTVWXYZ (no vowels).

### The set contains only consonants and no vowels (this is to insure that no words can be formed from the output string). All alpha characters will be upper case.

### As an example, to convert 123456789 to base 31:

31) 123456789
31) 3982477 r2
31) 128467 r0
31) 4144 r3
31) 133 r 21 (P)
31) 4 r9
0 r 4=49P302
   Or going the reverse:

$$2 + \\ ( 0 * 31 ) + \\ ( 3 \times 31 \hat{} 2 ) + \\ ( 21 \times 31 \hat{} 3 ) + \\ ( 9 \times 31 \hat{} 4 ) + \\ ( 4 \times 31 \hat{} 5 )$$

$$\_\_\_ \_\_\_ \_\_\_ \_\_\_ \\ = 123456789$$

The validation number is provided, not necessarily to prevent unauthorized access to the system, but mainly to ensure that, with a reasonable certainty, the user has typed the proper serial number into the serial number field. In order to make the entry as concise as possible for the end user, it has been determined that a 16 bit numeric hash of the communications number string is sufficient. Of course, the present contemplates using less bits, with understanding that the possibility of an incorrect number being accepted increases. Conversely, more bits decreases this possibility but require the entry of more characters by the user.

In the embodiment discussed above, the validation number is used in combination with the modem to help ensure that the serial number of the patient device was entered correctly. The present invention also contemplates that this technique can be used even if the modem is not being used. For example, a validation number field can be provided in FIG. 19A-19D, or any time a serial number is to be entered, so that the system can validate whether the serial number has been input correctly.

Therapy data 104 may be displayed in the form of a therapy data section 142. See FIG. 20. For example, the present invention contemplates that the therapy data is displayed upon selecting “Therapy” tab 143. As shown in FIG. 20, therapy data 104 in therapy data section 142 may include therapy data, device data, model data, mode data, start date, end date, therapy report data, device usage data, compliance data, a graphical representation of the device usage data, a graphical representation of compliance data, report data, historical report data, selectable data, etc. In this manner, therapy data 104 is selectable for a specified period of time by user 14 and presented in a detailed format, a summary format, a graphical format, etc.

Therapy data section 142 may include various subsections, as illustrated in FIG. 20. In particular, in the embodiment illustrated, therapy data section 142 includes an available therapy data section 144 and a therapy data reporting section 146. Available therapy data section 144 selectably displays available therapy data in a tabular form. In particular, therapy data 104 displayed in this section 144 includes the device model, device mode, usage start date, usage end date, etc. In addition, the data in this section 144 is sorted by start date in reverse chronological order.

Therapy data reporting section 146 allows user 14 to create and view a wide variety of therapy data 104 in a report format. In the embodiment of FIG. 20, therapy data reporting section 146 includes three panels, namely a time span panel 150, a pattern of usage panel 152, and a report type panel 154. Time span panel 150 allows user 14 to select the time and/or amount of therapy data 104 to be reported upon, e.g., one week, one month, six months or for a selectable custom setting. The custom setting would allow user 14 to enter a start date and an end date to define the custom start and end periods. Such values would be limited to valid date values, and the value in the start date input field must be a date occurring before the value in the end date field.

In addition, user 14 may have the ability to enter the date via a calendar control or by typing into a text box. The start and end date controls are active when the custom date range is selected, however, if the radio button is changed from custom, the date fields will be cleared. In addition, the therapy data reporting section 146 includes a refresh graph button 156. By selecting button 156, the graphical content in the pattern of usage panel 152 is updated for the terms and time periods set forth in the time span panel 150.

In pattern of usage panel 152, a graphical representation of therapy data 104 is dynamically presented to user 14. In the embodiment of FIG. 20, the graphical representation includes four columns, namely a checkbox, date, usage pattern in bars and total time for all sessions in a day. The usage pattern bars are in three colors, namely green for therapy time, black for blower time and red for therapy time less than prescribed. The total time of usage is expressed in hours and minutes as HH:MM/HH:MM, where the time on the left side of the slash represents total therapy time and the time on the right side of the slash represents total blower time. Time values shown in red represent therapy time that is less than prescribed.

The pattern of usage panel 152 also includes selectable box 76. By selecting selectable box 76, the selected day will be included in the statistics, while an unchecked or unselected box 76 means that the day is excluded from all usage statistics. The default values of the boxes are selected. After user 14 has checked or selected all the appropriate selectable boxes 76, an include/exclude days button 158 is selected. This will apply the change and refresh the graph accordingly. When a day is excluded, i.e., selectable box 76 by the day is not selected, a horizontal strikethrough will be drawn over the day.

Report type panel 154 includes two radio buttons for summary reporting and for detailed reporting. Once user 14 selects the type of report desired, a create report button 160 is selected and initiates the report request. If a selected time span is a data range where the data comes from the same source, e.g., a communications device 18 or Smartcard 22, and the data format is the same, the data will be merged and displayed. If the data is not from the same source and the same data format, an error message will be displayed indicating that no report is available. The name of the report will be generated and given a default name, such as “Summary Start Date-End Date” or “Detail Start Date-End Date”. When user 14 selects a relative time for the report, e.g., one week, one month, etc., the data displayed in the patterns of usage graphical representation will begin with the last data available in the time span. A detailed report is available when the data contained within the specified date range has equivalent format identifications returned from device 16.

The present invention contemplates that completed reports can be shown in a completed reports section 148 that can also be included in therapy data 104. An example of completed reports section 148 is illustrated in FIG. 21. In the illustrated exemplary embodiment, completed reports section 148 section 148 includes two columns, including a description column and a selectable box 76. Clicking on the report name in the description column will open up a report document in a new window, such as in a .pdf form or the like. Also, completed reports section 148 allows user 14 to select selectable box 76 that removes checked items from the reports list, refreshes the list and displays a confirmation message, or does nothing if no items are selected. The report records listed shall be ordered by their generation date in reverse chronological order.

As seen in FIG. 22, another type of report that is offered to user 14 at patient information interface 12 is a compliance pattern of usage report 162. Compliance pattern of usage report 162 includes compliance data 118, which is dynamically displayed to user 14 upon selection. This report may include the date, a graphical representation of device usage, time of device usage, selectable boxes 76 to tailor usage report 162, as well as report date range selection.

Under patient profile section 98 is reminder data 106 that is displayed in a reminders section 164. In particular, reminder data 106 is displayed in reminders section 164 according to the configuration and selection of user 14. The reminders data is accessed, for example, by selecting “Reminders” tab 165. As seen in FIG. 23, the reminders section 164 may include a drop-down list for selecting which type of reminder data 106 should be displayed. In addition, reminders section 164 includes an input text box 166 where the user may directly input or type text to describe the activity and create the reminder. Further, as discussed above, a selectable box 76 may be used to include or exclude reminder data 106 from reminders section 164.

Reminder data 106 is displayed by order of due date in chronological order, with the oldest listed first. An add reminder button 168 may be selected by user 14 which allows the user to add additional reminder data 106 to system 10. The drop-down list of what reminder data 106 should be shown may include the following options: “pending” (open reminders), “completed” (closed reminders) and “all” (all reminders). The reminder data 106 will be refreshed and displayed to user 14 based upon what category is selected.

FIG. 24 illustrates an add reminder section 167 that is accessed the “Add Reminder” button 168 is actuated. When adding reminder data 106, user 14 should add the appropriate message in a text box 166, together with the due date or deadline for the activity. Of course, this date may be selected from calendar function 137 or similar input function. Once the appropriate message has been place into the text box 166, together with the associated date or deadline, a save button 44 is selected to save the data. In this manner, user 14 is permitted to add reminder data 106, modify reminder data 106, save reminder data 106, delete reminder data 106, select reminder data 106, organize reminder data 106, etc.

As illustrated in FIG. 25, contact data 108 (which includes actual contact data 88) is displayed to user 14 in a contacts section 170. Contacts section 170 is displayed, for example, when “Contacts” tab 171 is actuated. Contact data 108 may include contact date, contact type, contact reason, contact notes, contact comments, etc. In addition, contacts section 170 allows user 14 to add contact data 108, modify contact data 108, save contact data 108, delete contact data 108, select contact data 108, organize contact data 108, etc. As shown in the embodiment of FIG. 25, each contact includes a date on which the patient P was contacted, the method by which the patient P was contacted, the reason why the patient P was contacted and a summary of notes portion.

As discussed above, user 14 is capable of adding contact data 108. In particular, by selecting an add contact button 172 (see FIG. 25) the user is directed to the screen illustrated in FIG. 26. User 14 will then add appropriate date, type, reason and summary data and select save button 44. In this manner, contact data 108 can be added to system 10. Further, any authorized user 14 can view this contact data 108 for use in making patient P interaction decisions. Section 86 is where user 14 would enter the date, type, and reason for making contact with the patient P. In addition, notes can be placed in this section, and once actual contact data 88 is appropriately filled into the fields, save button 44 may be selected. For example, as seen in FIG. 26, an e-mail contact was made on Jun. 16, 2006 because patient device 16 was found to not be functional. In the notes section, user 14 entered that an appointment should be made. This note or comment may be accessible by and presented to any of the users 14, based upon the authorization level of the user.

FIG. 27 demonstrates an embodiment of system 10 where questionnaire data 110 is in a questionnaire section 174 in patient profile section 98. Questionnaire data 110 is displayed, for example, by actuating “Questionnaire” tab 175. Questionnaire data 110 may include a summary of questionnaires completed by the patient P. New questionnaires may also be added in questionnaire section 174. Accordingly, questionnaire data 110 may include questionnaire questions, questionnaire responses, questionnaire dates, questionnaire type, questionnaire score, questionnaire status, summarized data, report data, etc. In addition, as discussed above, in connection with the other sections, questionnaire section 174 allows user 14 to add, modify and/or delete questionnaire data 110, questionnaire questions, questionnaire responses, questionnaire dates, questionnaire type, questionnaire scores, questionnaire status, summarized data, report data, etc.

While questionnaire data 110 may include any type of questionnaires, tests, etc., in one preferred embodiment, and as illustrated in FIG. 27, the relevant questionnaire data 110 includes a Functional Outcomes of Sleep Questionnaire (FOSQ). In this embodiment, questionnaire data 110 includes the test date, the name of the test, i.e., FOSQ test, the score of the patient P on the test, as well as a selectable request report button 176 for obtaining a desired report regarding questionnaire data 110.

As seen in FIG. 28, questionnaire data 110 may include a questionnaire having a list of questions that can be answered by clicking or selecting a test answer button 178. This list of questions can be displayed by calling up a new questionnaire, for example via “Add FOSQ” button 177 in FIG. 27. Once all the appropriate questions have been answered by selecting the test answer buttons 178 desired, save button 44 is selected to save the questionnaire data 110. If the request report button 176 is selected, a message box 180 is displayed to user 14. See FIG. 29.

In particular, message box 180 informs user 14 that a report document will be generated (such as in an .pdf format or the like), and that this report will be displayed when fully compiled. Further, this report will be available to user 14 for a set time period, after which it will be deleted. Accordingly, user 14 must save the report to his or her local computer if a permanent record is desired. Once a new test or questionnaire (questionnaire data 110) is saved by selecting save button 44, a message that the questionnaire is “pending” is displayed in the report column. As discussed above, this column will also display a “view PDF” button if applicable, and this message is also displayed if the report is available on the server. Clicking the “view PDF” button will display the questionnaire or test in an appropriate reader. See FIG. 30

As illustrated in FIG. 31, note data 111 is displayed to user 14 in a notes section 179. Notes section 179 is displayed, for example, when “Notes” tab 181 is actuated. Notes section 179 allows the user to write textual notes regarding the current patient. Notes section 179 may include a note entry box 201, an add button 203, a send notification to sleep physician check box 205, and note history section 207. In the illustrated exemplary embodiment, note history section 207 contains the following four columns of information regarding recent notes: date, author, note, and notified. The present invention contemplates that a user, such as a physician D, clinician C, or HCP H can create an unlimited number of notes per patient P. Users have the option of sending a copy of a note to the patient's sleep physician, by selecting send notification to sleep physician check box 205. When add button 203 is clicked, the note is then sent to the patient's physician as a notification. Note history 207 section lists all notes previously created in reverse chronological order.

FIGS. 32 and 33 are graphical illustrations showing how notes are sent to the various uses of system 10 according to the principles of the present invention. Referring first to FIG. 32, when a patient P, HCP H, or clinician C enters a note as a user, that note is automatically saved. If the patient entered the note, the note is also sent to the HCP H and/or clinician C responsible for supervising that patient, as indicated by path 209. The patient, HCP, or clinician has the option selecting send notification to sleep physician check box 205. If this box is selected the note is also automatically sent to the sleep physician, as indicated by dashed path 211. This note can be provided to the physician via e-mail or available to the physician the next time they access system 10.

Referring now to FIG. 33, when a physician P enters a note as a user, that note is automatically saved, and is also automatically sent to the patient and the HCP and/or clinician, as indicated by path 213. Of course the present invention also contemplates that notes can be sent automatically or selectively to each type of user or each specific user. For example, boxes can be provided to allow the user to decide who notes should be sent to. In addition, administrator A can also send and receive notes in a similar fashion. These features of the present invention provide easy communication between the parties involved in monitoring the wellbeing of the patient.

Also under patient profile section 98 is a display for history data 112 in the form of a history section 182. History section 182 is displayed, for example, when “History” tab 183 is actuated. History data 112 may include patient data 80, patient history data, patient interaction data, interaction date, status data, report data, etc. For example, as seen in FIG. 34, history data 112 associated with a specific patient P is presented to user 14. In this embodiment, history data 112 includes the date, the interaction type and any associated report. As with the previous questionnaire section 174, in order for user 14 to obtain a report or report data in a desired report form or type, a request report button 176 may be selected. The report function in the history section 182 is similar to the report function in the questionnaire section 174 discussed above.

Another area of patient information interface 12 is profile data screen 50. See FIG. 35. In the illustrated embodiment, profile data screen 50 includes two areas: a general information section 184 and a password section 186. In addition, it is in profile data screen 50 that user data 188 is displayed to user 14. User data 188 may include user name, first name, last name, e-mail address, work team data, role data, facility data, title, group practice data, UPIN number, address, phone number, facsimile number, time zone, etc. Such user data 188 is displayed to user 14 in general information section 184. In password section 186 of the profile data screen 50, user 14 is permitted to modify his or her password data 38, confirm password data 38, save password data 38, etc. Accordingly, user 14 is allowed to manage his or her account on system 10 in this section 50.

As discussed above, user 14 is capable of acquiring data from patient device 16 by selecting an acquire data button 122. See FIG. 10. By selecting acquire data button 122, user 14 is directed to an acquire data area 190, as illustrated in FIGS. 36 and 37. When acquiring data from a Smartcard 22, for example, user 14 must select the type of Smartcard reader from a listing. This listing may include selectable radio buttons labeled as “serial AM512”, “serial Mako Tech”, “USB” and “PCMCIA”. In addition, acquire data area 190 includes a start download button 192 to initiate the downloading process. Only those options available to the type of card reader on patient device 16 are available for selection. In addition, when start download button 192 is selected, system 10 evaluates the data on Smartcard 22 and compares it to the currently-displayed patient P. If patient data 80 or device data 114 matches the data in database 20 of system 10, the appropriate data will be obtained from Smartcard 22 and a “successful acquisition” message will be displayed to user 14. If patient data 80 and the device data 114 do not match, an error/alert window will be displayed, as seen in FIG. 37. As illustrated, the window will display a message that the information does not match in order to inform user 14 of the error.

As seen in FIG. 38, user 14 may also program a device, such as write prescription data onto a Smartcard 22, in a program area 194. This area is accessed from any appropriate screen, such as that shown in FIG. 10. As discussed above in connection with acquire data area 190, user 14 must first select the appropriate device model or communications platform for providing data to Smartcard 22. In addition, program area 194 will include appropriate text boxes 166 to allow user 14 to input device data 114 and/or prescription data 102 for use in programming Smartcard 22. This represents an important communications feature and allows user 14 to manage the therapy of the patient P through communications from system 10 to patient device 16. This, in turn, provides a much more robust and efficient system 10 for communications and interactions between the clinician C, physician D, and patient P. Further, system 10 allows user 14 to program and interact with any remote patient device 16 or communications device 18, given the appropriate authorizations by the administrator A.

The above-described screens and sections are available to any user 14 having the appropriate access rights and authorization. However, it may be desirable to only provide a user 14 with limited data viewing or manipulation rights based upon his or her function. For example, a clinician C may be afforded all of the rights described above, while a physician D may be afforded a limited set of rights. In another example, Physician D may have access to the full functionality and viewability of patient data 80 in patient data screen 48, including the searchable patient lists (further examples of which are shown in FIGS. 39 and 40), patient profile section 98 (a further example of which is shown in FIG. 41), patient detail section 126 (a further example of which is shown in FIG. 42), device prescription section 132 (a further example of which is shown in FIG. 43), therapy data section 142 (a further example of which is shown in FIG. 44), reminders section 164 (a further example of which is shown in FIG. 45), contacts section 170 (a further example of which is shown in FIG. 46), questionnaire section 174 (a further example of which is shown in FIG. 47), notes section 111 (a further example of which is shown in FIG. 48B), and history section 182 (a further example of which is shown in FIG. 48A).

Also, as discussed above, the physician D has access to profile data screen 50, as illustrated in FIGS. 49 and 50. As discussed above, in profile data screen 50, user 14, in this case a physician D, will have the ability to view and modify his or her user data 188. For example, user data 188 may include the first name, last name, title, group practice, UPIN number, user name, e-mail address, address, password data, work team data, role, facilities, etc. All of this information in user data 188 is modifiable and can be saved by selecting save button 44.

As seen in FIG. 50, an administrator A, HCP H, and/or clinician C also has access to various features and functions of system 10 at patient information interface 12. For example, the administrator A, HCP H, and/or clinician C will also have access to profile data screen 50 for displaying user data 188. It is on profile data screen 50 that user 14, in this case the administrator A, HCP H, and/or clinician C can view and/or modify his or her user data 188, as well as save it by selecting save button 44.

The area configured for an HCP H or administrator A has additional functionality which will be described hereinafter. In particular, HCP H or administrator A may have access to a calculation rules section 196 (FIG. 51), a facilities section 198 (FIGS. 52-54), a lists section 200 (FIGS. 55-57 and 59-62), a users section 202 (FIGS. 63 and 64), a roles section 204 (FIG. 65), a teams section 206 (FIGS. 66-68), a physicians section 208 (FIGS. 69-71), a patient assignment section 210 (FIGS. 72-75), and a company notification section 212 (FIG. 76). As seen in FIG. 51, and with respect to the calculation rules section 196, this area is configured to selectively display compliance calculation data 214, AHI data 216, leak data 218, etc.

This data can be modified, manipulated, saved and set in this calculation rules section 196. For example, with respect to the compliance calculation data 214, user 14 (e.g., administrator A) is able to input, modify and save base calculation data, compliance score data, usage data, etc. In particular, and as seen in FIG. 51, compliance calculation data 214 includes the number of days to base calculation, minimum compliance score (%), and minimum hours per day. In addition, a selectable box in the form of an enable notification box 220 allows system 10 to enable compliance notifications to user 14, such as the clinician C, HCP H, or physician D. These notifications can be viewed and utilized by user 14 to make required clinical and efficacy decisions with respect to the patient P.

AHI data 216 may include base calculation data, average AHI data, etc. As seen in FIG. 51, AHI data 216 includes the number of days to base calculation, as well as the average AHI on a per hour basis. In addition, the enable notification box 220 is also available in this area. Leak data 218 may include base calculation data, average leak data, etc. As seen in FIG. 51, the number of days to base calculation data and average large leak for a number of minutes is displayed. Still further, as discussed above, an enable notification box 220 is provided. Once all the data is entered and adjusted by user 14, save button 44 is selected.

In facilities section 198, a user 14 is allowed to modify facility information by selecting edit button 130. Facility data 226 may include facility information, facility logo, clinician identification, etc., and this information can be displayed based upon a selected category, a selected term, a search category, a search term, etc. Accordingly, the appropriate facility can easily and quickly be located through such search features. Also, by selecting add new button 222, a new facility or facility information can be added to system 10 by the administrator A.

In particular, by selecting add new button 222, user 14 may input the appropriate facility data 226, including facility name, address, phone contact information, logo data, time zone, etc. In addition, clinician data 228 may be added in this area in order to associate specific clinicians C with the appropriate facility at which they work. Once all the information is appropriately input, save button 44 is selected. See FIGS. 53 and 54.

In lists section 200, user 14 is capable of creating, modifying, and otherwise manipulating list data 224 for the other users 14 of system 10. In particular, the various drop-down lists and other selectable list data 224 can be managed by the administrator A in lists section 200. In the embodiment shown in FIGS. 55-62, user 14 may modify list data 224 associated with an insurance provider data 230, sleep laboratory data 232, device data 114, mask data 234, humidifier data 236, accessory data 238, actual contact data 88, contact data 108, contact reason data 240, etc. As seen in FIG. 55, insurance provider data 230 may be added, deleted, edited, etc. FIG. 56 illustrates insurance provider data 230 that should be entered by the user in order to add the insurance provider to the available lists or list data 224. In particular, the insurance provider data 230 includes insurance name, plan name, contact name, address, phone contact data, e-mail address, website data, mask replacement period data and replacement rate data.

Sleep laboratory data 232 includes name, contact name, address, phone contact information, e-mail, website data, etc. See FIG. 57. Humidifier data 236 includes a description of the humidifier. See FIG. 58. Mask data 234 includes a description of the mask to be added to the list. See FIG. 59. Accessory data 238 includes a description of the accessory item to be added to the list. See FIG. 60. As seen in FIG. 61, contact reason data 240 can be entered for use as list data 224, and in FIG. 62, actual contact data 88 and/or contact data 108 can be added for use as list data 224.

In users section 202, user 14 can manage all user data 188. Accordingly, user 14 is permitted to select a user 14, selectively display user information, add a user 14, modify user data 188, save user data 188, etc. For example, user data 188 may include user name, first name, last name, status, lock status, password data, title, e-mail address, facility data, work team data, role data, assignment data, etc. As seen in FIG. 63, users 14 may be displayed based upon a category selectable by the administrator A. Such categories may include active or inactive users 14. In addition, a selectable add new button 222 will allow the administrator A to add a new user 14 to system 10. For example, as seen in FIG. 64, when the administrator A wishes to add a new user 14, the user name, first name, last name, status, lock status, password data 38, title, e-mail address and facility data is all input.

In addition, work team data 242 and role data 244 are presented to the administrator A, HPC H, and/or Clinician C. Accordingly, administrator A, HPC H, and/or Clinician C is capable of assigning a new user 14 to a work team, as well as to assign a new user 14 the appropriate role. The administrator A, HPC H, and/or Clinician C can view all work team data 242 and role data 244 associated with a particular user 14. Once the appropriate data is input, save button 44 is selected.

FIG. 65 illustrates roles section 204. In roles section 204, role data 244 may include role title, role permission data, assigned user data, etc. Accordingly, after the administrator A, HPC H, and/or Clinician C has selected the appropriate role for user 14, the permissions associated with that role are displayed, as are the number of users 14 that are in that role. Therefore, the administrator A, HPC H, and/or Clinician C is quickly able to identify what functions are available to each user 14 according to his or her role.

The present invention provides the ability to assign a team of clinicians to a given patient. Teams allow more than one clinician (or more than one employee of a homecare provider) to see the data associated with a given patient. This allows the clinicians at a single home care provider to share the responsibility of supervising a given patient. Teams section 206 allows the administrator A, HPC H, and/or Clinician C to add new teams and edit information on existing teams. Therefore, in teams section 206, work team data 242 is provided, and this work team data 242 may include team description, assigned clinician data, assigned patient data, etc. Also, the administrator A, HPC H, and/or Clinician C is allowed to selectively display a team, selectively display work team data 242, add a team, modify work team data 242, save work team data 242, etc.

As shown in FIG. 66, work team data 242 may be shown according to category or team name and display the clinicians C that are on the team, as well as patients P that are part of the team. By selecting add new button 222, the administrator A, HPC H, and/or Clinician C is capable of adding new work team data 242 into system 10. In particular, as shown in this figure, user 14 would add the team name and team description, and then select save button 44. By selecting save button 44, system 10 will validate that the team name and team description have been entered. By selecting edit button 130 (see FIG. 66), the administrator A, HPC H, and/or Clinician C is permitted to edit work team data 242 that already exists in system 10, as illustrated in FIG. 68.

In physicians section 208, user 14 or administrator A, HPC H, and/or Clinician C is permitted to selectively display a physician D, search for a physician D, delete a physician D, or otherwise manipulate physician data 246. As seen in FIG. 69, physician data 246 can be added or removed using the selectable box 76, and the physician data 246 is presented to the administrator A, HPC H, and/or Clinician C. In the embodiment of FIG. 69, physician data 246 includes the last name, first name, UPIN number, address, phone number and facsimile number.

Physicians section 208 also includes or displays a search physician button 248, which leads to a screen illustrated at FIG. 70. This is where the administrator A, HPC H, and/or Clinician C is capable of searching for a physician D or physician data 246 based upon either a drop-down listing or a text search. Such a function will allow the administrator A, HPC H, and/or Clinician C to quickly and efficiently obtain information regarding physicians D that are currently part of system 10.

Presently, physicians D may or may not be part of system 10, and may or may not even be aware that such a unique patient information management system 10 exists. Accordingly, the administrator A, HPC H, and/or Clinician C or user 14 may select an invite physician button 250 (see FIG. 69). By selecting the invite physician button 250, user 14 is directed to a screen illustrated at FIG. 71. It is at this screen that user 14 is permitted to transmit a message to the physician D. In one embodiment, this message is an electronic communication comprising content including text, a graphical logo, an invitation to use system 10, etc. Once the appropriate data has been placed in the appropriate input boxes, and user 14 selects send button 140, an e-mail is sent to the physician D inviting him or her to join system 10. It is envisioned that user 14 may enter any text he or she wishes to send to the physician D as an invitation, or alternatively, such text may be automatically generated by system 10 and transmitted through patient information interface 12 in a set form and format.

FIG. 71A illustrates the process by which physicians D are invited to participate in system. In this exemplary embodiment, the HCP sends the e-mail communication to a physician using the above-described process as indicated by path 221. The e-mail communication includes a link to allow the physician to access system 10 as indicated by path 223. Once the physician has accessed the system and entered their information. The HCP searches for the physician and associates the appropriate patient or patients with the newly added physician as indicated by path 225. In this manner, the HCP controls which doctors can participate in the system with their patients.

Referring now to FIG. 72. patient assignment section 210 is configured to selectively display patient data 80, clinician data 228, assignment data 252, etc. Accordingly, in the patient assignment section 210, user 14 or administrator A, HPC H, and/or Clinician C is permitted to associate at least one patient P with a clinician C. As shown in FIG. 72, clinician data 228 is selected in a drop-down list. Next, as seen in FIG. 73, patient data 80 (or a patient P) is associated with a clinician C. Finally, the specific identity of the target clinician C is selected. See FIG. 74. In order to complete the transfer, a transfer patient button 254 is then selected, such that the selected patient(s) P is/are now associated with the chosen clinician C. If successful, a message is displayed to user 14 that the transfer has occurred successfully. See FIG. 75.

In company notification section 212, notification data 256 is selectively displayed to user 14, including company data and other similar information. For example, notification data 256 may include receipt data, status data, description data, selection data, etc. As seen in FIG. 76, notification data 256 includes a log of calls from a communications device 18 made to system 10. The time of the call is logged, together with a status description. A selectable box 76 is provided next to each entry in order to allow user 14 to add or remove logged notification data 256 from the listing.

Another area of patient information interface 12 is the business reports screen 54. It is this business reports screen 54 that allows user 14 to selectively display or have presented thereto report data 258. For example, report data 258 may include report title, report description data 72, report type 78, etc. See FIG. 77. One example report is illustrated in FIG. 78, namely a “Mask Replacement Report” which shows user 14 a listing of patients P that have a mask (patient device 16) that is expired or set to expire within a thirty-day period. In particular, this “Mask Replacement Report” displays report data 258 including first name, last name, address, phone number, clinician C name, insurance name, plan name, expiration time period, mask type, mask prescription date, e-mail information, months for reimbursement, and rate. It is also envisioned that report data 258 can be exported into a spreadsheet application.

As shown in FIGS. 79-82, user 14 or administrator A, HPC H, and/or Clinician C is also able to interact with communications device 18 via the modem administration screen 56. In particular, modem administration screen 56 includes a modem summary section 260, a modem list section 262 and a modem settings section 264. Modem summary section 260 displays modem data 266, including activity data, call schedule data, modem summary data, etc. The modem list section 262 selectively displays modem data 266, including modem identification, call data, assignment data, last call data, next call data, status data, schedule data, etc. In addition, modem settings section 264 selectively displays modem data 266 in the form of call schedule data.

As seen in FIG. 79, modem summary section 260 includes modem data 266 regarding active and inactive communications devices 18 (or modems). As seen in this figure, user 14 is able to ascertain that zero modems have initial call schedules, two modems have custom call schedules, zero modems call daily, zero modems call weekly and zero modems have less than ten calls remaining according to a plan. Modem list section 262 provides a listing of all communications devices 18 (such as modems), together with to whom the modem is assigned, the number of calls remaining on the modem, the last call, the next call, the status of the modem and the schedule, which can be edited. Modem data 266 may also include the serial number of the modem.

The number under calls remaining represents the number of calls that can be placed from communications device 18 prior to some warning or other indication being presented to the administrator A, HPC H, and/or Clinician C. In this manner, the patient P can be given or purchase a set number of calls for his or her communications device 18, after which the modem calling “plan” must either be renewed or adjusted. Such a “plan” approach allows for the minimization of communications traffic to and from system 10. More specifically, in an exemplary embodiment, a modem is sold, leased, given, or otherwise provided to a homecare provider with a fixed number of calls, e.g., 60 calls. Once these 60 calls are used, additional calls must be obtained/purchased. In a further embodiment, a life-time or unlimited call subscription can be provided. For example, an up-front cost can be paid, and the user can then be given unlimited access. In a still further embodiment no calls are preloaded into to the mode, and each call must be paid for, for example by charging each call to a credit card or account.

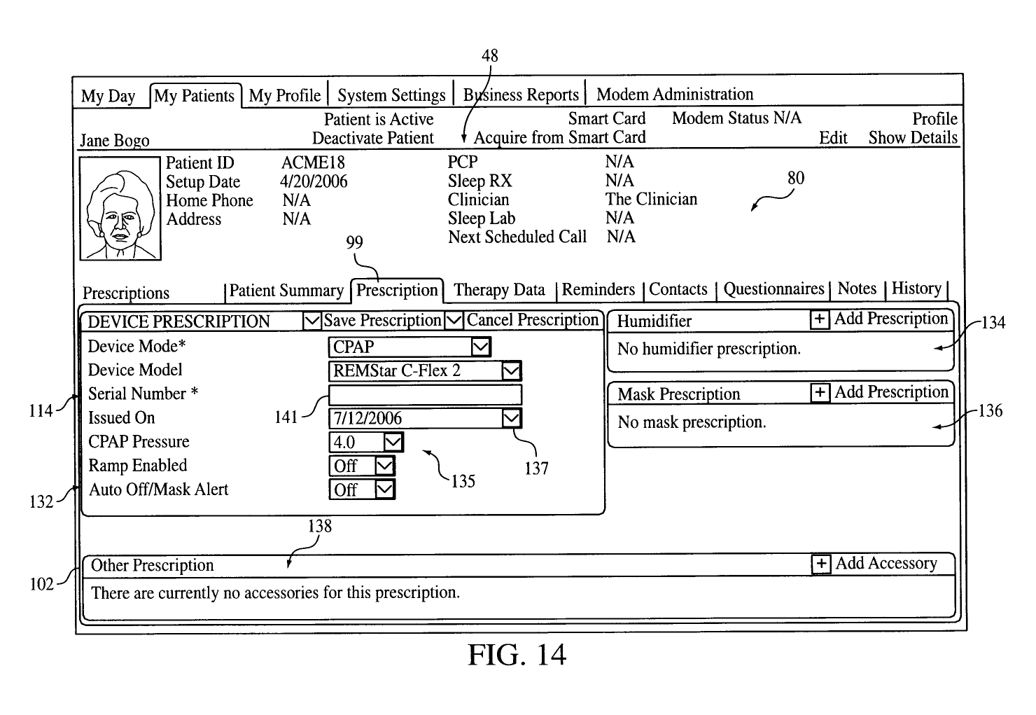

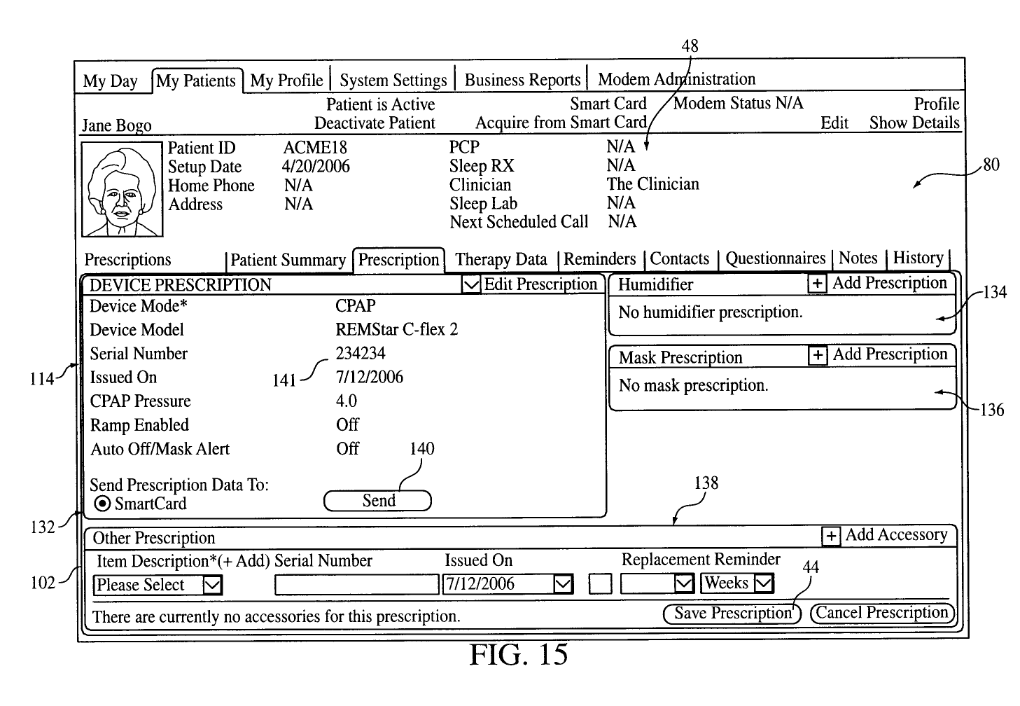

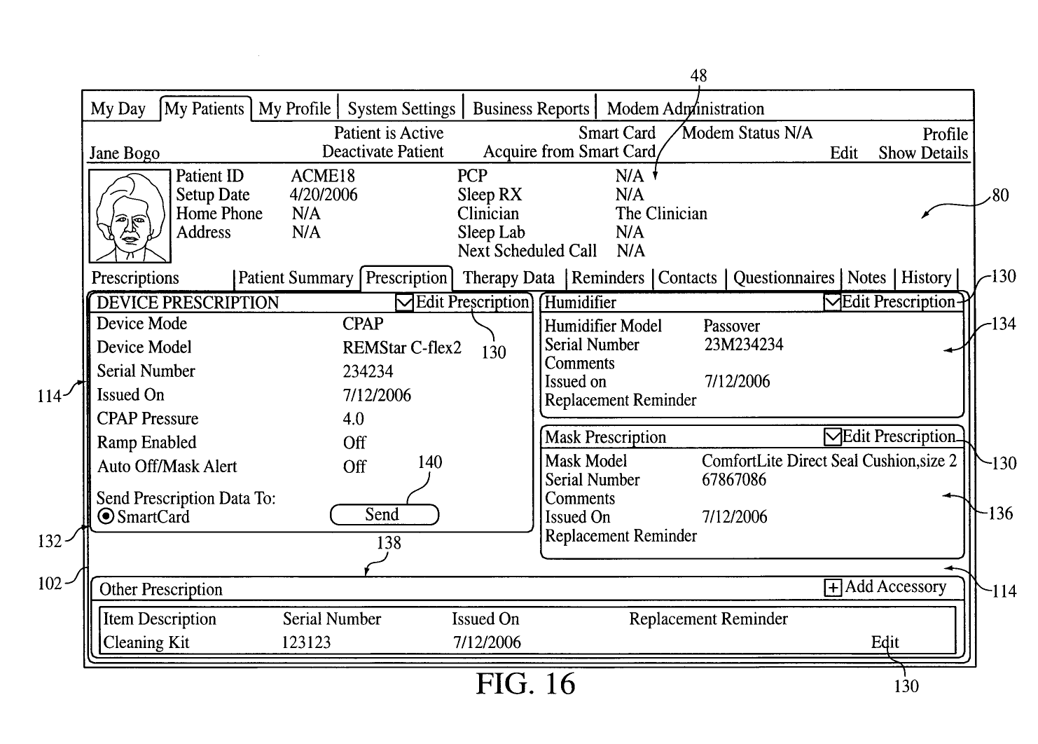

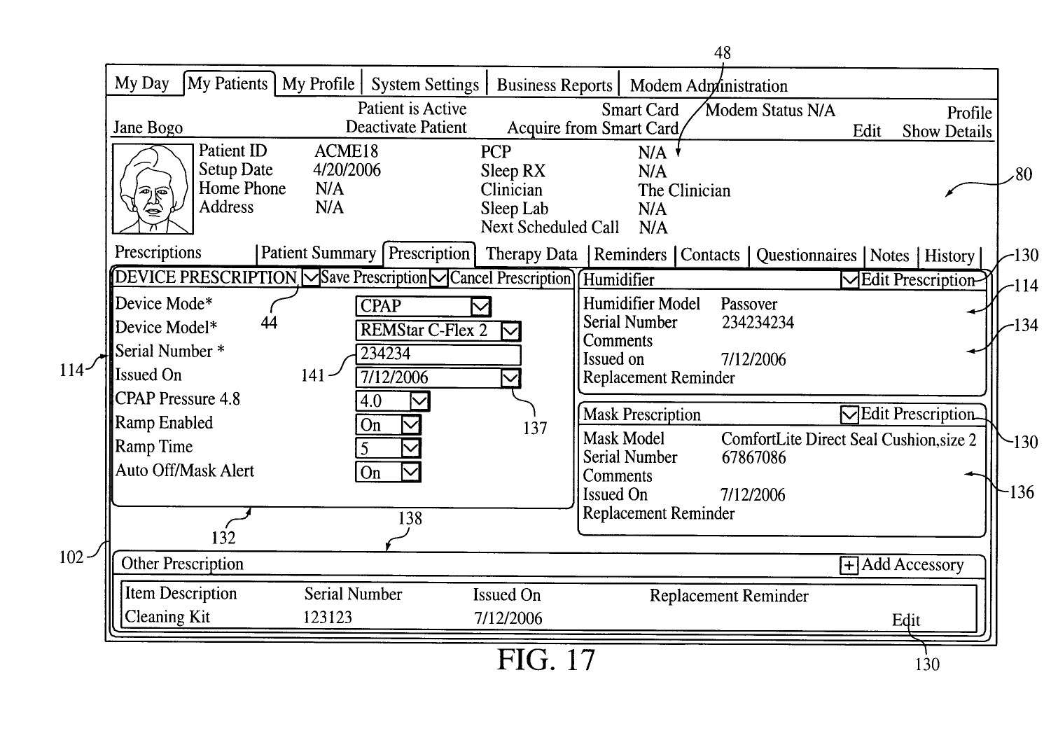

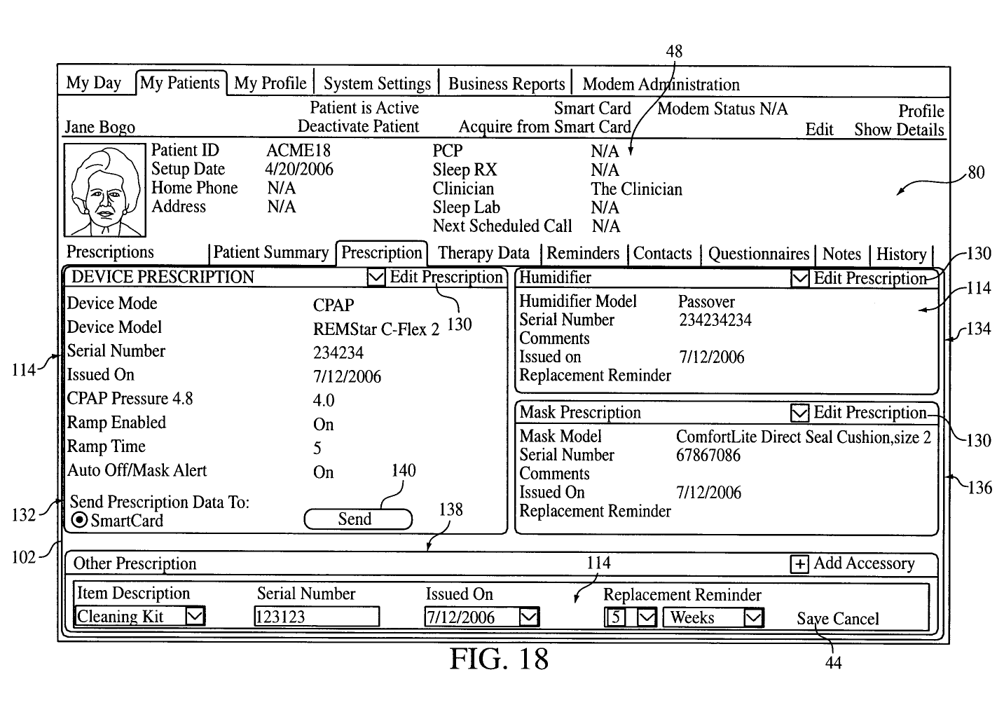

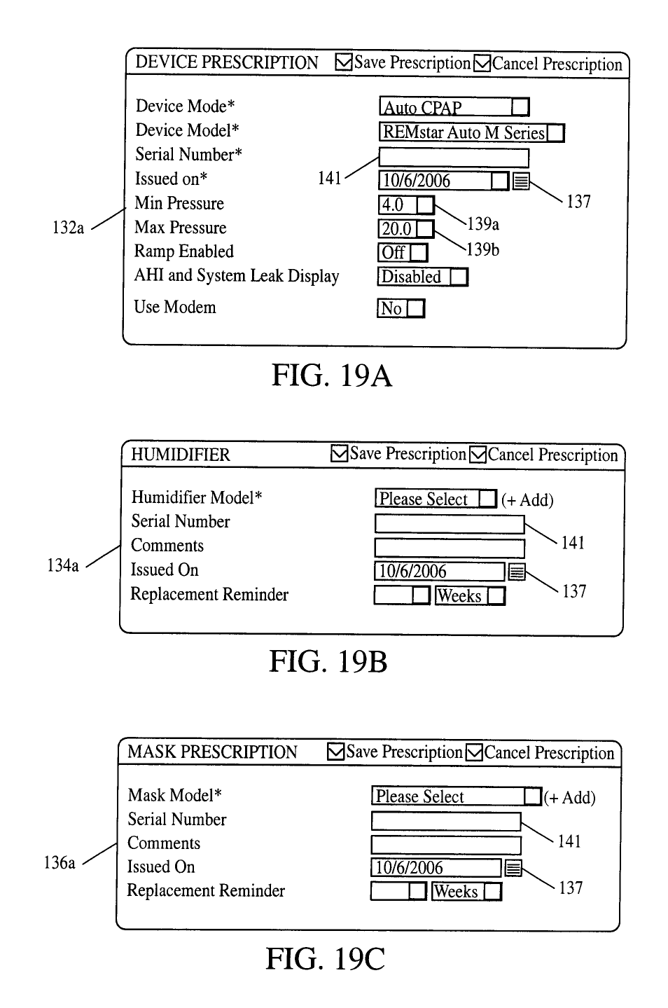

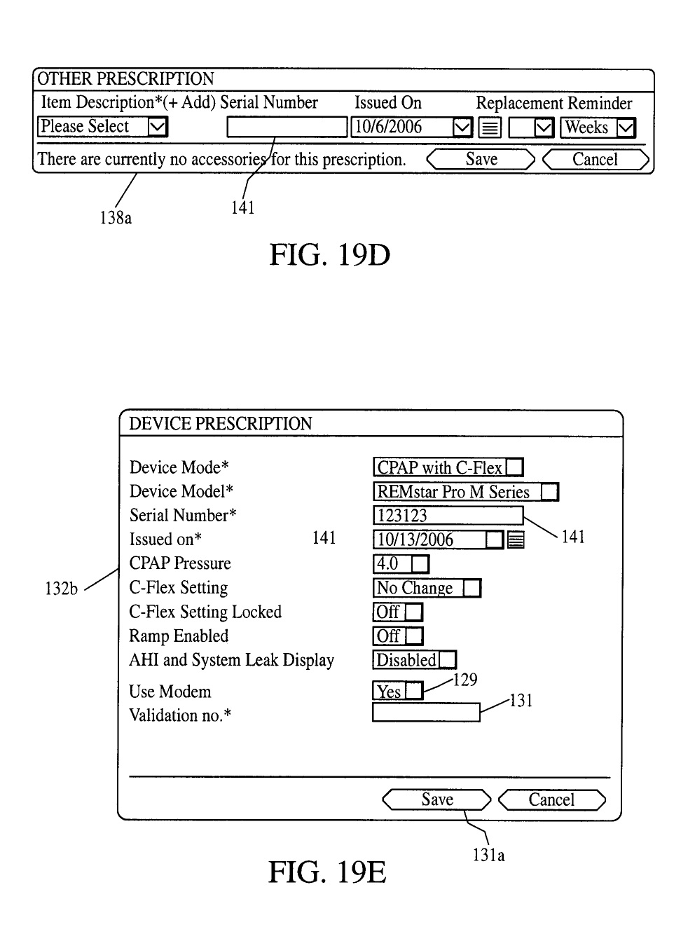

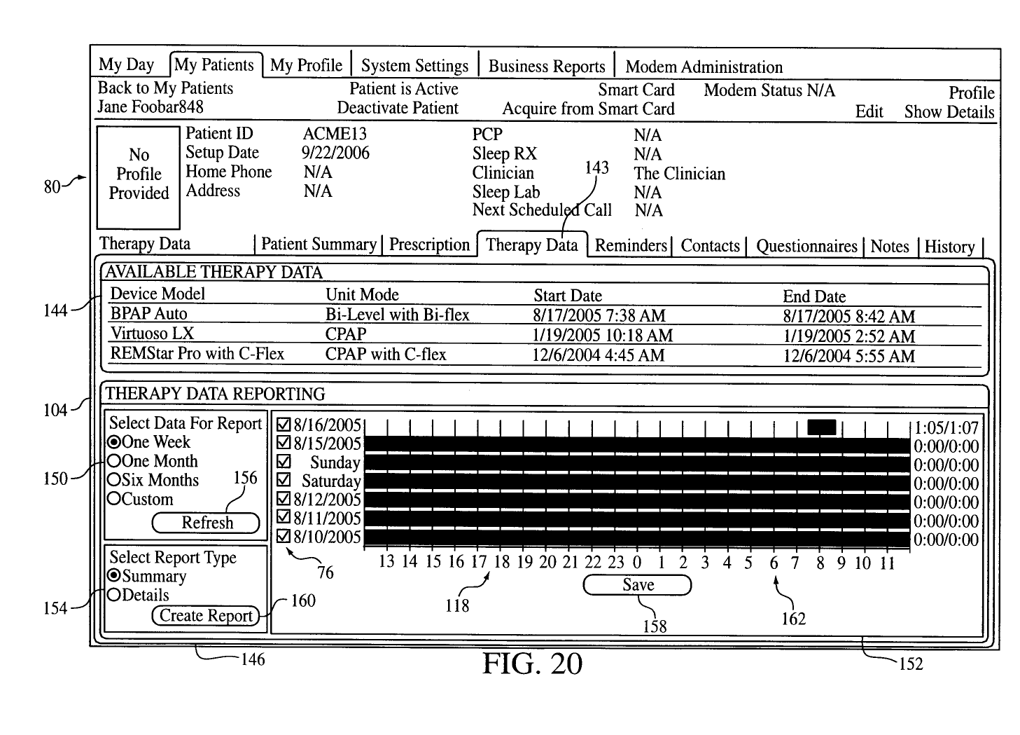

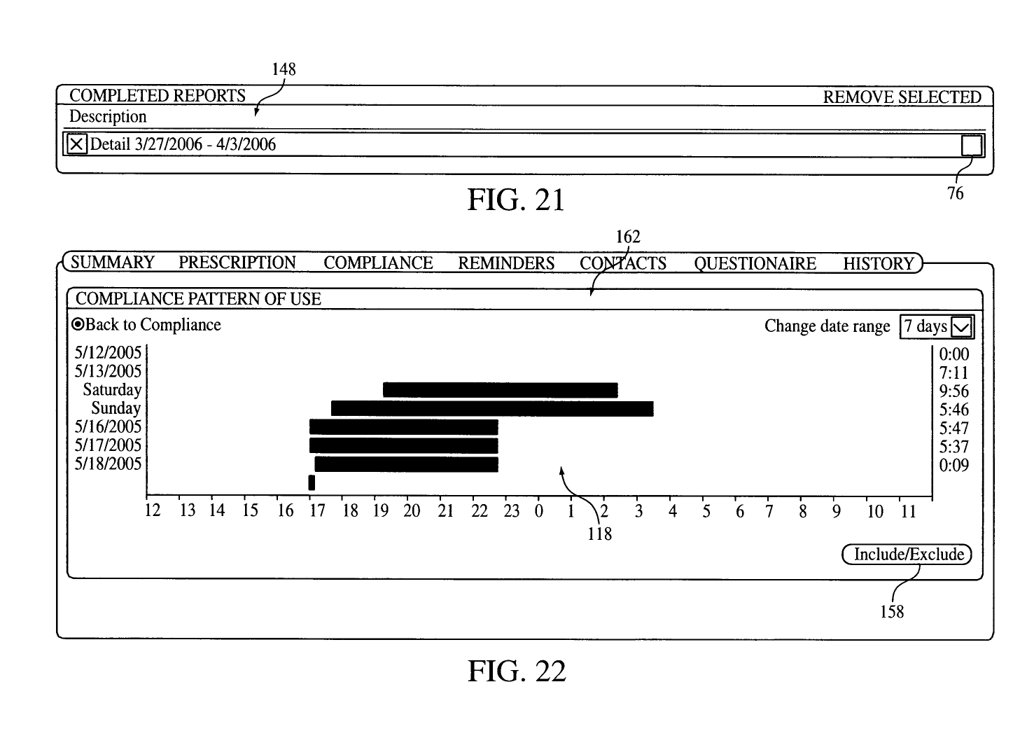

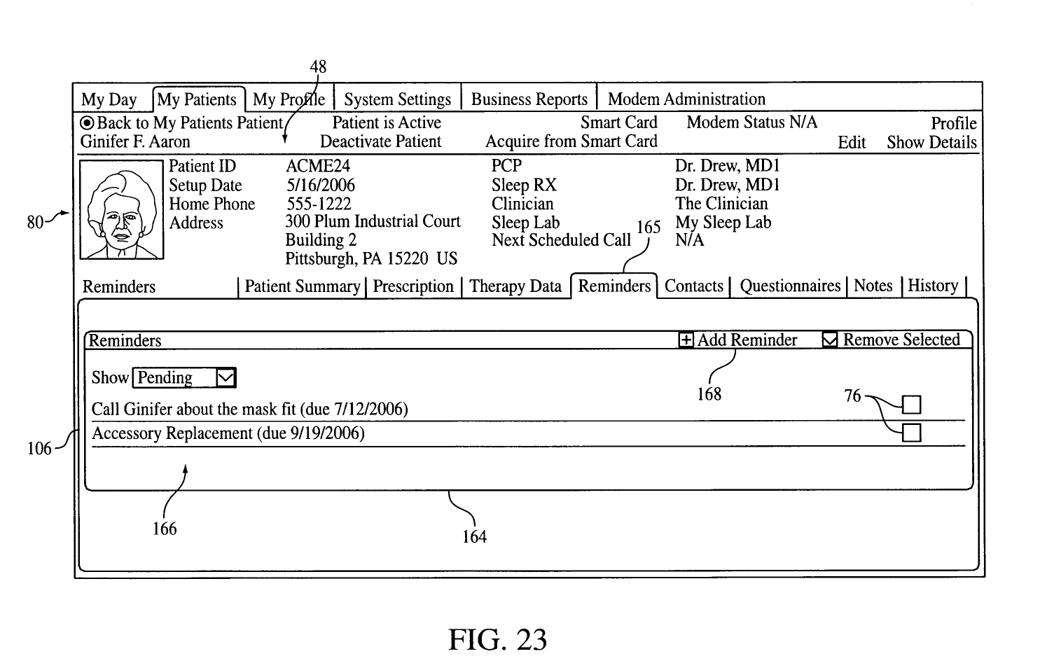

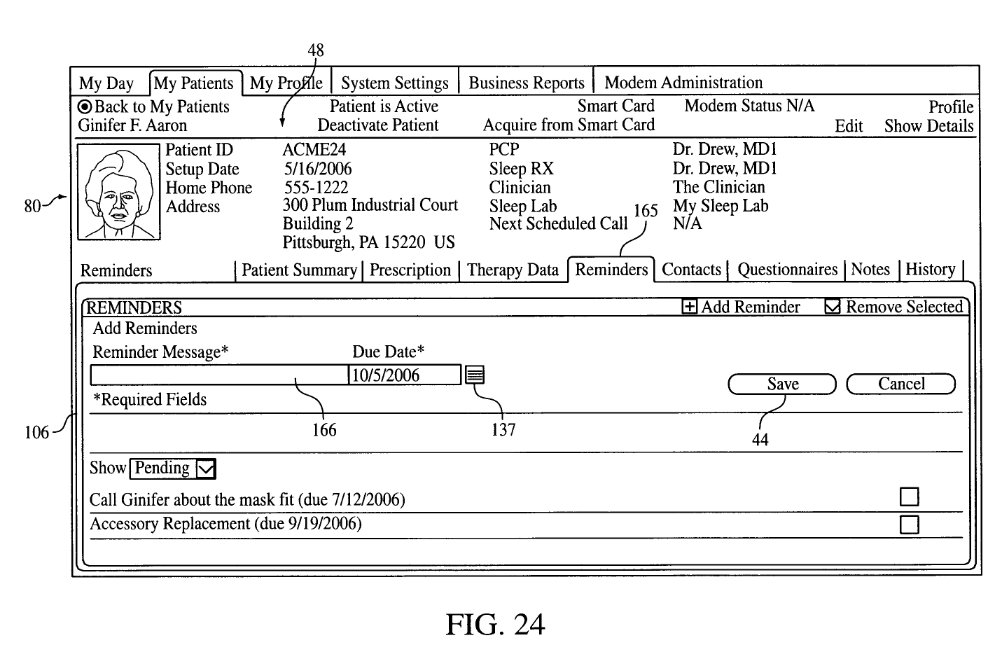

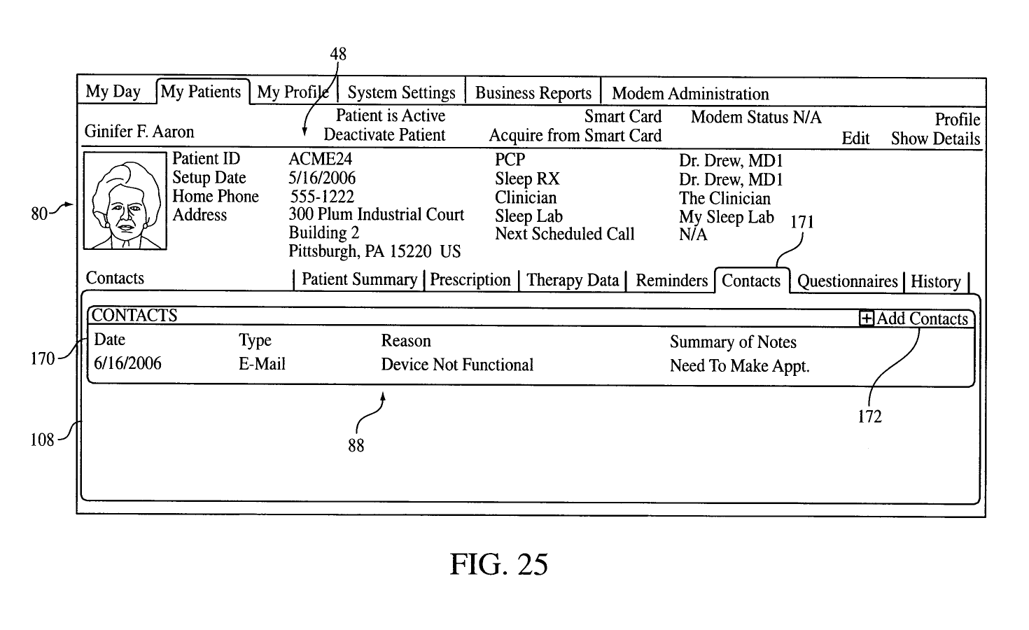

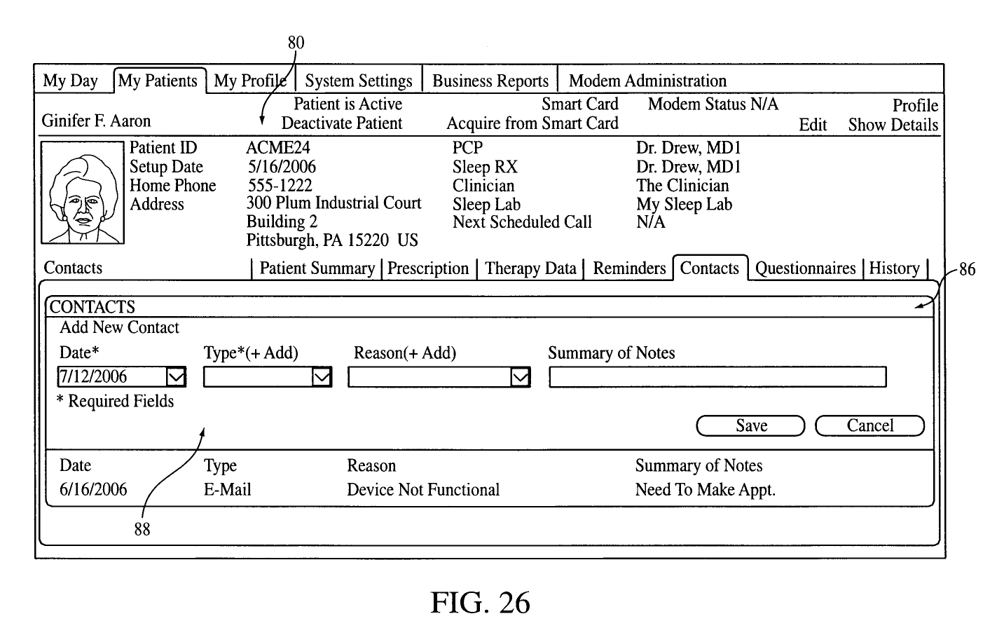

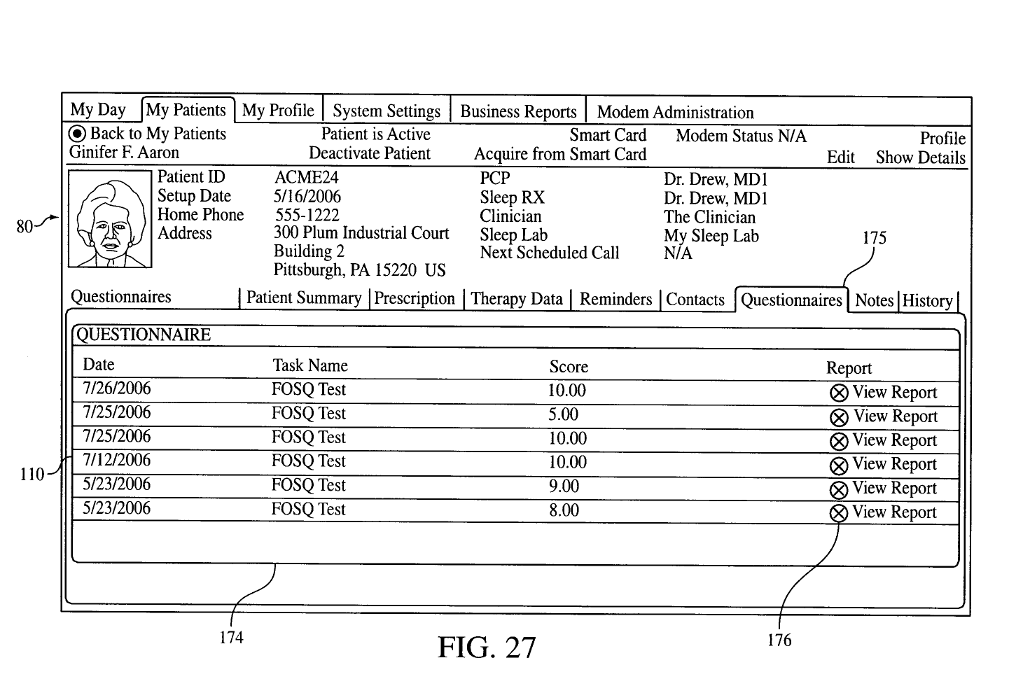

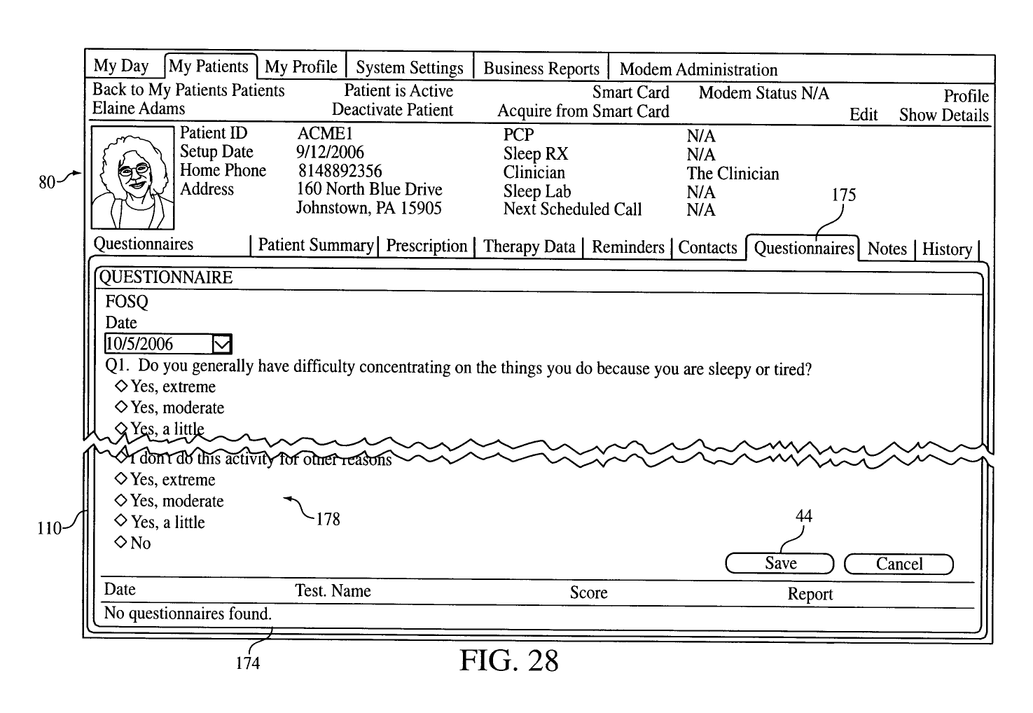

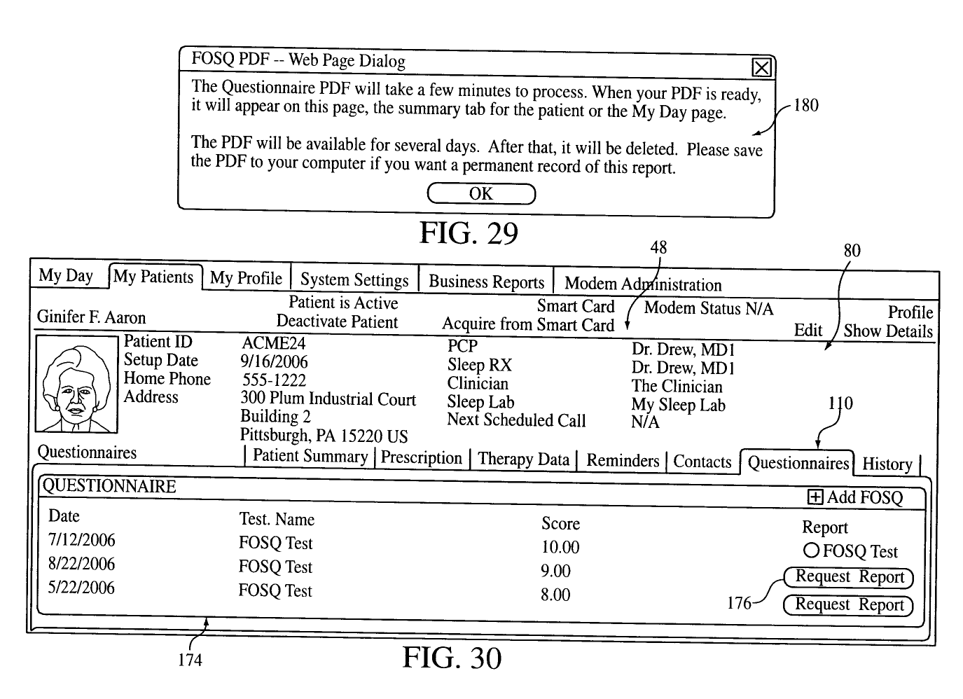

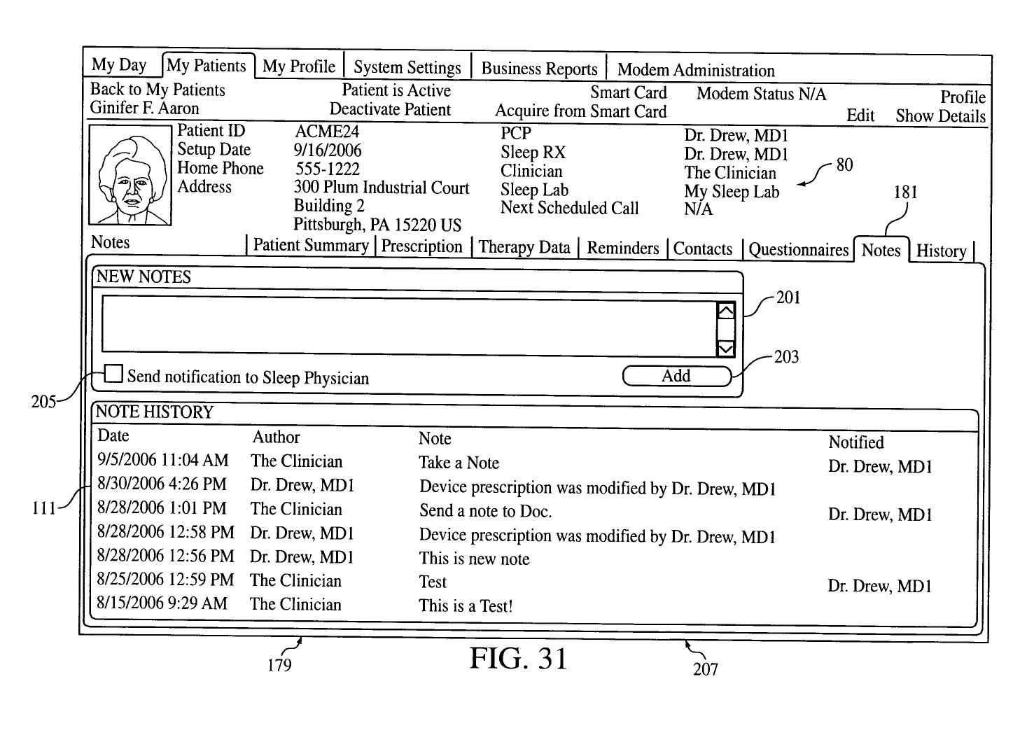

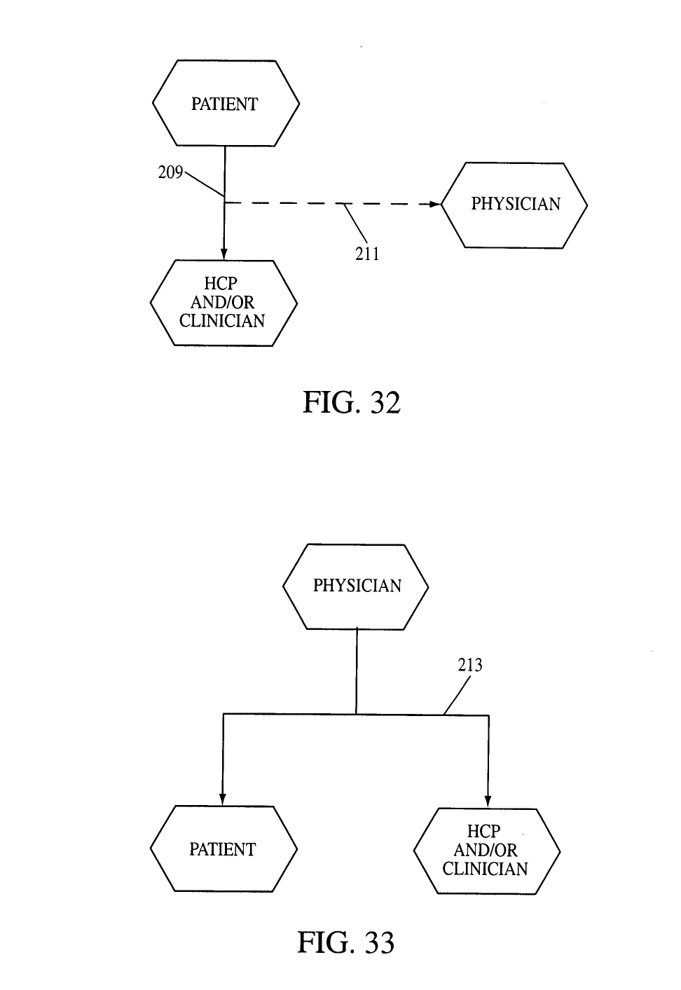

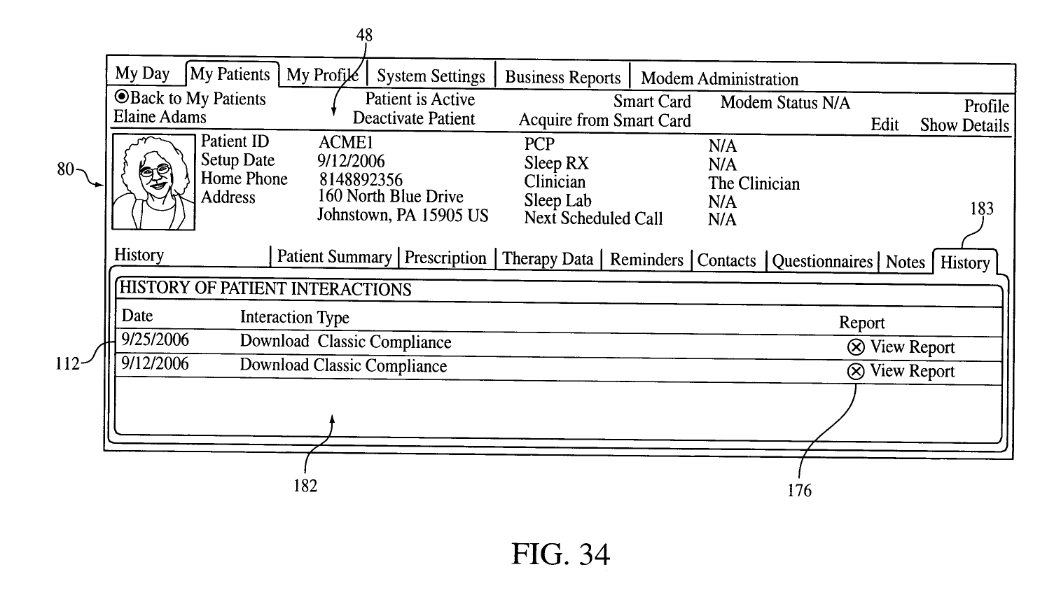

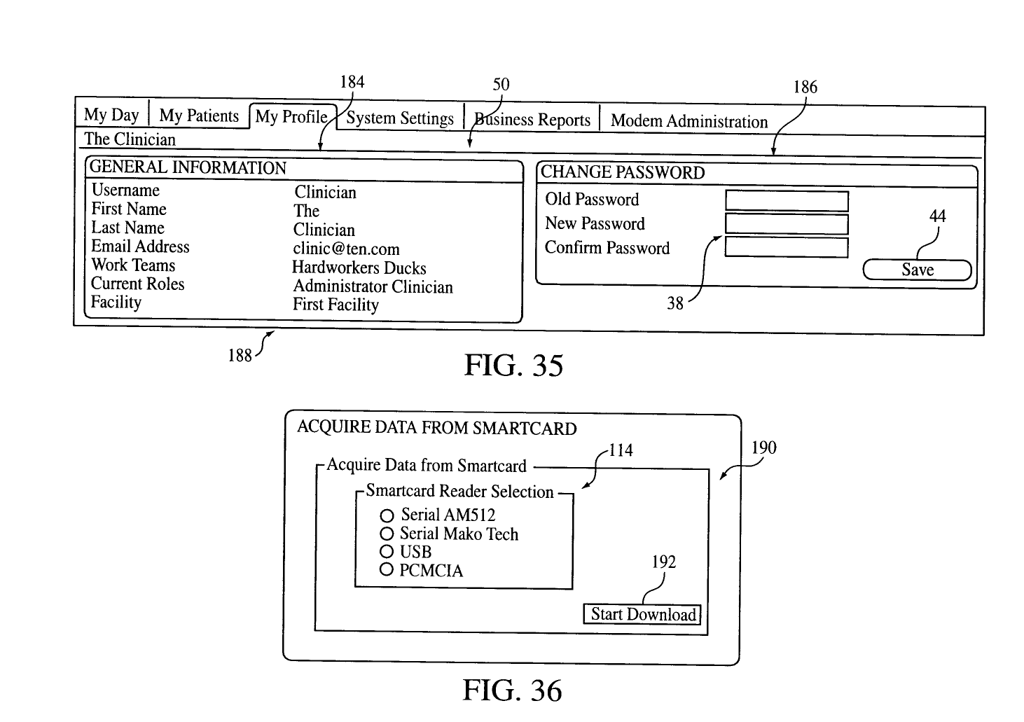

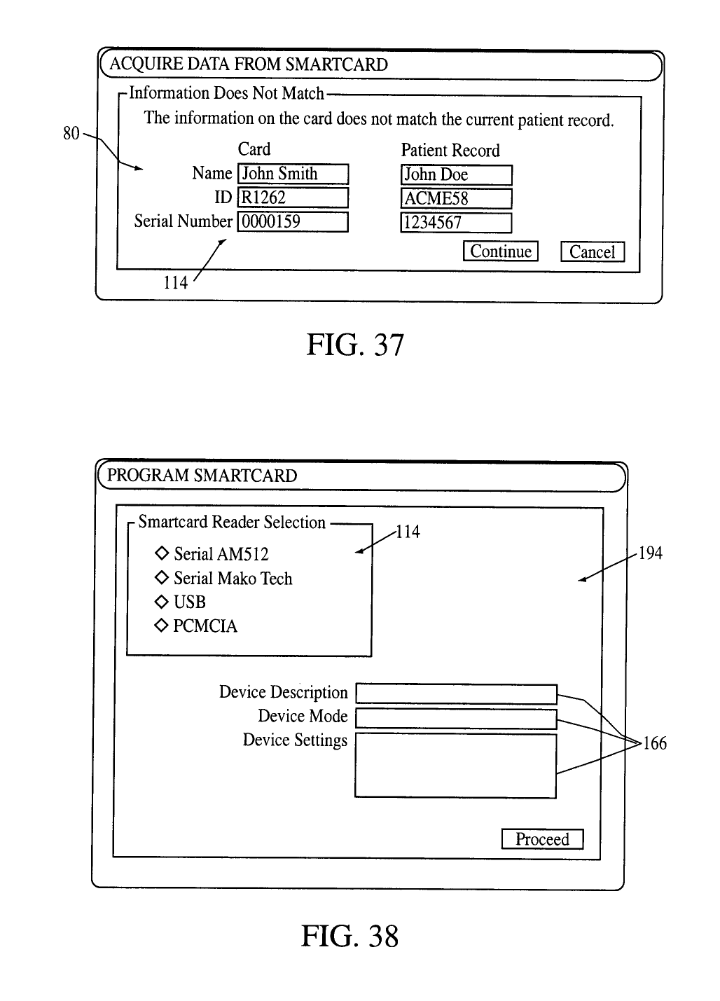

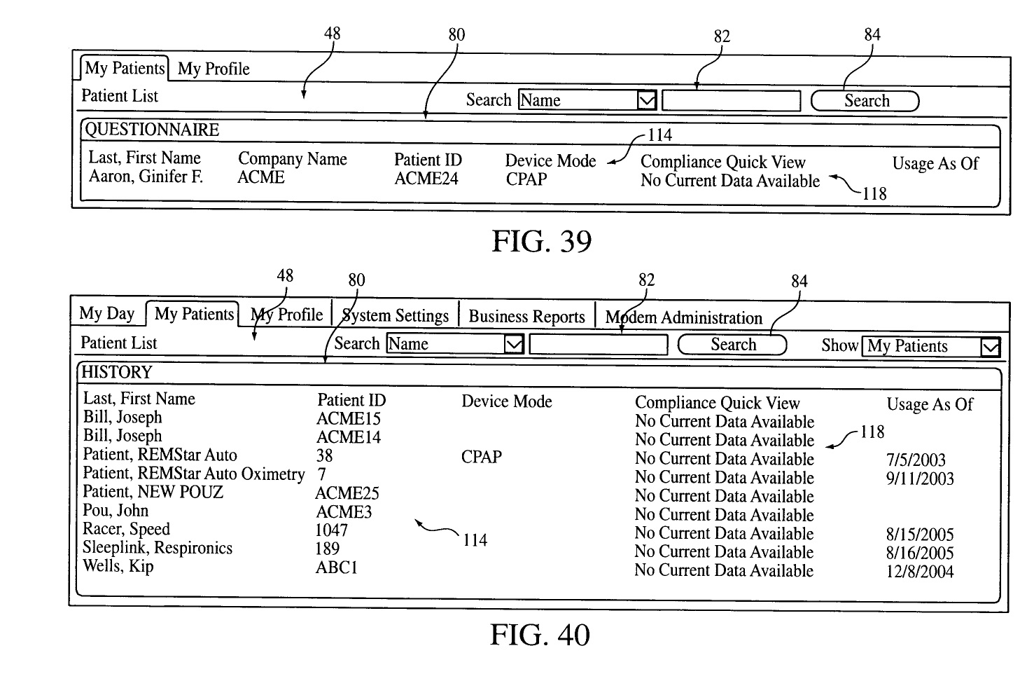

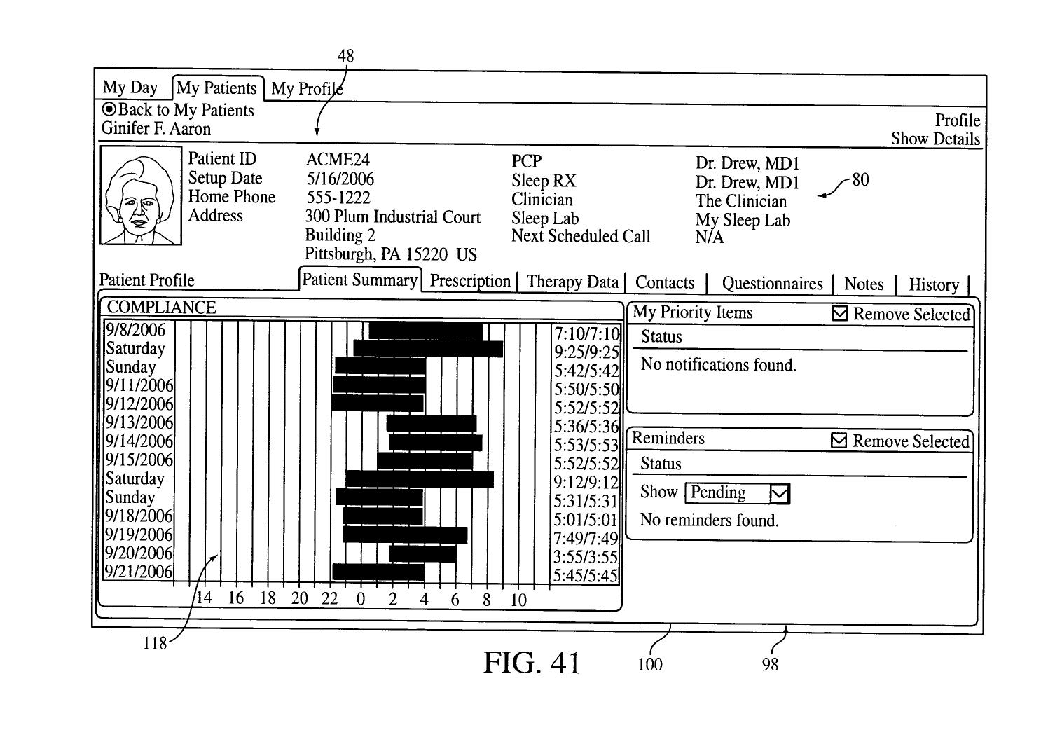

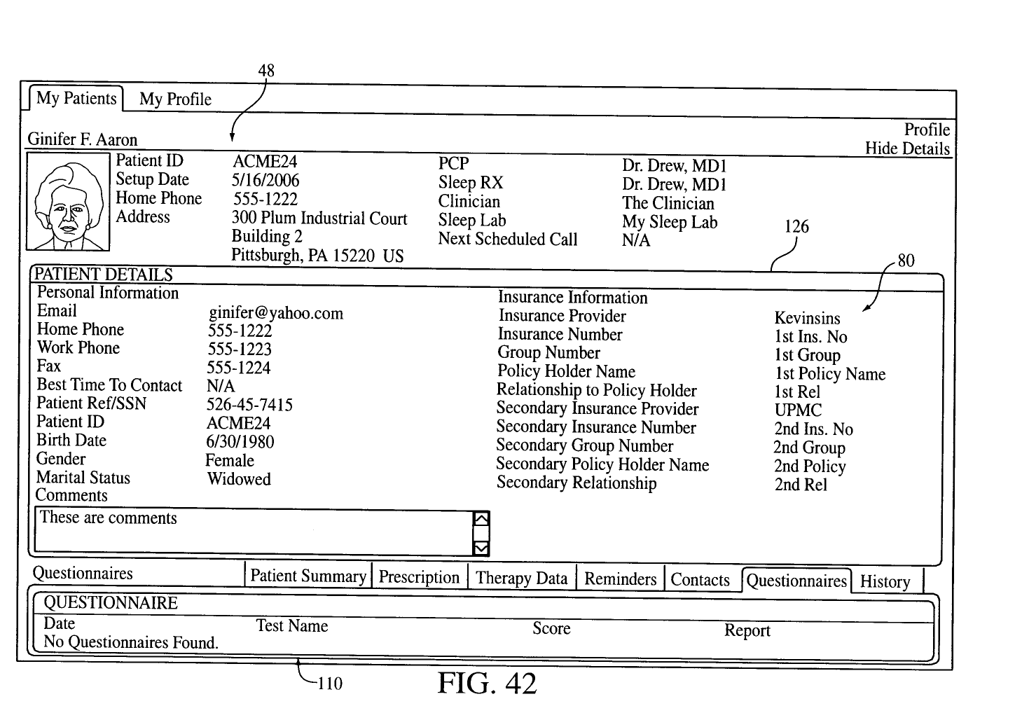

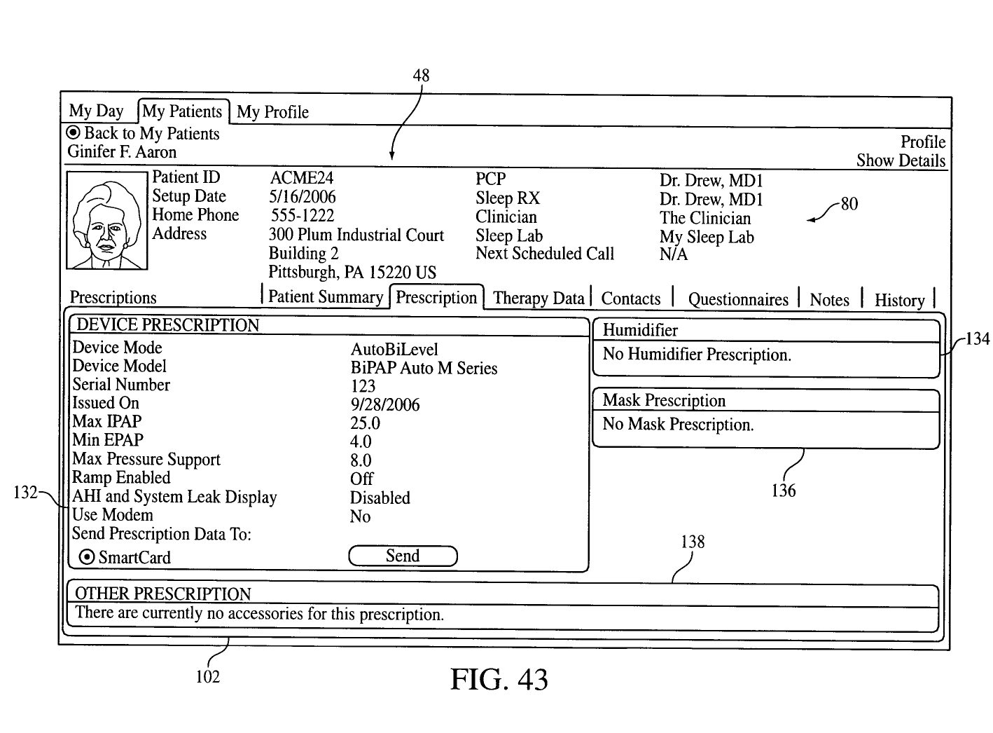

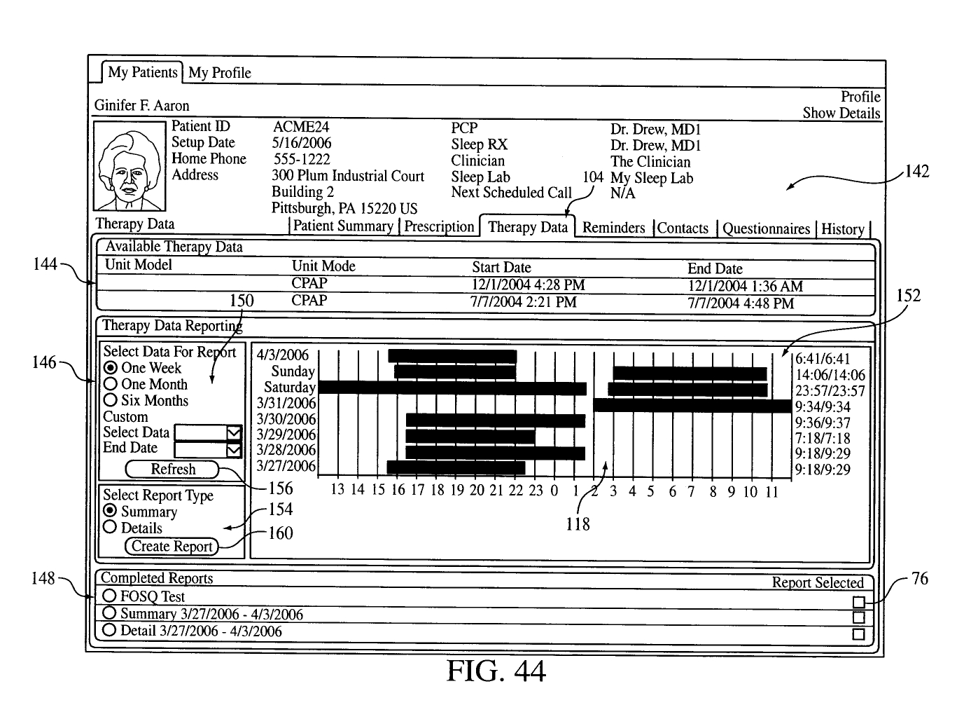

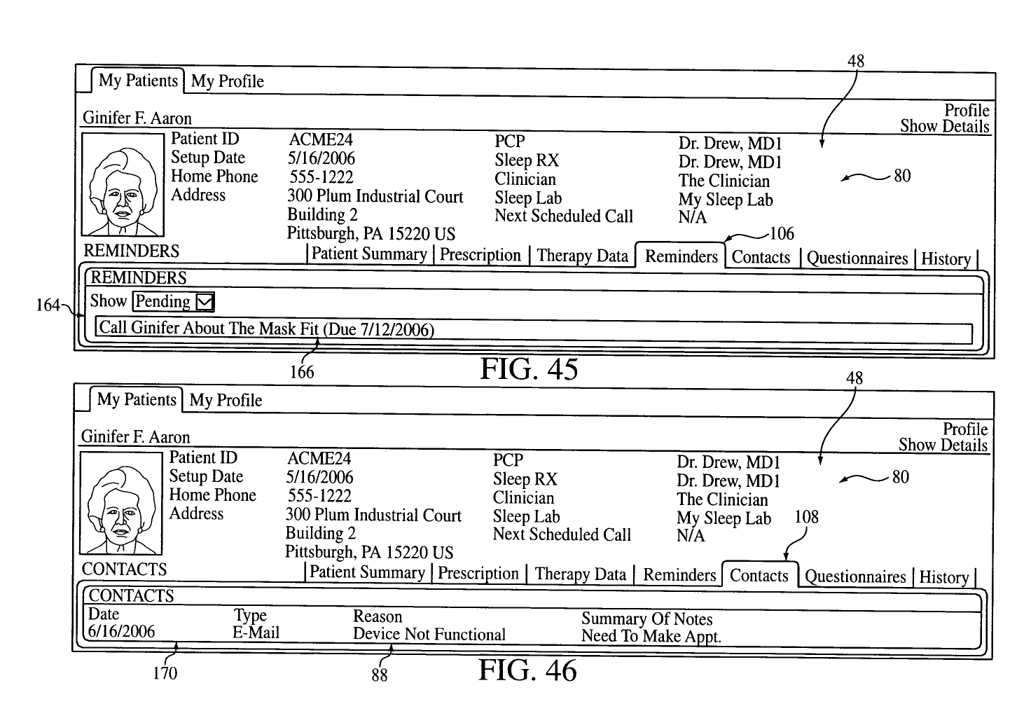

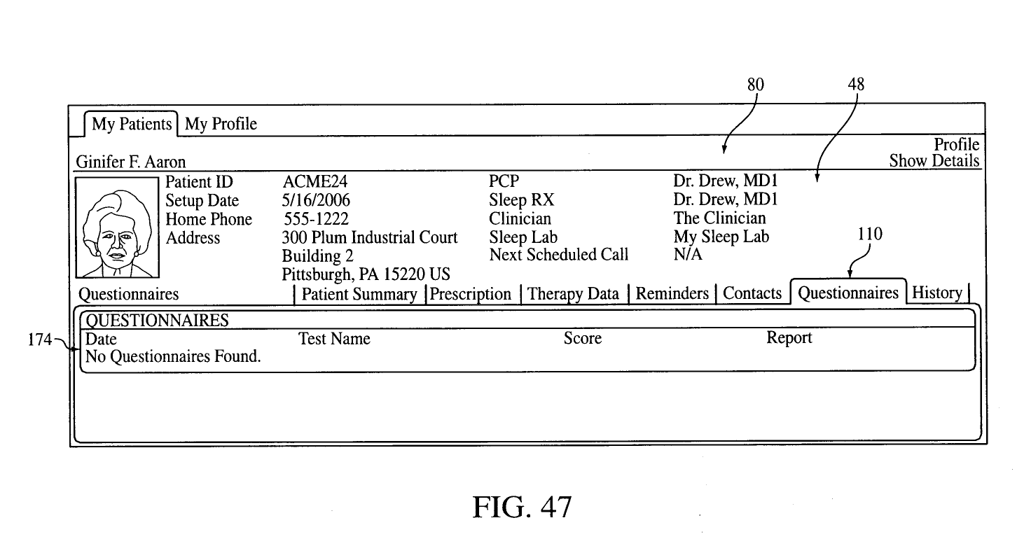

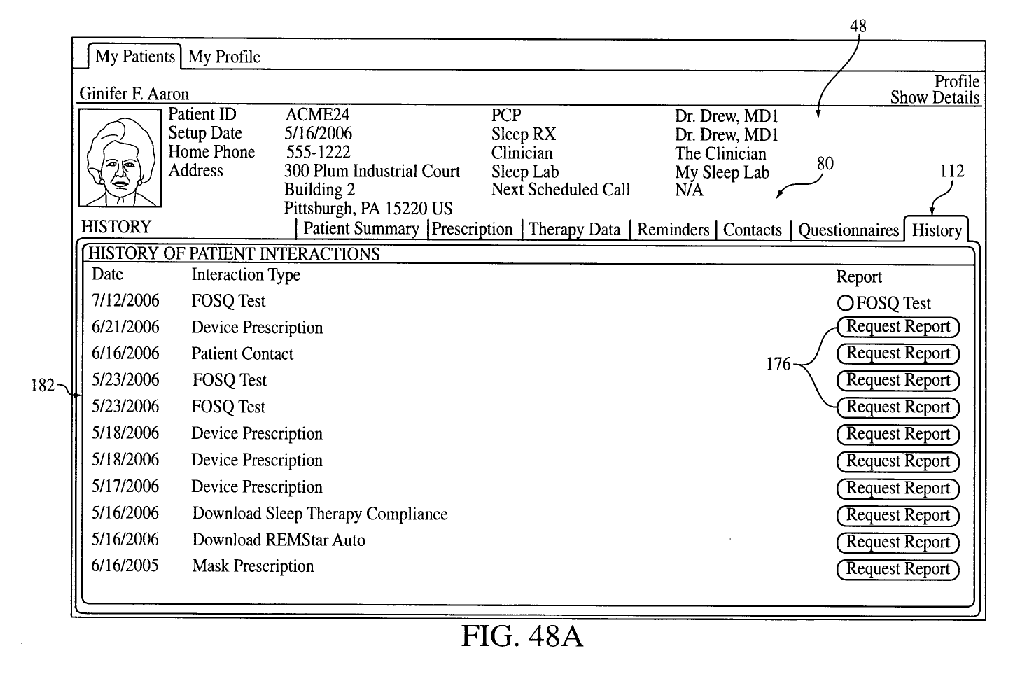

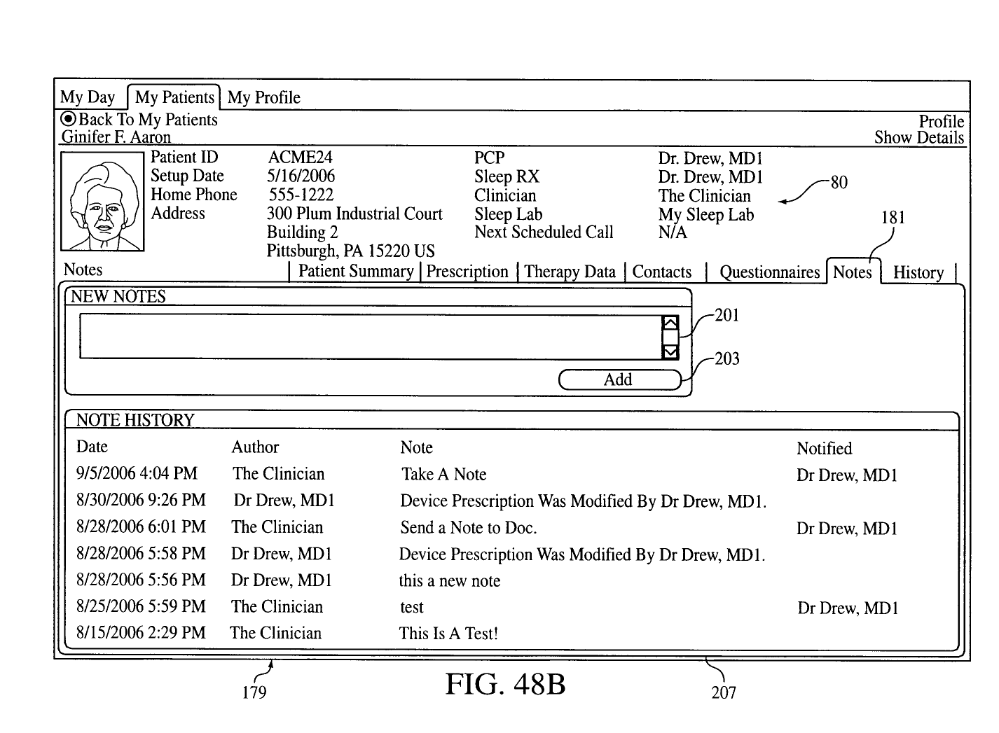

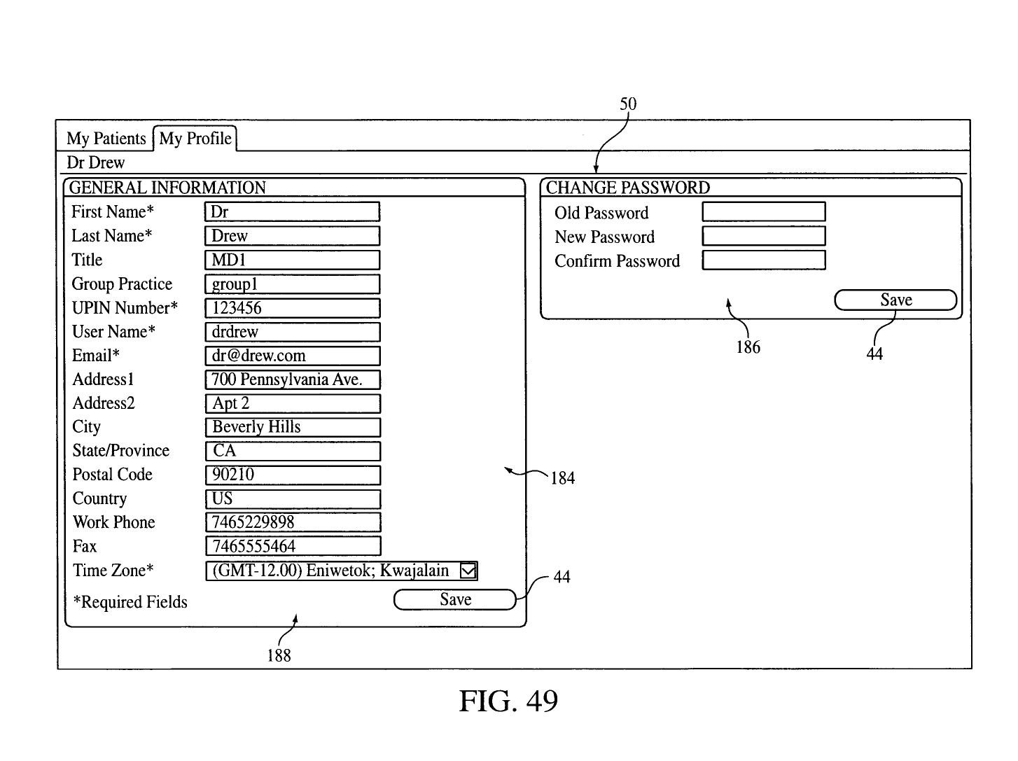

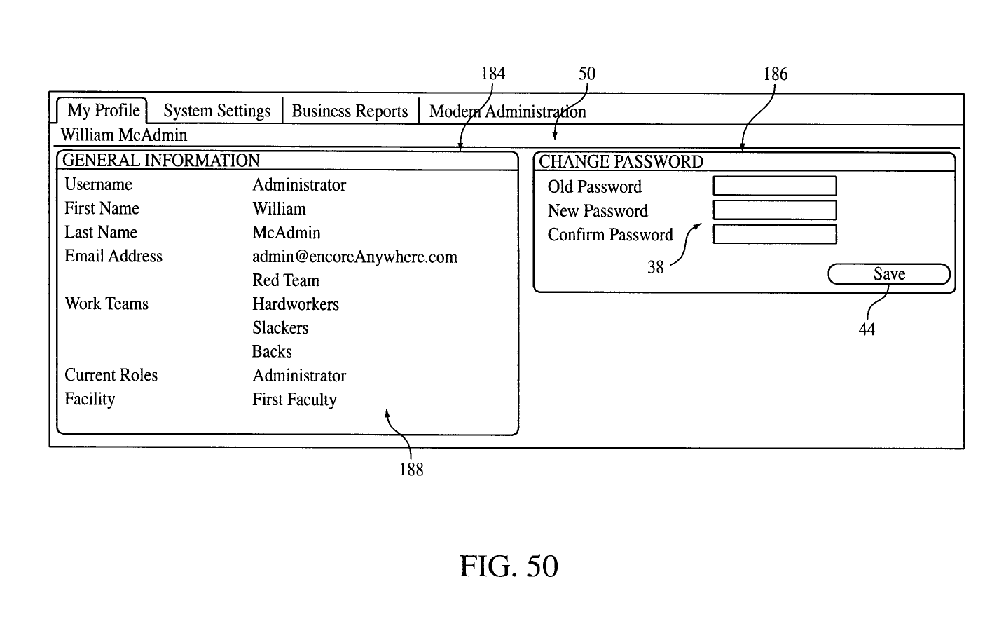

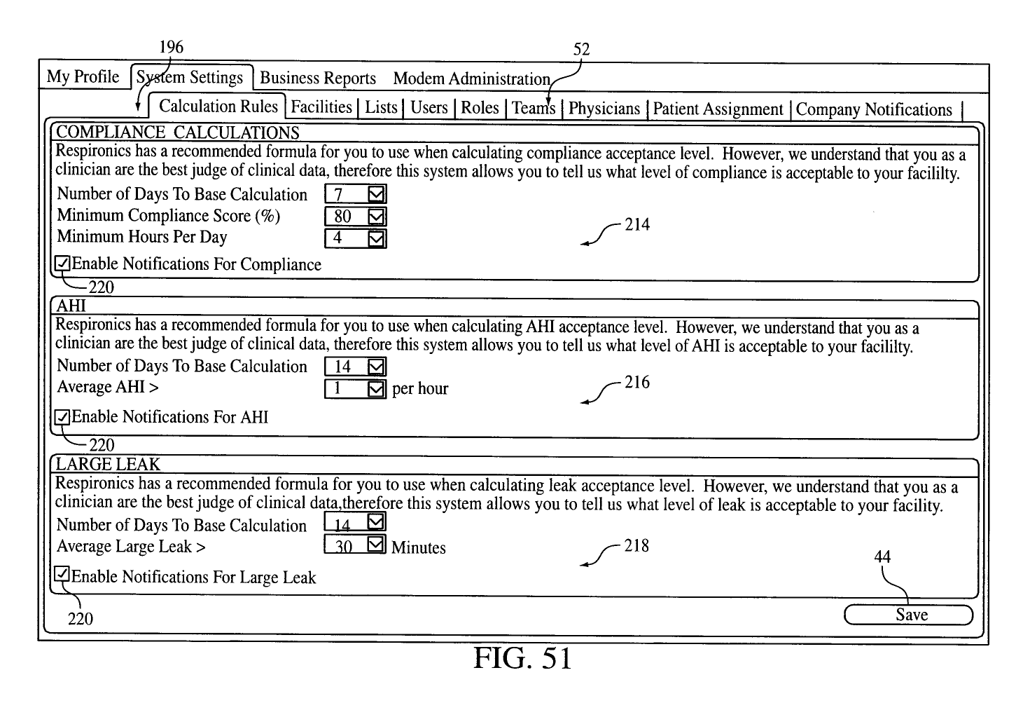

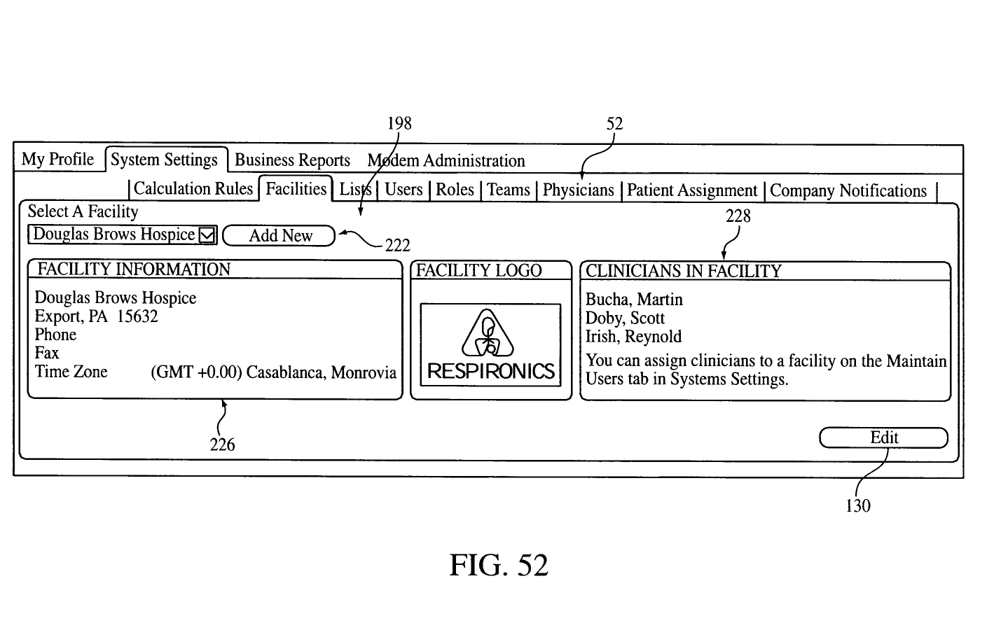

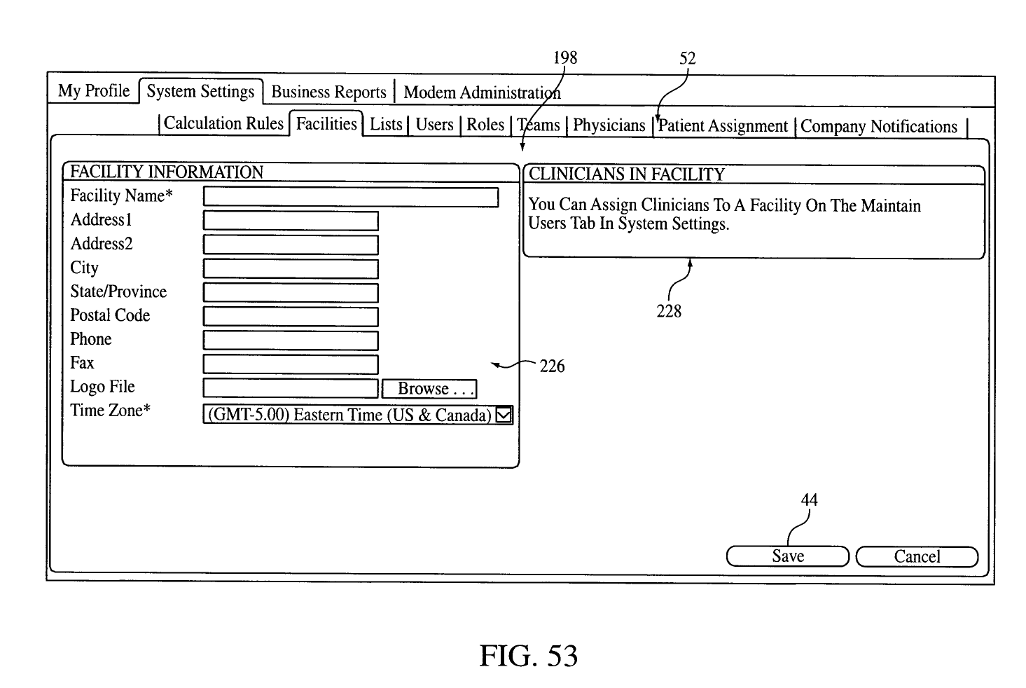

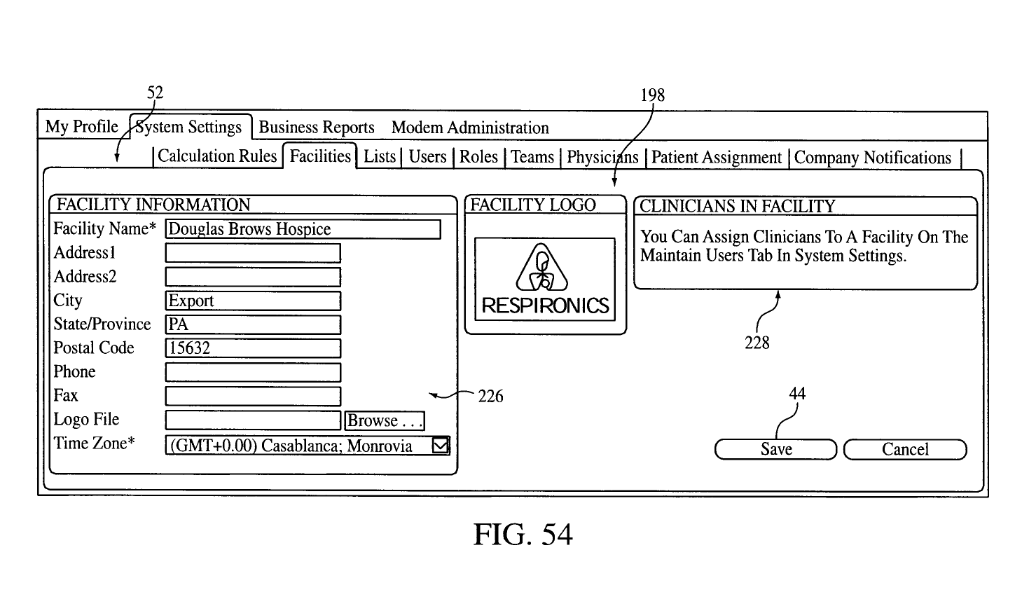

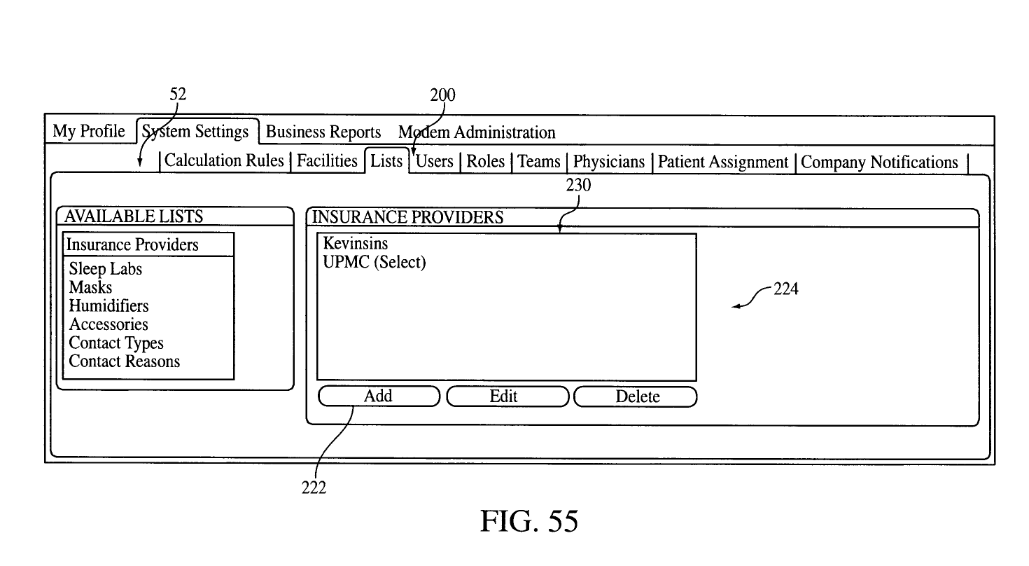

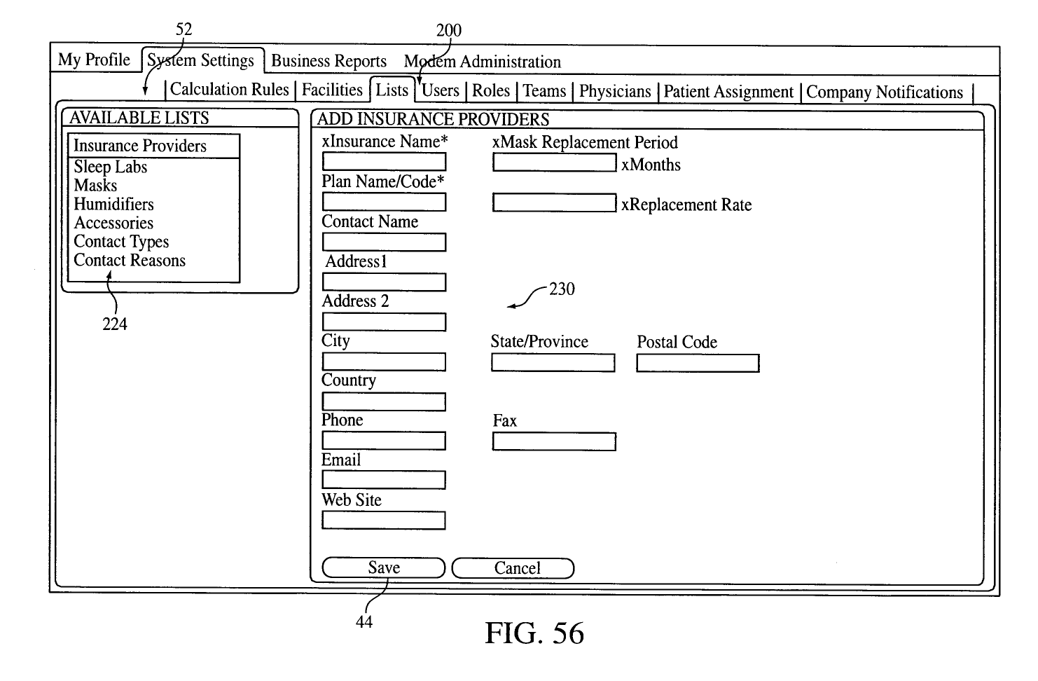

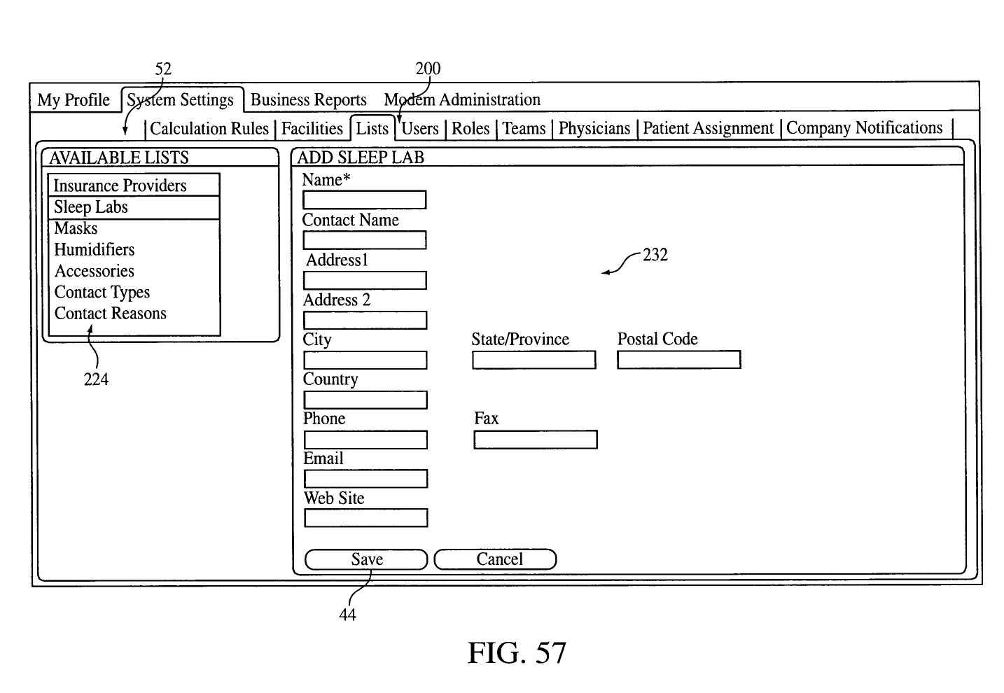

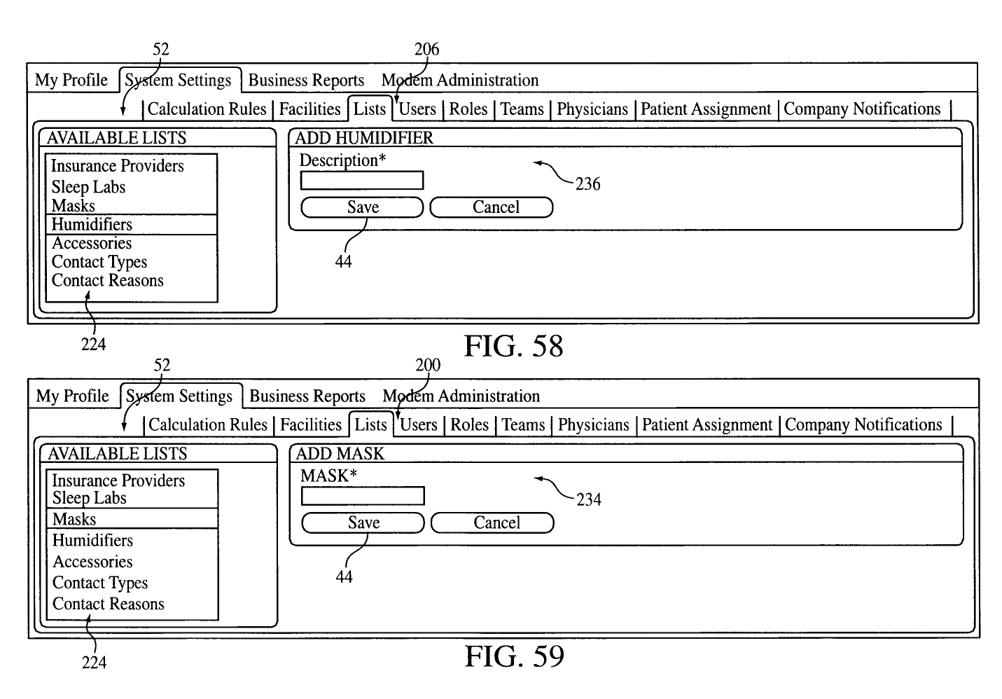

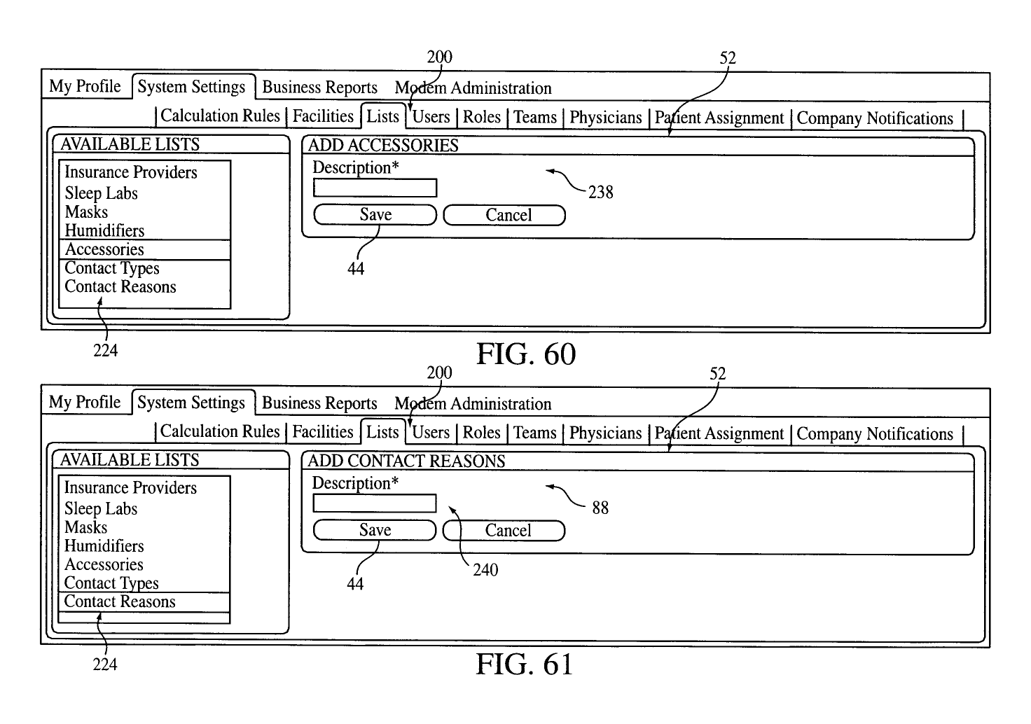

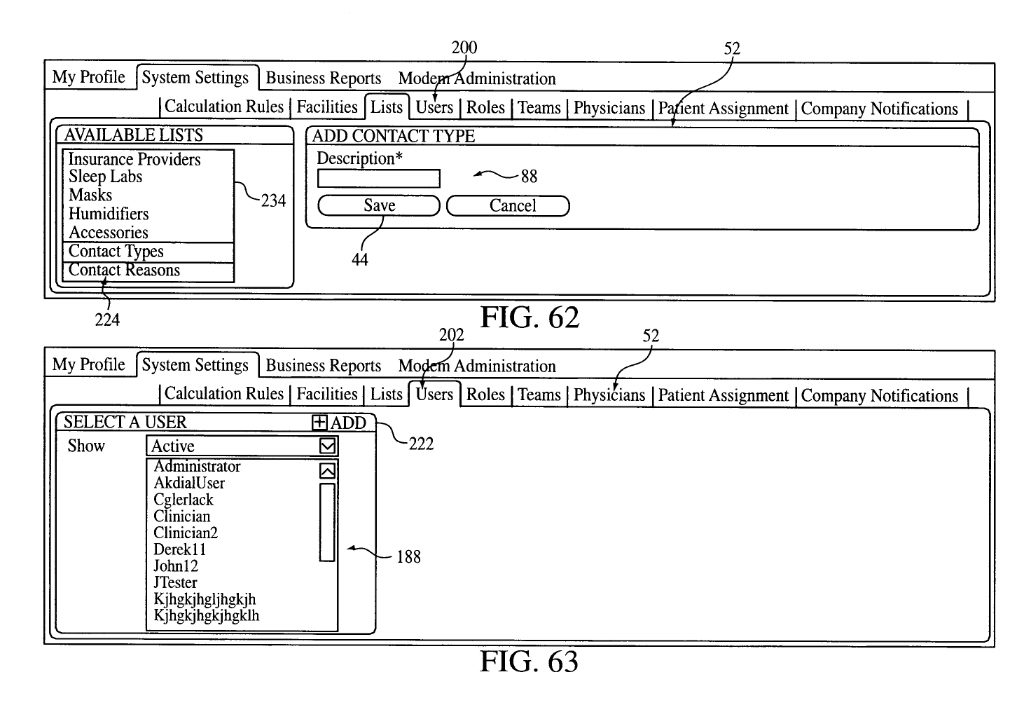

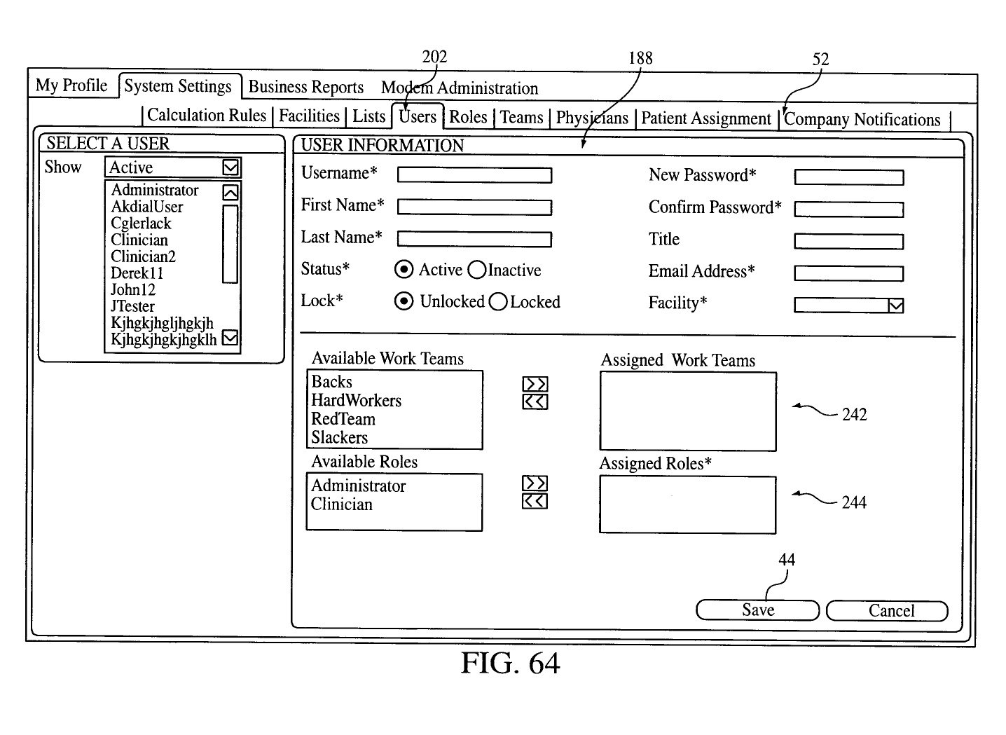

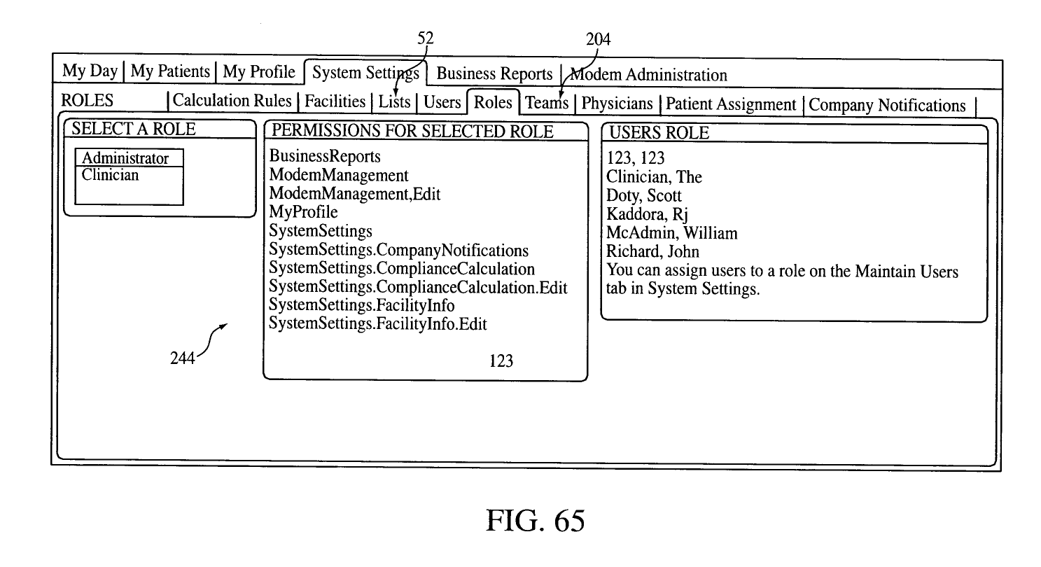

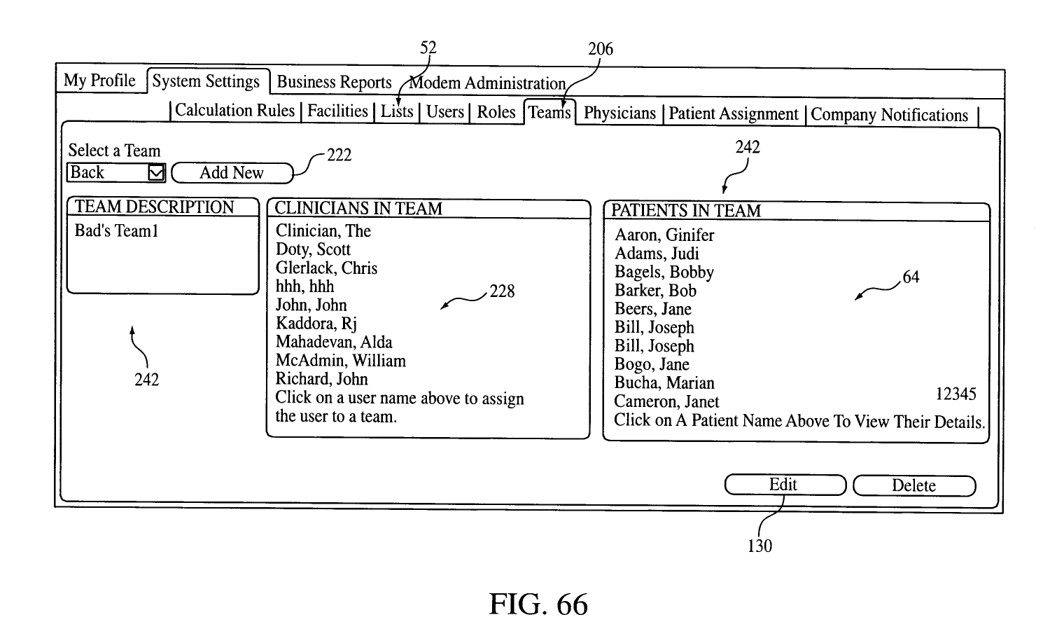

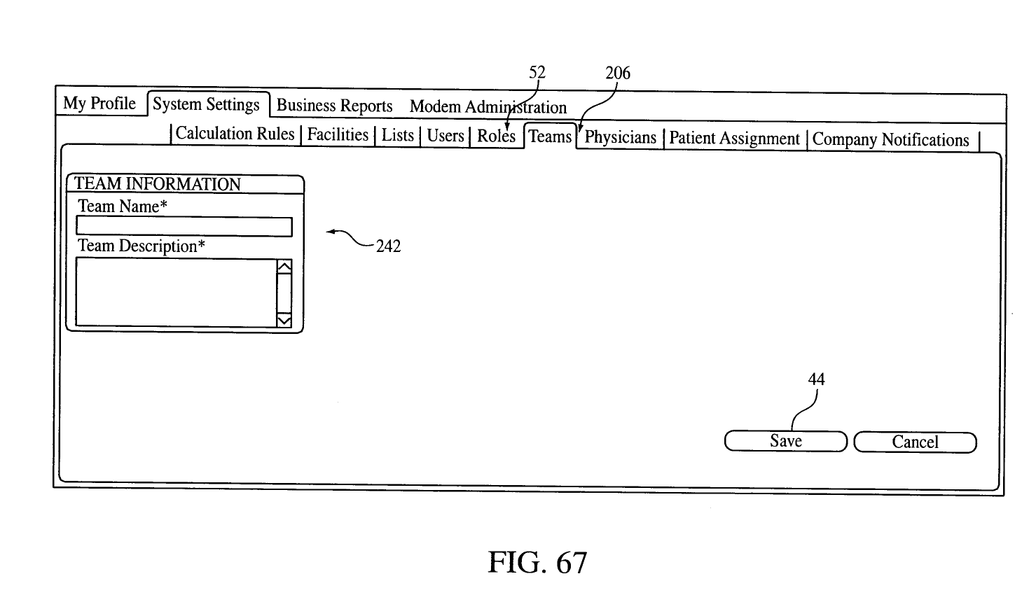

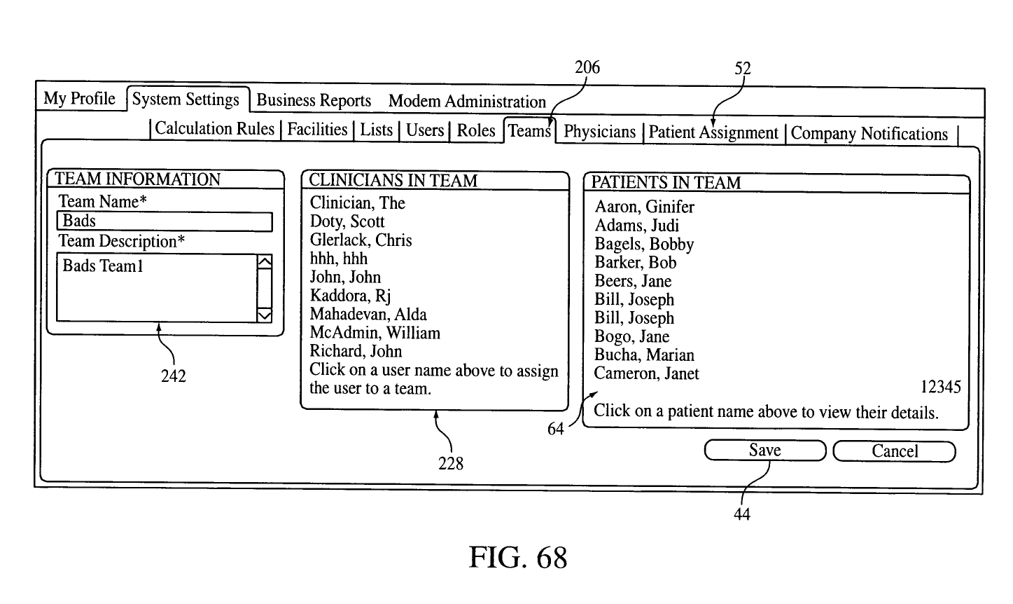

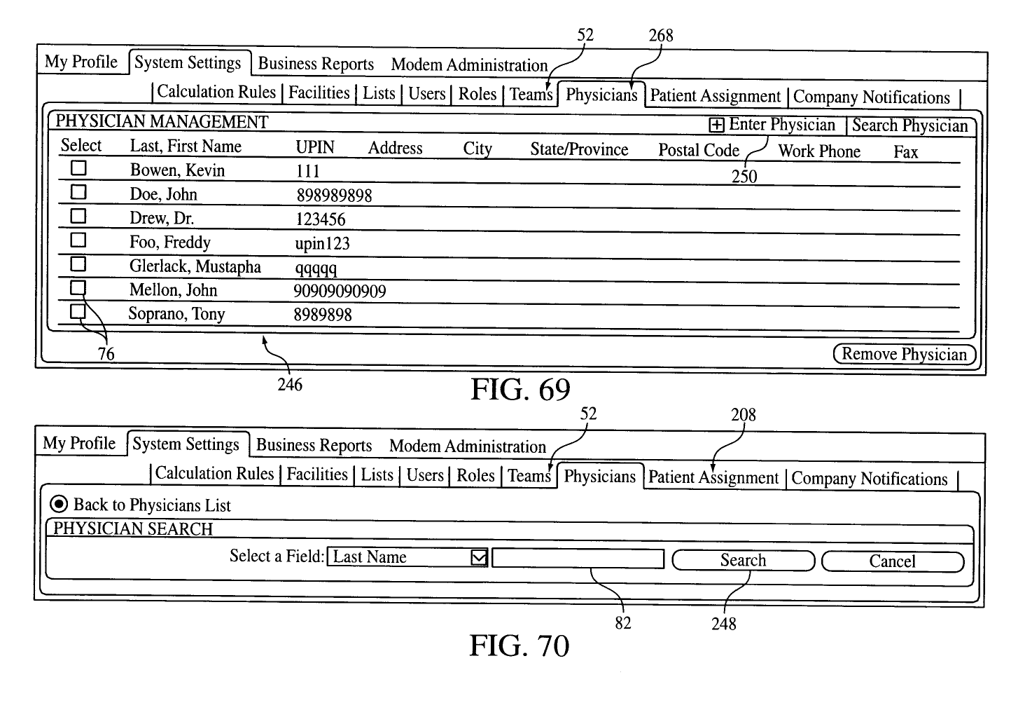

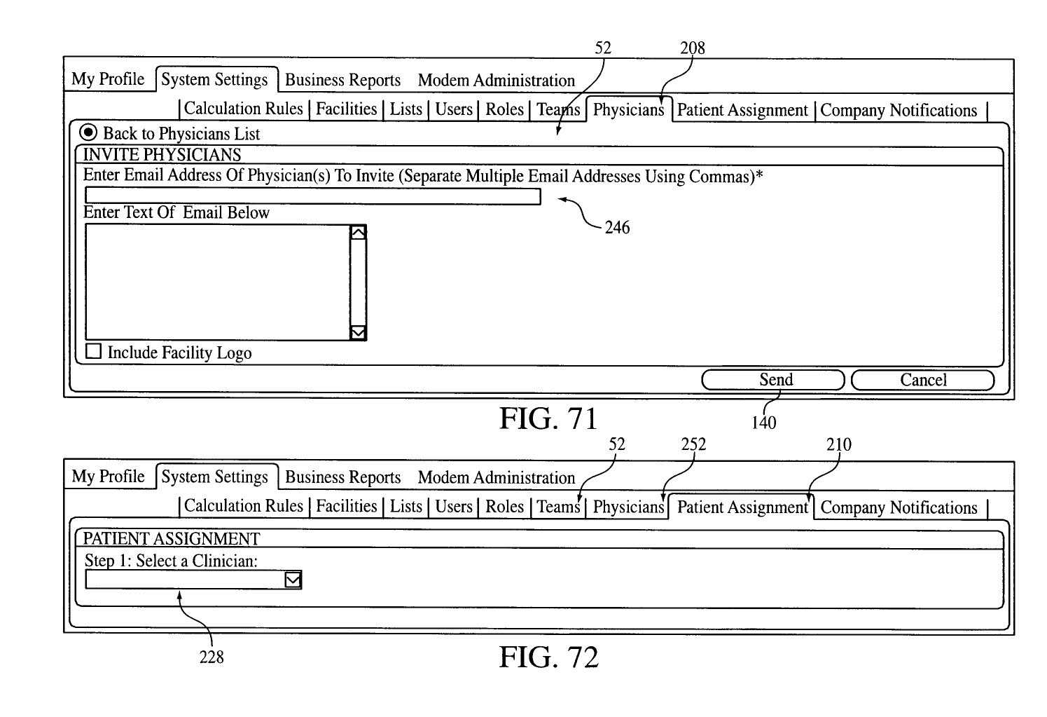

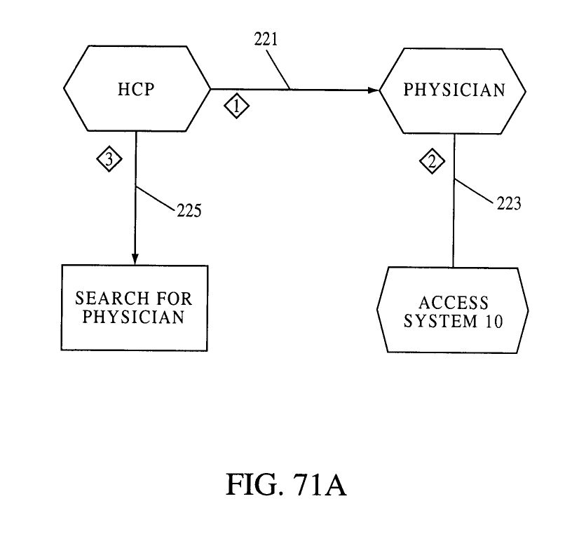

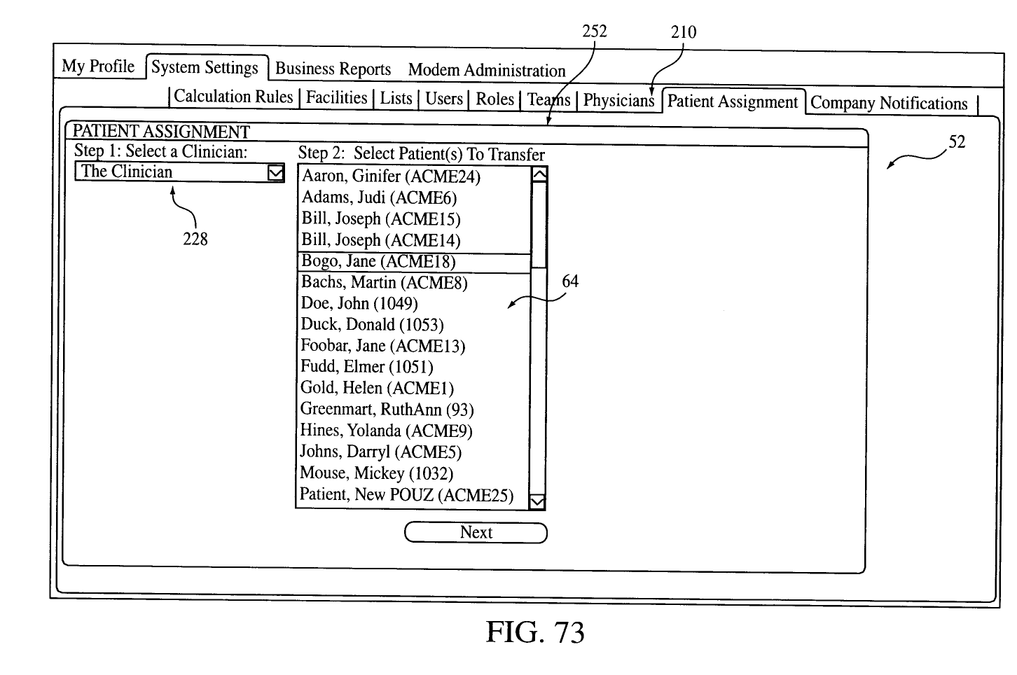

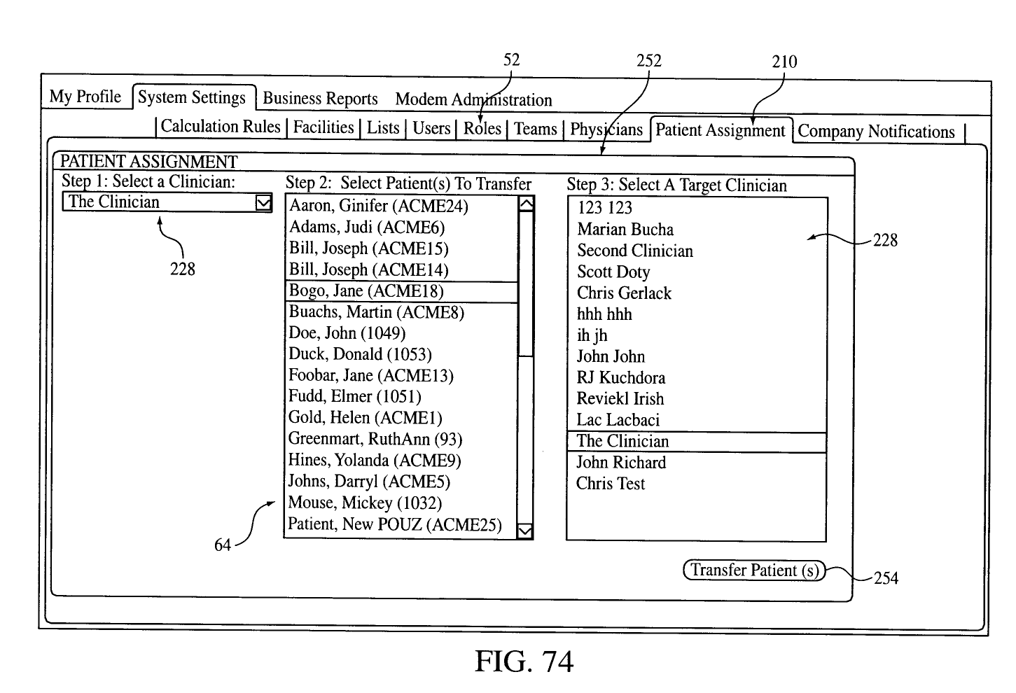

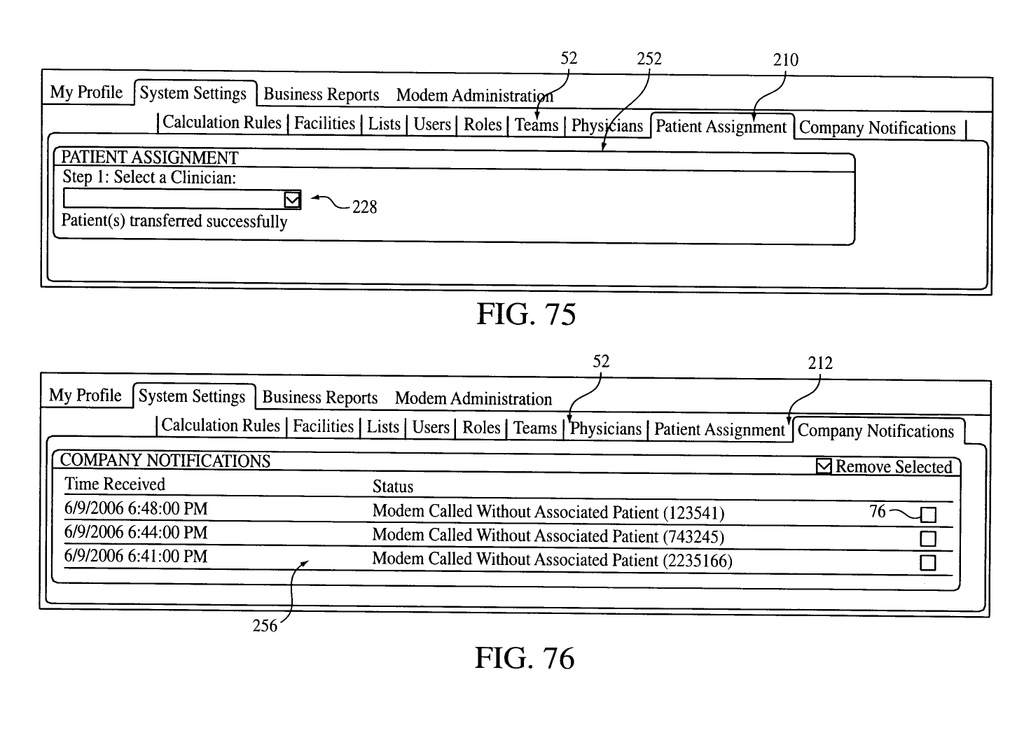

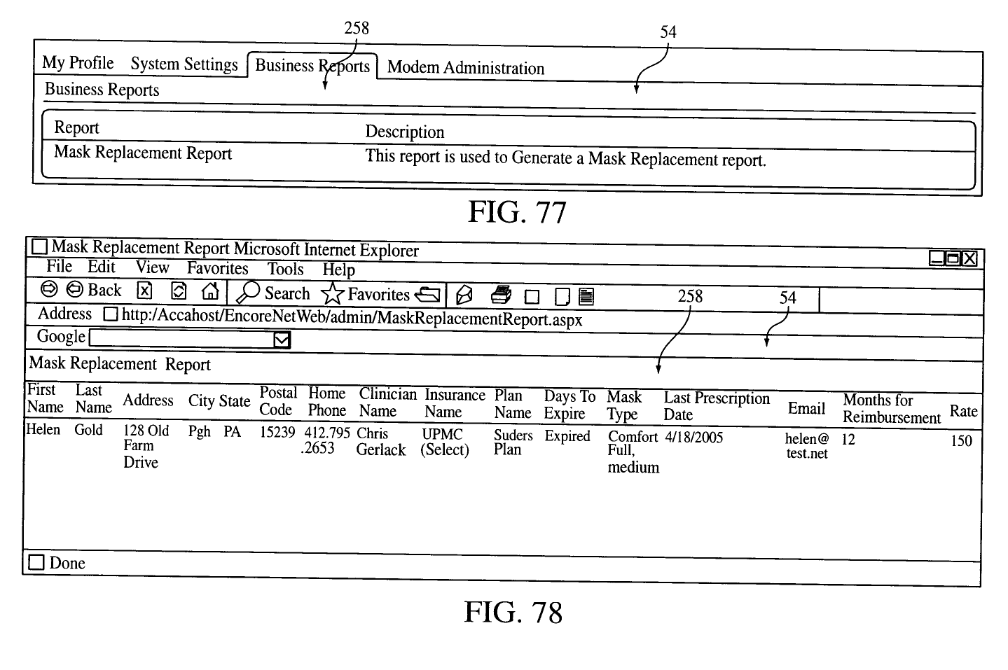

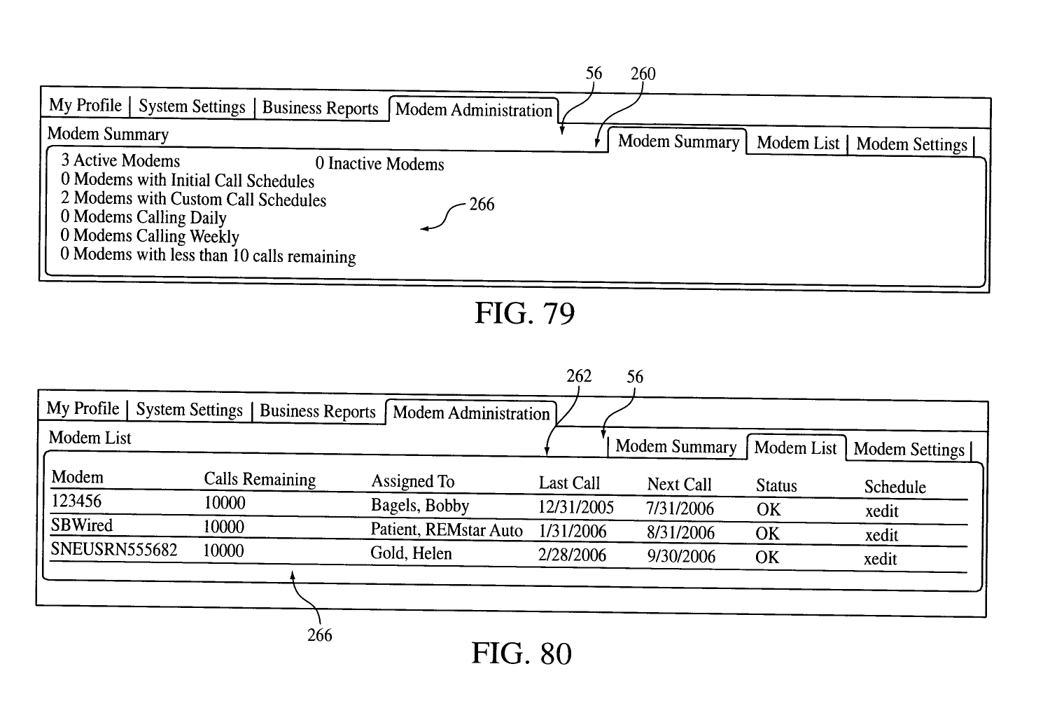

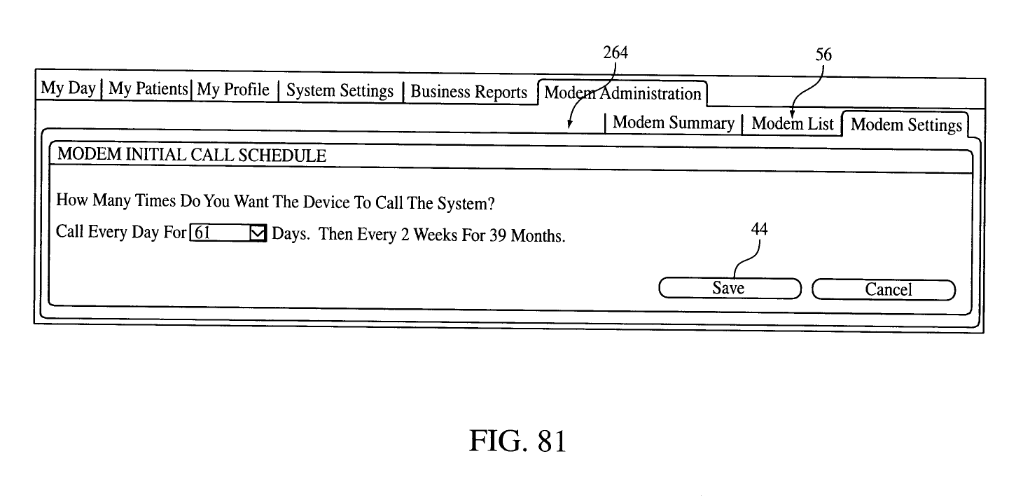

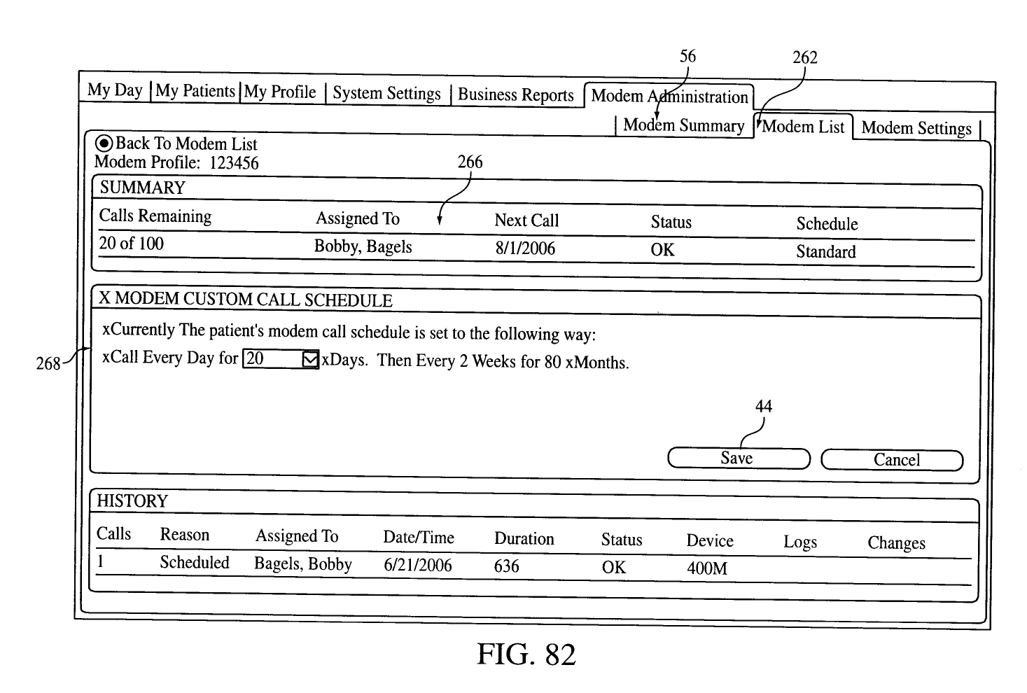

In modem settings section 264, user 14 is permitted to modify and save all call schedule data. As seen in FIG. 81, user 14 or administrator A, HPC H, and/or Clinician C is able to set how often patient device 16 or communications device 18 should interact with and communicate with system 10. This schedule may be modified and saved by user 14 using save button 44. As seen in FIG. 82, a modem profile screen 268 is also available when a specific communications device 18 is selected from modem summary section 260. In modem profile screen 268, a greater amount of modem data 266 is presented to user 14. In particular, in addition to the summary data discussed above, user 14 is also provided with a custom call schedule, as well as a historical schedule of contact between system 10 and communications device 18.

Modem profile screen 268 presents modem data 266, including modem identification, call data, assignment data, last call data, next call data, status data, schedule data, history data, reason data, exception data, duration data, log data, change data, etc. Accordingly, user 14 can establish to whom communications device 18 is assigned, as well as a status of the communications device s' modem 18 last attempt to establish a connection. The custom call schedule may include a drop-down list for daily calls remaining, a label representing the number of bi-weekly calls remaining, a save button 44, and a cancel button. The reasons may explain the reason for the call, such as a “scheduled” call, a “manual call” or an “exception” call (for use if there is an error in data transfer or content). In addition, the date and time of the call, as well as the duration of the call, a status message indicating the result of the call and log data are presented to user 14.

In this manner, a patient information interface 12 is provided for use by a number of possible users 14, including the clinician C, the physician D, HCP H, and administrator A, etc. All data, which is stored in database 20, is populated in the appropriate fields in the appropriate screens and sections throughout patient information interface 12. In addition, this data is populated dynamically as user 14 navigates through patient information interface 12.

The present invention contemplates that system 10 includes many different and varying data streams, which are categorized data sets for the purposes of this discussion only. These “data sets” are only categorized to provide some additional clarity, but none of the above-discussed “data” should be construed as containing only the data fields listed. There is a considerable amount of overlap between these “data sets”, and this represents one key function of system 10, namely to provide one or more linked databases 20 that can dynamically serve data fields to populate any portion of patient information interface 12, or any part of system 10. Accordingly, any specific data fields discussed above in connection with a specific “data set” may be “tagged” or categorized in any other “data set”.

Still further, the present invention contemplates that system 10 and patient information interface 12 maximize the amount and flexibility for data creation, addition, manipulation, editing, deletion, etc., dependent upon the authorization level of user 14. Therefore, any specific data manipulation function (or data in any “data set”) discussed above should not be construed as being limited only to a particular area of patient information interface 12, or any particular function or “data set”. Accordingly, the system provides a dynamic and highly interactive platform to display and otherwise configure data for use in patient information interface 12, or elsewhere in system 10.

### II. Environment and General Functionality

As discussed above, system 10 represents a dynamic communication and patient information management process available to a variety of users 14. In addition, patient information interface 12 may be displayed to user 14 via a web browser or the like at user 14 computer. User 14 may be a clinician C, a physician D, HCP H, an administrator A, a home care provider staff person, a sleep laboratory staff person, a hospital staff person, a family member, etc. In one preferred embodiment, user 14 will be working in a HIPAA-controlled environment. Accordingly, adherence to these duties and responsibilities falls upon user 14, however system 10 may provide certain guidance.

System 10 may be used anywhere, at any time, where user 14 has Internet access and an account on system 10. In one embodiment, system 10 is designed to run on customer or client machines running either Windows 2000 or Windows XP operating systems. In addition, system 10 will have the appropriate drivers and software for utilizing Smartcards 22. Because system 10 and patient information interface 12 are able to run on any existing browser, it may work on conventional browsers, such as Internet Explorer, Fire Fox, etc. As discussed above, in one embodiment, system 10 includes presentation layer 24, web services layer 26, and communications services layer 28. Each user 14 will have different rights and roles associated with system 10, as well as these areas of system 10. While any database or data structure is envisioned, one embodiment of system 10 will include the use of an SQL Server as the back-end database 20. In addition, system 10 will utilize the appropriate USB, PCMCIA and serial reader drivers.

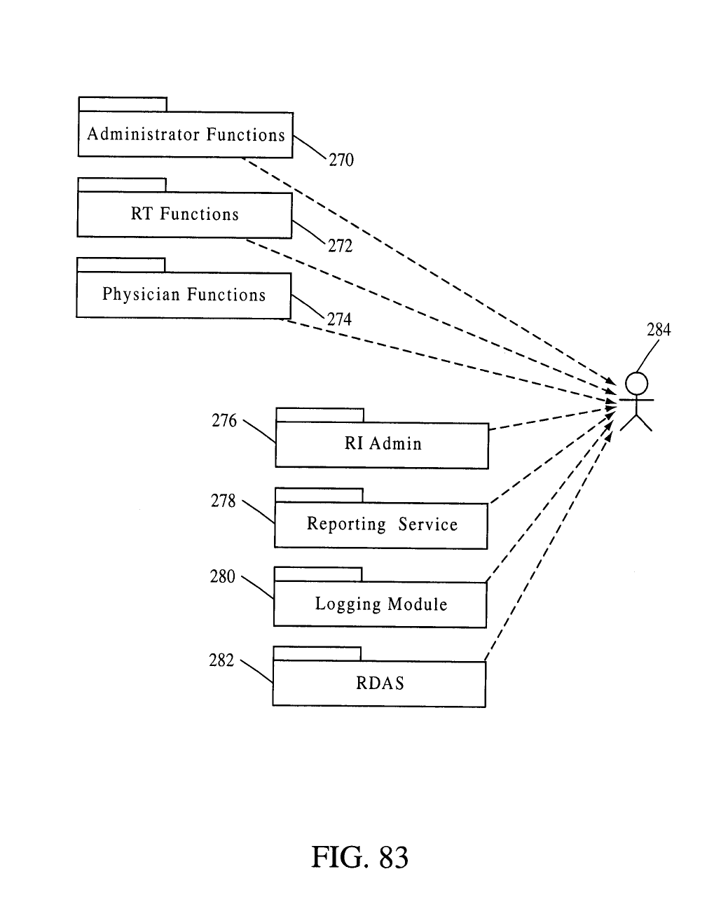

System 10 may be broken down into distinct functional groups. In one embodiment, as seen in FIG. 83, the groups may include administrator functions 270, RT (clinician) functions 272, physician functions 274, RI administrator functions 276, reporting service 278, logging module 280, and server functions 282. In addition, each one of these groupings 270, 272, 274, 276, 278, 280, 282 is in communication with or otherwise driven or implemented by a system server 284.

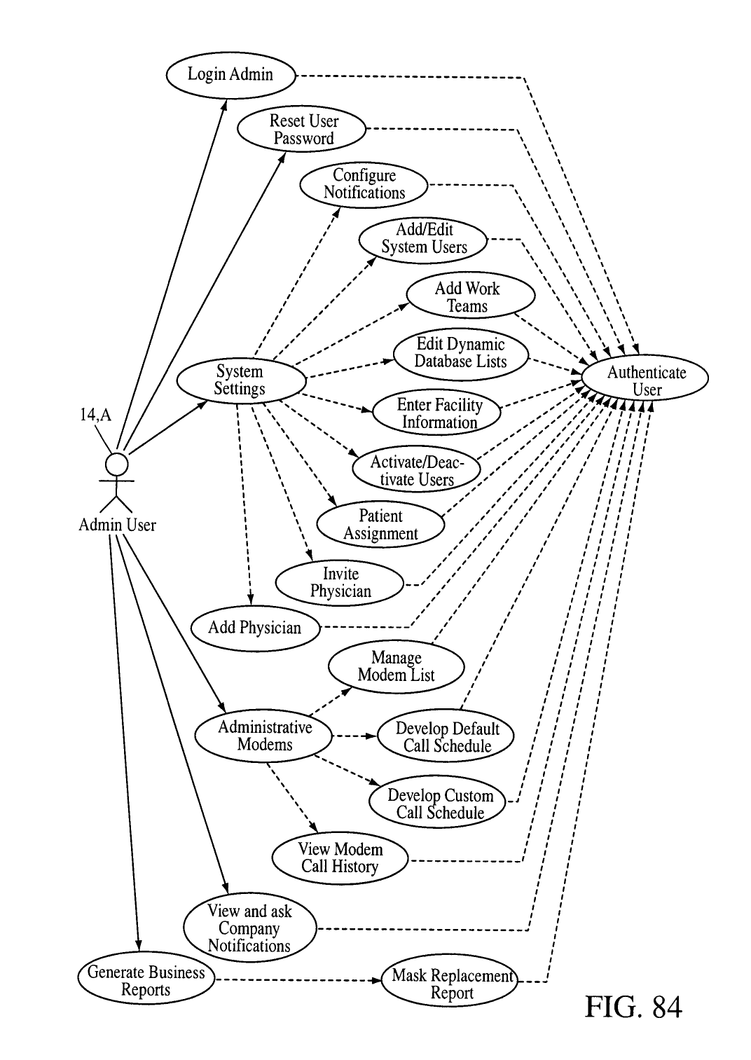

As discussed above, user 14 will have a specified role, access and authorities or rights for using the various functions of system 10. As seen in FIG. 84, when user 14 is an administrator A or HCP H, maximum functionality, display, and data rights are associated with this administrator A. As discussed above, prior to gaining access to system 10, the administrator A or HPC H is authenticated by providing the appropriate user name data 36 and password data 38. Once the administrator A or HPC H has gained access to the system, the full functionality is available to him or her. Accordingly, the administrator A or HPC H is permitted to perform such functions as: reset password data 38; configure associated notification data 66 or notification data 256; determine and modify compliance data 118 and compliance calculation data 214; add, modify and delete user data 188; activate/deactivate the account of a user 14; add, modify, and delete work team data 242; add, modify, and delete list data 224 (which constitutes dynamic lists in database 20); add, modify, and delete patient identification data 64, patient data 80, physician data 246, clinician data 228, insurance provider data 230, sleep laboratory data 232, device data 114, facility data 226, modem data 266, etc.; develop call schedules or schedule data 116 for communications device 18; develop custom schedule data 116 on a per device 18 basis; manage the profiles and call history data for communications device 18; invite a physician D to join system 10; assign patients P where necessary; generate report data 258; view and acknowledge company notifications; etc. It should be noted that this list is by no means exhaustive, and as described above in greater detail, the administrator A or HCP H has the ability to fully manage and configure system 10, as well as patient information interface 12.

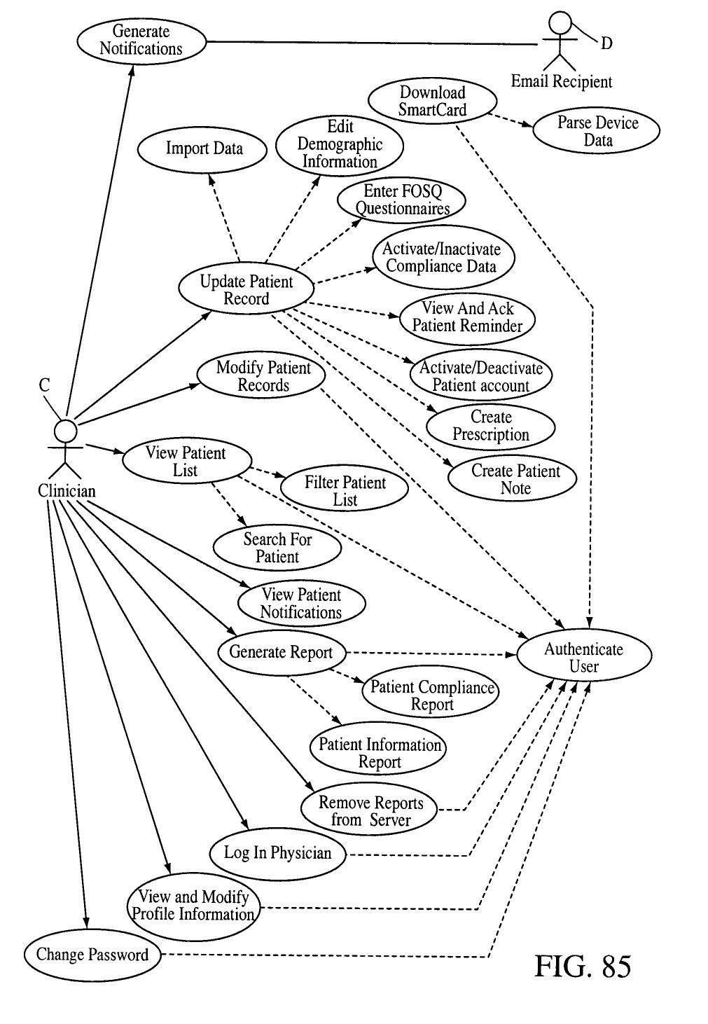

Similarly, the clinician C or HCP H is capable of interacting with system 10 via patient information interface 12 once appropriate authorization and access has been gained. For example, FIG. 85 illustrates some of the functions available to the clinician C or HCP H when utilizing the presently-invented system 10. For example, the clinician C or HCP H has the ability to download and upload device data 114 (such as data on the Smartcard 22). Accordingly, the clinician C or HCP H has the ability to configure system 10 to use any of the available communications devices 18 or Smartcards 22, as well as any interaction required with patient device 16, such as via USB, PCMCIA, serial readers, etc. The appropriate setting would be stored locally on the computer of the clinician C or HCP H in the registry. Once user 14 selects the appropriate path to download data from a Smartcard 22, system 10 will first verify that card 22 is inserted in the reader. If the reader does not detect it, a message will be displayed indicating that the reader/writer was not detected. If a card is not inserted in the reader/writer, the system would display a message that the card has not been detected, and if card 22 is inserted improperly or an error is encountered during communication, the system will also display an alert message.

When downloading data from Smartcard 22, the system will verify patient identification data 64, as well as device data 114, namely the identification or serial number of Smartcard 22. In addition, system 10 may verify the identification of patient device 16 or communications device 18. Accordingly, the system is capable of matching patient data 80, patient identification data 64 and device data 114 with the information in database 20. Any component data, Smartcard 22 data or other information regarding patient device 16, communications device 18, Smartcard 22, etc. will be verified and matched accordingly from the information in database 20. If a match does not occur, an alert is displayed to user 14.

If the version, form, or format of the transmitted data is incompatible with system 10, a message will be displayed to user 14 that indicates the appropriate version. However, the data on Smartcard 22 would remain stored and available. In addition, compliance data 118 contained on Smartcard 22 will be parsed according to a set protocol or logging standard. In addition, system 10 is capable of detecting whether Smartcard 22 may be reused for the same patient P, and if it is not, modify patient data 80 and device data 114 appropriately.

Accordingly, system 10 allows for the appropriate matching of the patient P, patient device 16, and/or the communications device 18, and this matching may occur using central database 20 or other compiled listing at the system level. Further, Smartcard 22 and/or communications device 18 can be utilized and switched between patients P and patient devices 16. For example, communications device 18, e.g., a modem, could be switched from one patient device 16 to another patient device 16 without the need for a physical re-programming of communications device 18. Instead, the serial number of communications device 18, as well as the serial number or identification of the associated patient device 16, can be modified by system 10, which will then use this new data to update the appropriate entries in database 20. This new data will then be used in the above-described matching process. Such an internal switching and matching process provides for greater flexibility and efficiency in the hardware and device distribution and assignment process.

With respect to the functionality afforded the clinician C, this user 14 will also be able to create, modify and delete patient data 80; import patient data 80; and create, modify and delete patient identification data 64. It should be noted that patient identification data 64 should include a patient identification (e.g., an alphanumeric identifier) that is unique to the patient P. A clinician user 14 has the ability to enter this patient identification, however if not entered, system 10 may assign a unique patient identification to the patient P. The clinician C also has the ability to create, modify and delete questionnaire data 110; activate or deactivate patient P accounts; create, modify and delete reminder data 68, prescription data 102 (including appropriately identifying and assigning unit data, mode data, settings, ranges, communications functions and support for patient device 16); issue assigned patient devices 16, communications devices 18, including masks, humidifier and other accessories; modify and interact with the patient P list; create, modify, acknowledge and delete notification data 256; and create, modify and interact with report data 258 (e.g., compliance reports, interaction reports, contact reports, etc.).

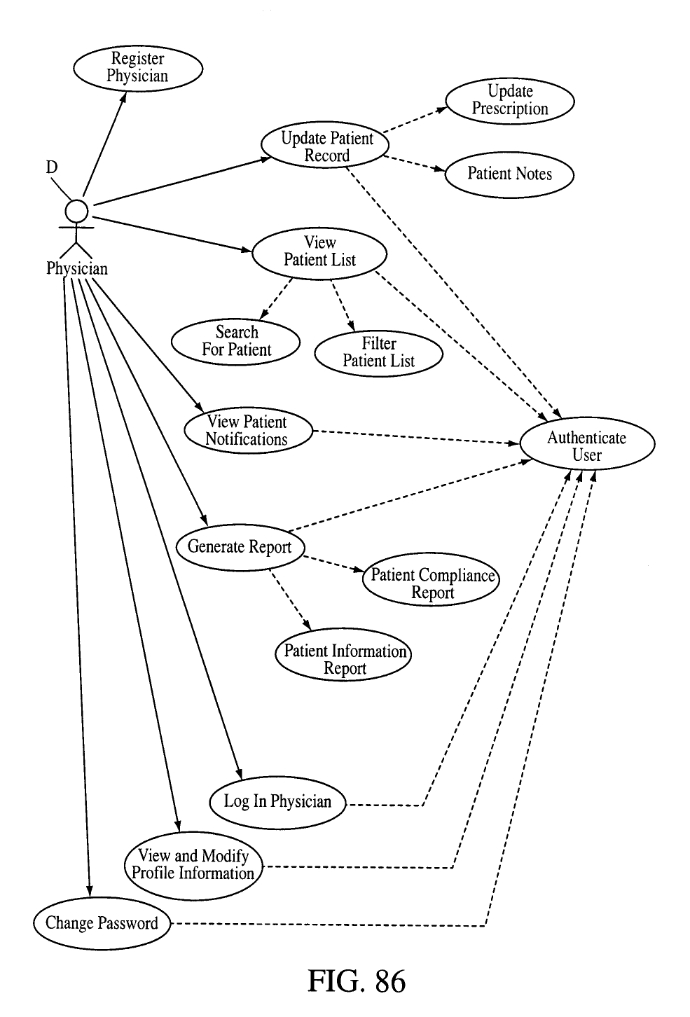

As discussed above, when user 14 is a physician D, system 10 may provide a limited set of functionality to this user. As discussed above, the physician D must have the appropriate access and enter through the same login interface 34 as described above. In addition, the physician D may or may not have been specifically invited by a user 14, clinician C, etc. to participate in using system 10 and patient information interface 12. A portion of the functionality afforded the physician D is illustrated in FIG. 86.

Once the physician D is registered with system 10 and appropriate access has been achieved, the physician D is permitted to: create, modify and delete prescription data 102; create, modify, and delete notes or comments associated with the patient P (e.g., associated notification data 66); view the patient P list; view notification data 256 and/or associated notification data 66; and create, modify and delete compliance data 118 and associated reports; create, modify and delete user data 188, etc.

One of the advantages of the present invention is that it allows a physician D to view information on a number of patients associated with that physician in a single consolidated report, even if the patients for that physician are being supervised by different HPC and/or clinicians. Conventional data acquisition systems do not allow the data associated with one HPC to be accessible by or through another HCP. Thus, a physician would have to access the data management system of each HCP individually in order to view all of his patients. Using the present data management system, however, the data is maintained by a system that is accessed by the HCP and not under the exclusive control of the HCP, so that physicians can have access to their patient's data independent of the HCP or clinician associated with that patient.

One of the benefits of including a relational and dynamic database 20, is the ability to provide up-to-date and timely notifications to the users 14. Accordingly, system 10 monitors certain patient data 80 and usage information, as well as other system 10 activity, and sends notifications, where applicable. For example, compliance notifications may be sent to user 14 based upon the hourly usage of patient device 16, the percentage usage of patient device 16, AHI compliance, leak notifications, message notifications, communications device 18 notifications, etc.

When user 14 is a customer service representative of patient device 16 and/or system 10 manufacturer, this representative will have the ability to create a new account for a company. In one embodiment, the creation of such an account would be initiated via a web service call, and the account information would be entered into system 10. In addition, it is envisioned that the manufacturer's system or other computing systems can be in communication with system 10 and initiate web service commands and other similar communications functions for achieving these results. This customer service representative may also have the ability to activate or deactivate accounts, activate communications devices 18, deactivate communications devices 18, permit access in the case of lost password data 38, initiate the shipment of a communications device 18, etc.

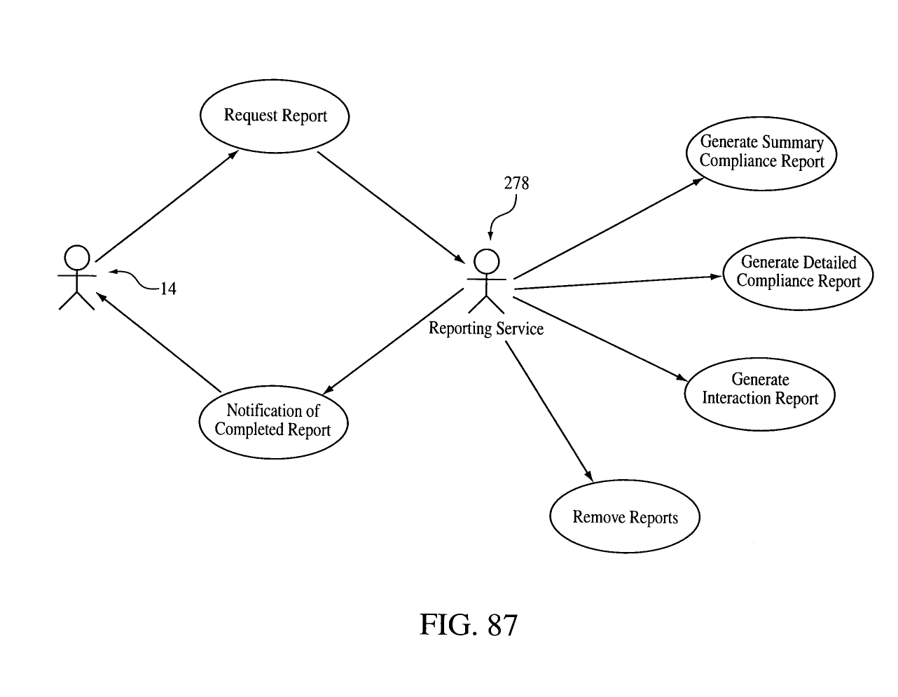

Another important function of system 10, as discussed above, is the generation and communication of reports and report data 258. In particular, patient information interface 12 allows user 14 to submit requests for summary reports, detailed reports, etc., which are populated with data from database 20. In an exemplary embodiment, a user (any user) could request a report to be generated, and a reporting service 278 can be used to generate the report and notify the user when the report has been completed. In one embodiment, these reports would be associated with a patient P, and only users 14 having authorization to view a specific data of patient P will have the ability to retrieve the report. User 278 may also delete reports from the server. See FIG. 87. In addition, these reports may have standard header, footer and forms and format information for use in consistent generation.

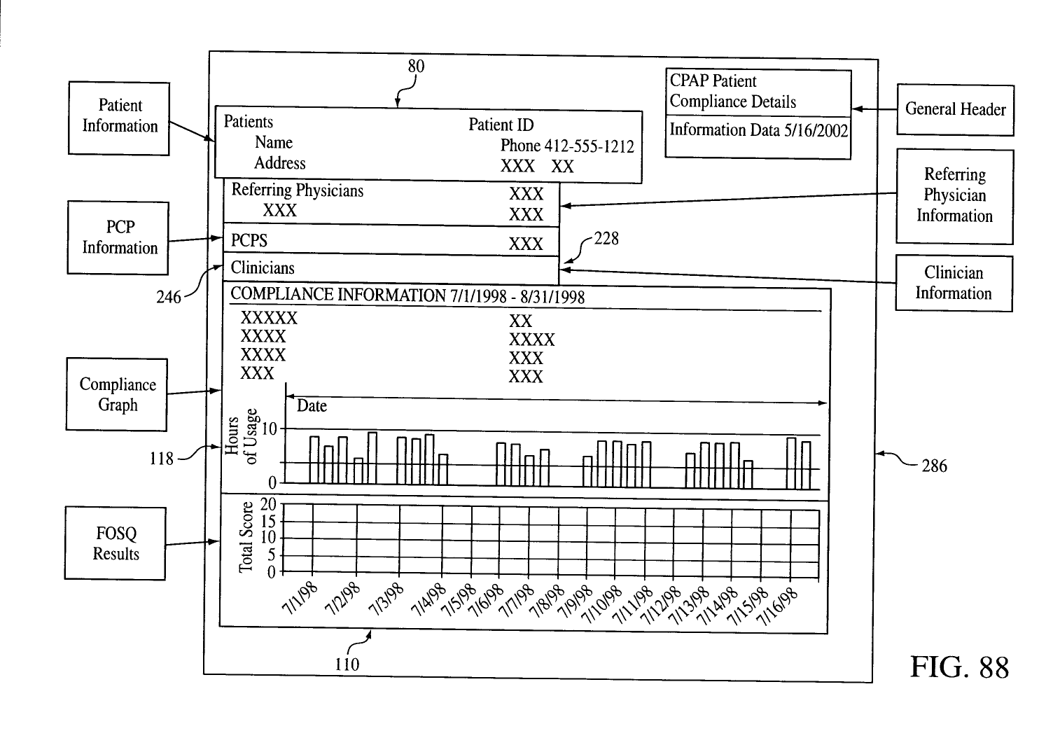

FIG. 88 illustrates a summary compliance report 286 which includes patient data 80, physician data 246, compliance data 118, questionnaire data 110, clinician data 228, and other pertinent information. In addition, compliance data 118 includes a graphical representation of the usage and compliance of the patient P with the therapy/prescription. For example, as seen in FIG. 88, compliance data 118 may be displayed in a bar-type graph, with the X-axis indicating the date and the Y-axis indicating the hours of use. Compliance data 118 display would be the total therapy time for the day, and the graph would also be displayed in a way in which the unit mode could be determined. Similarly, questionnaire data 110 would be represented in graphical form for the selected date range. In this case, the X-axis would indicate the date and the Y-axis would indicate the total score. The average test score would also be provided over a given range.

As discussed above, any of compliance data 118, questionnaire data 110, compliance calculation data 214, AHI data 216, and leak data 218 can be displayed to user 14 as graphical representations created based upon the type of patient device 16 and prescribed therapy. A detailed compliance report 286 may also be generated by system 10. Compliance data 118, again, could be displayed in graphical form including patterns-of-use, hours-of-use, pressure trend, long term index trend, snore index, apnea indicator, flow limitation index, leak data, daily details, events, questionnaire, synchrony therapy and other statistics. These statistics will be calculated based upon known formulas and algorithms. User 14 may also have an interaction report generated detailing patient interactions. Further, a mask replacement report may be generated, which would display all the masks that have exceeded their expiration date by a set period of time, or set to expire.

### III. Network and Communications Features

As discussed above, system 10 may be implemented over a variety of networks, communication links and protocols in order to achieve the dynamic input/output of data. Accordingly, the present invention is further directed to a communication system 288 for use in patient information management. Communication system 288 will include the above-discussed central database 20, which includes multiple data fields populated with patient data 80, physician data 246, health care provider data, device data 114, medical data, health data, presentation data, identification data, administrator data, etc. In particular, all or a portion of the various data points and above-described data fields could be added, modified and deleted in database 20. In addition, a set of program instructions is configured to facilitate communication of data between one or more patient devices 16 (via a communications device 18) in communication system 288. In particular, communications device 18 may be a hardwired modem, a wireless modem or any other device that allows for the electronic communication of data from patient device 16 to and within communication system 288.

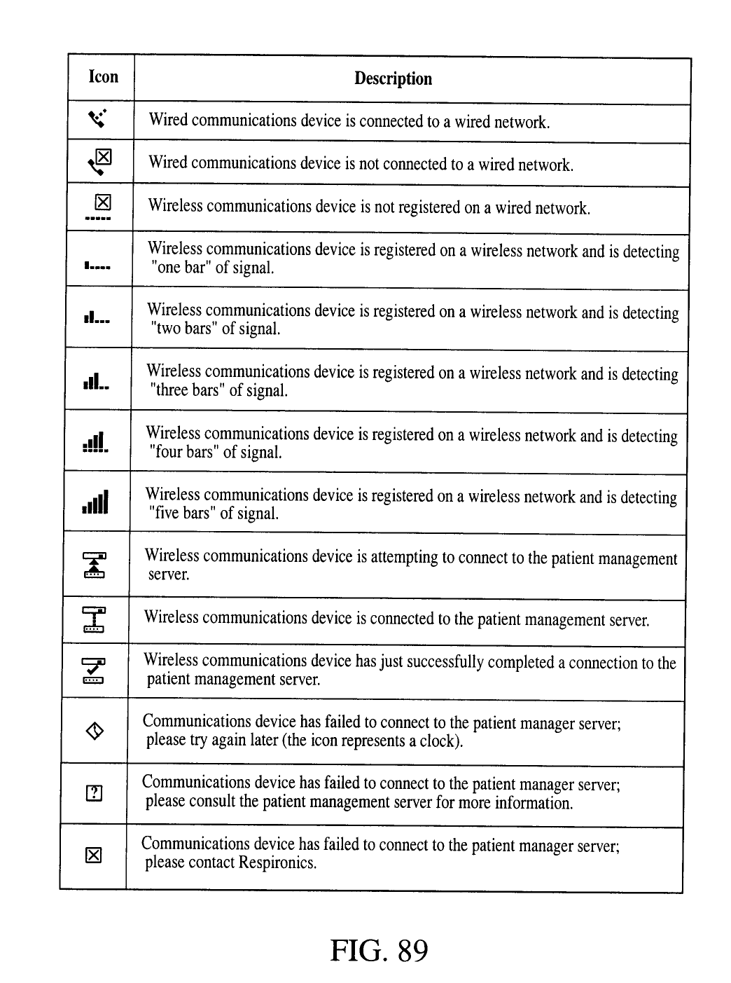

The present invention contemplates that communication device 18, whether a stand-alone device, such as a modem, or integrated into another device, such as a pressure support system, ventilator, or other medical device, can display or provide information indicative of the status of the modem. This information can be displayed in a visual format, presented audibly, or any combination thereof. FIG. 89 illustrates various examples of icons that can be displayed by the communication device and their associated meaning.

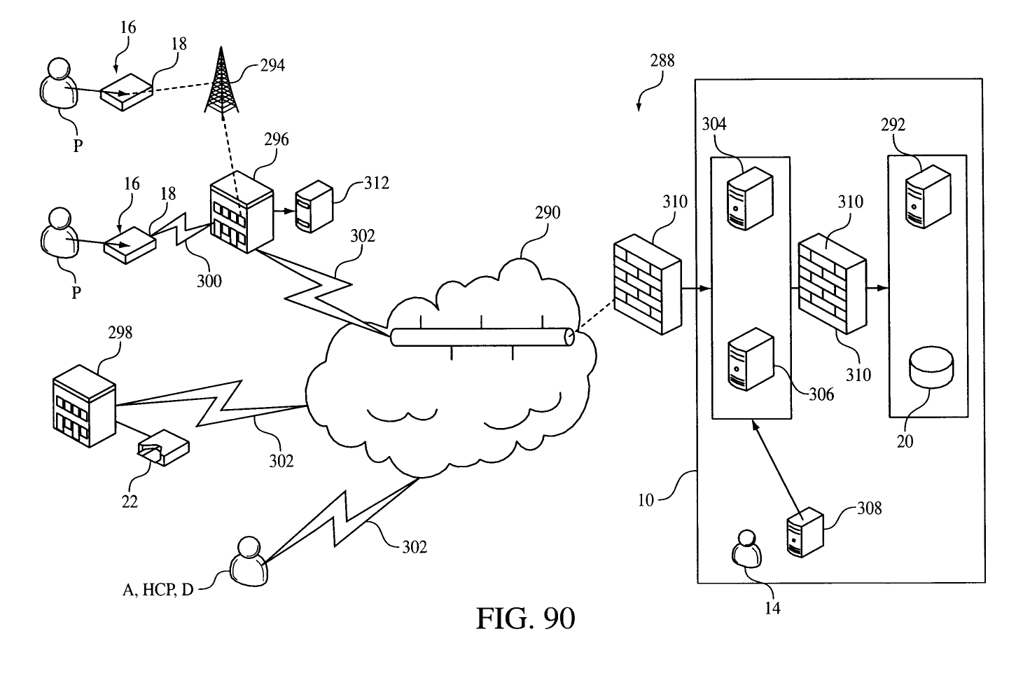

As seen in FIG. 90, the present invention is further directed to a method of facilitating secure transmissions of data from a patient device 16 over a network 290 to a patient management system 10. This method would be implemented over a communication system 288, as discussed above. Therefore, communications are enabled between patient device 16 and a communications device 18, and communications device 18 transmits data to a patient management system server 292. This transmission occurs over the network 290, and this network 290 may be a Virtual Private Network, the Internet, a wireless local area network, a wireless wide area network, a WiFi network, etc.

It should be noted that patient device 16 and communications device 18 can be combined into a common device, for example, a pressure support system with an integrated communications capability, such as a modem built into the circuitry of that device. The present invention also contemplates that patient device 16 is optional, so that data can be provided to and from the system via a communications device 18, such as a modem provided with a computer.

When the data transmission is in a wireless format, communications device 18 transmits the data over a wireless carrier 294 to an Internet Service Provider (ISP) server 296. ISP server 296 then transmits information and data to patient management system server 292 over network 290 for storage in database 20. Typically, a hardwired communication link 302 connects the ISP servers to network 290. Although wireless connections are also contemplates. It is also envisioned that a storage device, e.g., Smartcard 22, includes data that is transferred to an intermediate server 298. This data would then be transmitted from intermediate server 298 through network 290 to patient management system server 292. For example, intermediate server 298 may be a server based at the health care provider, hospital, facility, clinician work station, etc.

Hardwired information and data may be sent from an appropriate communications device 18 over a telephone line 300 to the ISP server 296, which then follows the same protocol for communications with patient management system server 292 discussed above. Wireless communications, as well as hardwired communications, are secured. For example, the secured communications may be conducted according to a cryptographic protocol, Secure Sockets Layer protocol, Transport Socket Security protocol, etc.

In order to provide further security to the communications in communication system 288, further intermediate and frontline servers may be used, such as a web server 304, a remote data acquisition server (RDAS) 306, and a business unit server 308. Web server 304 is used to drive and implement the above-described system 10, remote data acquisition server 306 is used to effect secure transmissions between system 10 and patient device 16 (or communications device 18), and business unit server 308 is used to provide appropriate data regarding other business aspects and information associated with system 10. In addition, appropriate and secure firewalls 310 may be used to further secure all communications in system 10 and communication system 288 over a network 290.

In another aspect of the present invention, the communications over network 290 to system 10 may occur over a dedicated line, as facilitated through a dedicated phone number (e.g., a “1-800 number”). Because all calls from communications devices 18 are channeled through this single, secure, and dedicated line, patient P, patient device 16, and communications device 18 matching process is both efficient and accurate. If it is determined, for example, that communications device 18 should be assigned or switched to a different patient P or patient device 16, the switch can occur and be detected by system 10 during the next call to the system over the dedicated line. Using internal database 20, system 10 can easily resolve, modify, and/or match the new device data over this communication line. In addition, system 10 may implement appropriate security measures based upon the incoming data over the dedicated line and the data in the database 20 using the above-described matching process.

Unlike some existing communications devices, which need to be configured with patient- or site-specific parameters, communications device 18 as used with system 10, requires no such configuration by the end-user. All communication-related parameters (phone number, dialing prefixes, server address, etc.) are identical for a given type of communications device, and the communications device has no patient identifiers. Provided that the end-user has made the proper match of patient to therapy device and communications device within the patient management server, the system will be able to work should the end-user move the communications device from one patient's therapy device to another patient's therapy device

In order to add another layer of security, communication system 288 may utilize a handshake protocol. Specifically, communications device 18 initiates contact with patient management system server 292 (whether through the intermediate servers or not), and this communication is authenticated through the remote data acquisition server 306, which is in communication with patient management server 292. In particular, these communications are subject to and conducted according to a challenge protocol. This challenge protocol includes: pre-providing a challenge algorithm to patient device 16, communications device 18, etc.; transmitting a key from patient management system server 292 to communications device 18; processing the key by patient device 16 and/or communications device 18 according to the challenge algorithm, thereby obtaining a response key; and transmitting the response key from communications device 18 to patient management system server 292. In one embodiment, the algorithm may be a mathematical formula transmitted to or pre-stored on patient device 16 and/or the communications device 18. This algorithm would take the key (e.g., a number), apply the mathematical formula to the number and return the response key or number. For example, the algorithm may be 3X²+10. If the key sent is 5, then the response key would be 85. Patient management system server 292 would ensure that communications continue only if the number “85” was received.

If the response key obtained is correct, further secure communications are established between patient management system server 292 and communications device 18. However, if the response key is incorrect, system 10 may close the communication link between patient management system server 292 and communications device 18; request a retry by communications device 18; send a subsequent key from patient management system server 292 to communications device 18; and/or generate a notification by patient management system server 292 for user 14. User 14, in this embodiment, can be any user, such as the user attempting to establish the communication link, D, A, HCP, C of FIG. 1.

In one embodiment, the format is a parsable string of alphanumeric characters, where the response key is embedded in the string or somehow associated with the string. In the above example, where the response key is “85”, this key may be transmitted to patient management system server 292 as the following string—“0CR83BX65”. In this case, the string would be parsed, and the values at the first, fourth and ninth positions would be read and combined to form “085”, i.e., the correct response key.

In addition, this challenge protocol may include pre-providing a response key format to patient device 16, communications device 18, etc.; and transmitting the response key in the response key format from communications device 18 to the patient management system server 292. Accordingly, if the response key format is correct, system 10 will establish further secure communications between patient management system server 292 and communications device 18. However, if the response key format is incorrect, the above-discussed options would be available, including closing the link, requesting a retry, sending a subsequent key, generating a notification, etc.

As discussed above, this communication system 288 may be used to transmit data back and forth between the patient devices 16 and system 10. For example, this data may be transmitted by patient management system server 292 to communications device 18, and this transmitted data is then communicated to patient device 16. For example, such a device may be prescription data 102 and the like. In addition, this transmitted data may include programming data for use in modifying settings of patient device 16. Further, communications with and to communications device 18 may provide some visual indication to the patient P of the status of the device 16, 18. All activities occurring in system 10 in communication system 288 can be logged and associated with a particular user 14 or device or component of system 10, 288.

FIG. 91 illustrates one preferred embodiment of communications system 288, which uses RDAS 306 as a central communications “bottleneck” for use in securing communication. Accordingly, communication system 288 allows for the management of secure communications using remote TCP/IP modems, TCP/IP Smartcard readers/writers, etc. Communication system 288 allows for the retrieval of compliance, therapy and error information from remote devices and also sends configuration changes to these same remote devices. The above-discussed authentication and challenge protocol may occur throughout communication system 288, such as at a radius server 312 in communication with the ISP server 296 (see FIG. 89). Communication system 288 provides for the identification of communications device 18 in attempting access to determine whether the patient P has paid for the appropriate service, and determine whether any specific instructions are required for data storage locations.

In one embodiment, remote data acquisition server 306 identifies each patient device 16 that communications device 18 is acting as a communication proxy on behalf of. Accordingly, data necessary to determine the types of devices present and to determine where each set of downloaded data is destined to be stored is provided whether through web server 304, remote data acquisition server 306 or the business unit server 308. Communication system 288 allows for the retrieval of active communications devices 18, as well as patient identification data 64. In any case, it is remote data acquisition server 306 that makes the determination whether a connection should continue or be terminated, and whether the patient P and patient device 16 and/or communications device 18 are appropriately associated. Remote data acquisition server 306 may also determine device capabilities, request logs, parse modem data, specify configuration changes, authenticate users and transmitted data, download Smartcard 22 data, parse this Smartcard 22 data, store patient data 80 and device data 114, store communications device 18 call histories, etc. Accordingly, communication system 288 provides a secure and networked environment for the transmission of all appropriate data between the patient devices 16, the communications devices 18 and the other components of system 10.

In this manner, the present invention provides a system 10 and communication system 288 that allows for the effective use and management of patient P information. Using the full functionality of patient information interface 12, any user 14 is capable of engaging in all needed functions to better perform his or her duties. The data structure and protocol allow for the dynamic population of fields throughout system 10, such that all real time and up-to-date information is provided to each user 14 according to his or her authorization levels and roles within system 10. Therefore, the present invention provides a computer-implemented method and system 10 for patient information management that provides a robust and secure communications platform and infrastructure to facilitate communications between all users 14 and patient devices 16. In addition, the presently-invented method and system 10 provides a simple, yet dynamic, interface to the clinician C, physician D, HCP H, administrator A, etc. for use in monitoring, analyzing and communicating with patients P and/or patient devices 16. Still further, the present system provides for increased and efficient compliance monitoring, reminder functions, notifications, patient data 80 and information management and other additional functions that enhance the experience of user 14 interactive via patient information interface 12, while improving user/patient responsiveness, resulting in an enhanced health care and efficacy system.

FIG. 92 provides another illustration of a method by which a modem accessory (communication device 18) is sold, shipped, serviced, and used to call patient data management system 10 according to the principles of the present invention. This diagram shows how each of these operations work together in the system to provide a secure and simple method to deliver data from a patient therapy device 16 to system 10.

Shipping 350 is person or process that provides a modem to an intended destination, such as a HCP, as indicated at 360. When a modem is shipped, a shipping tracking system (such as an SAP system) of the modem provider (which is typically also the manufacturer of patient device 16 and/or communications device 18) will call a routine in step that populates radius server 312 with the authentication information required to reach RDAS system 306. Radius Server 312 is the authentication server for the ISP. This authentication information will be populated with a username and login when a modem is shipped. The tracking system of the modem provider also places an entry in a global modem list 356 that indicates that an HCP has not yet been assigned to that modem (the assignment of the HCP to a modem occurs when the HCP enters a prescription that utilizes that modem). Global modem list 362 is outside of any individual HCP's data and allows RDAS system 306 to quickly locate and identify the modem-HCP relationship. The global modem list is contained, for example, in database 20. This list can be access by super-administrator A, but would normally not be accessible to patients, clinicians, physicians or HCPs. However, an HCP/clinician can view the modems associated with the communication devices under their supervision.

Creating a system account 358 is completed by a database customer service representative (CSR) 352. In a typical setup, CSR 352 is an employee of the company responsible for maintaining system 10, such as a patient and/or communications device manufacturer. When an account is created, the system will provide a username and a password, for example, via e-mail to the user to be entered into the account, such as the HCP. This information is used to access the system as described above.

HCP 354 is a user that sends the modem (communications device 18) out to the patient. The HCP will create a prescription 364 that unites a patient therapy device 16, modem 18, and the HCP. When a patient prescription is entered, the user will enter the prescription information for the therapy device, the serial number of the therapy device, and the validation number that is located with the modem. Please remember that in this example, the therapy device corresponds to patient device 16 and the modem corresponds to communication device 18. The technique for generating the validation number is discussed above. Once the prescription is saved, global modem list 356 is updated to include the HCP information for that modem (previously, the entry would be null because at the time of shipment, the company was not known).

The therapy device 16/communications device 18 will call 366 and be authenticated 368 by radius server 312. Once authenticated at the radius server, the modem will connect to RDAS server 306. The modem will communicate to RDAS 306 via a known protocol. An identity message will be generated by the modem and sent to the RDAS system with enough information to enable the system identify the HCP that owns the modem (updated when the prescription was entered) as well as the patient connected to the therapy/patient device 16 (via the therapy device serial number entered at the time of prescription). In step 370, the system determines whether the therapy/patient device serial number connected to the modem corresponds to the validation number. If so, then the system recognizes the therapy device as being a valid device.

In the event that the therapy/patient device serial number connected to the modem is not the same as the prescription generated in prescription creation step 364, there will be a notification to the HCP that indicates that the correlation of the modem (communications device 18) and therapy device (patient device 16) is incorrect. The HCP will then be required to modify the prescription to remedy the problem.

The present invention contemplates that individual modems will not be repaired. Once a modem is to be replaced, a service technician 370 will use a tool that will remove the modem entry from radius server 312 and remove the modem information from global modem list 356. A new modem can then be shipped, and the process discussed above followed to track the new modem to the patient.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, it is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A method of facilitating the secure transmission of data of a patient device over a network to a patient management system, the method comprising the steps of:
enabling communication between the patient device and a communications device; and
transmitting, by the communications device, data to a patient management system server, wherein the transmission occurs over a network, and wherein the data is patient data, device data, medical data, health data, presentation data, identification data, or any combination thereof.

2. The method of claim 1, wherein the network is a Virtual Private Network, the Internet, a wireless local area network, a wireless wide area network, a Wi-Fi network, or any combination thereof.

3. The method of claim 1, wherein the method further comprises the steps of:
transmitting, by the communications device, patient data to an Internet service provider server; and
transmitting, by the Internet service provider server, patient data to the patient management system server.

4. The method of claim 1, wherein the method further comprises the step of transferring, by a storage device, patient data to an intermediate server in communication with the communications device.

5. The method of claim 1, wherein the communication between the communications device and the patient management system server are secure communications conducted according to a cryptographic protocol, the Secure Sockets Layer protocol, the Transport Socket Security protocol, or any combination thereof.

6. The method of claim 1, wherein the communications device initiates contact with the patient management system server.

7. The method of claim 1, further comprising the step of authenticating communications from the communications device through a remote data acquisition server in communication with the patient management system server.

8. The method of claim 1, wherein the communication between the communications device and the patient management system are conducted according to a challenge protocol.

9. The method of claim 8, wherein the challenge protocol comprises:
pre-providing a challenge algorithm to the patient device, the communications device, or any combination thereof;
transmitting a key from the patient management system server to the communications device;
processing the key by the patient device and/or the communications device according to the challenge algorithm, thereby obtaining a response key;
transmitting the response key from the communications device to the patient management system server; and
determining whether the response key is valid by comparing the response key to an expected response key.

10. The method of claim 9, further comprising the steps of:
if the response key is valid establishing further secure communications between the patient management system server and the communications device; and
if the response key is invalid:
closing the communication link between the patient management system server and the communications device;
requesting a retry by the communications device;
sending a subsequent key from the patient management system server to the communications device;
generating a notification by the patient management system server for a user; or
any combination thereof.

11. The method of claim 8, further comprising the steps of:
pre-providing a response key format to the patient device, the communications device, or any combination thereof;
transmitting the response key in the response key format from the communications device to the patient management system server; and
determining whether the response key format is valid by comparing the response key format to an expected response key format.

12. The method of claim 11, further comprising the steps of:
if the response key format is valid, establishing further secure communications between the patient management system server and the communications device; and
if the response key format is invalid:
closing the communication link between the patient management system server and the communications device,
requesting a retry by the communications device,
sending a subsequent key from the patient management system server and the communications device,
generating a notification by the patient management system server for a user, or
any combination thereof.

13. The method of claim 8, further comprising the steps of:
transmitting, by the patient management system server patient data, device data, medical data, health data, presentation data, identification data, or any combination thereof, to the communications device; and
communicating the transmitted data from the communications device to the patient device.

14. The method of claim 13, wherein the transmitted data is prescription data.

15. The method of claim 13, wherein the transmitted data is device data, the method further comprising the step of modifying, based upon the transmitted device data, at least one patient device setting, at least one patient device configuration, or any combination thereof.

16. The method of claim 1, further comprising the step of visually indicating, by the communications device, call status data.

17. A method of displaying medical information for a plurality of patients in a consolidated format;
displaying a patient identifier associated with each patient;
displaying a graphical representation of notification data related to such a patient at a location proximate to the patient identifier; and
providing a link to review details of the notification data represented by the graphical representation.

18. A method of providing data to a physician having a plurality of patients, wherein a first patient in the plurality of patients is associated with a first HCP/clinician and a second patient in the plurality of patients is associated with a second HCP/clinician, comprising:
providing a central database that contains first information associated with the first patient and second information associated with the second patient;
providing the first HCP/clinician access to the first information and not the second information;
providing the second HCP/clinician access to the second information and not the first information; and
providing the physician access to both the first information and the second information.

19. A method of providing notifications between various users in a data management system, comprising:
providing a data management system that includes patient information associated with a patient;
providing a home care provider (HCP)/clinician associated with such a patient, a physician associated with such a patient, or both, access to the patient information;
entering a notification by such physician into the data management system; and
automatically sending the notification to such a patient and to such an HCP/clinician.

20. A method of providing notifications between various users in a data management system, comprising:
providing a data management system that includes patient information associated with a patient;
providing a home care provider (HCP)/clinician associated with such a patient, a physician associated with such a patient, or both, access to the patient information;
entering a notification by such an HCP/clinician into the data management system;
automatically sending the notification to such a patient; and
providing such an HCP with an option to send the notification to such a physician.
